(19) United States
(12) Patent Application Publication
(10) Pub. No.: US 2024/0377931 A1
(43) Pub. Date: Nov. 14, 2024

(54) SYSTEMS AND METHODS FOR MESSAGING APPLICATION USER INTERFACES

(71) Applicant: Apple Inc., Cupertino, CA (US)

(72) Inventors: Christian X. DALONZO, San Francisco, CA (US); Grant R. PAUL, San Francisco, CA (US)

(21) Appl. No.: 18/658,842

(22) Filed: May 8, 2024

Related U.S. Application Data
(60) Provisional application No. 63/501,140, filed on May 9, 2023.

(51) Int. Cl. G06F 3/04842; G06F 3/0485; G06F 3/04886

(52) U.S. Cl. CPC G06F 3/04842; G06F 3/0485; G06F 3/04886

(57) ABSTRACT

In some embodiments, an electronic device updates an input field of a messaging application user interface in accordance with a respective application user interface. In some embodiments, an electronic device updates an input field of a messaging application user interface in accordance with a location sharing application user interface. In some embodiments, an electronic device updates an input field of a messaging application user interface in accordance with an audio messages application user interface.

### CROSS-REFERENCE TO RELATED APPLICATIONS

This application claims the benefit of U.S. Provisional Application No. 63/501,140, filed May 9, 2023, the entire disclosure of which is herein incorporated by reference for all purposes.

### FIELD OF THE DISCLOSURE

This relates generally to electronic devices that present user interfaces for composing and/or sending messages in accordance with a respective application user interface.

### BACKGROUND

User interaction with electronic devices has increased significantly in recent years. These devices can be devices such as computers, tablet computers, televisions, multimedia devices, mobile devices, and the like.

In some circumstances, users wish to compose and/or send messages via electronic devices. Enhancing these interactions improves the user's experience with the device and decreases user interaction time, which is particularly important where input devices are battery-operated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### SUMMARY OF THE DISCLOSURE

Some embodiments described in this disclosure are directed to an electronic device that displays user interfaces for managing hardware subscriptions that entitle the subscriber to use an electronic device. The full descriptions of the embodiments are provided in the Drawings and the Detailed Description, and it is understood that the Summary provided above does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6P illustrate exemplary ways of updating an input field of a messaging application user interface in accordance with a respective application user interface in accordance with some embodiments of the disclosure.

FIGS. 7A-7I are flow diagrams illustrating a method of updating an input field of a messaging application user interface in accordance with a respective application user interface in accordance with some embodiments of the disclosure.

FIGS. 8A-8J illustrate exemplary ways of updating an input field of a messaging application user interface in accordance with a location sharing application user interface in accordance with some embodiments of the disclosure.

FIG. 9A-9I are flow diagrams illustrating a method of updating an input field of a messaging application user interface in accordance with a location sharing application user interface in accordance with some embodiments of the disclosure.

FIGS. 10A-10O illustrate exemplary ways of updating an input field of a messaging application user interface in accordance with an audio messages application user interface in accordance with some embodiments of the disclosure.

FIGS. 11A-11I are flow diagrams illustrating a method of updating an input field of a messaging application user interface in accordance with an audio messages application user interface in accordance with some embodiments of the disclosure.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for user interfaces of a messaging application that can present content in accordance with a respective application user interface. In some embodiments, an electronic device updates an input field of a messaging application user interface in accordance with a respective application user interface. In some embodiments, an electronic device updates an input field of a messaging application user interface in accordance with a location sharing application user interface. In some embodiments, an electronic device updates an input field of a messaging application user interface in accordance with an audio messages application user interface. Further, such techniques present content that the user may be interested in viewing easily accessible, thus reducing the number of inputs needed to sort through and identify content that the user may have an interest in, thereby reducing power usage and improving the battery life of the electronic device

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

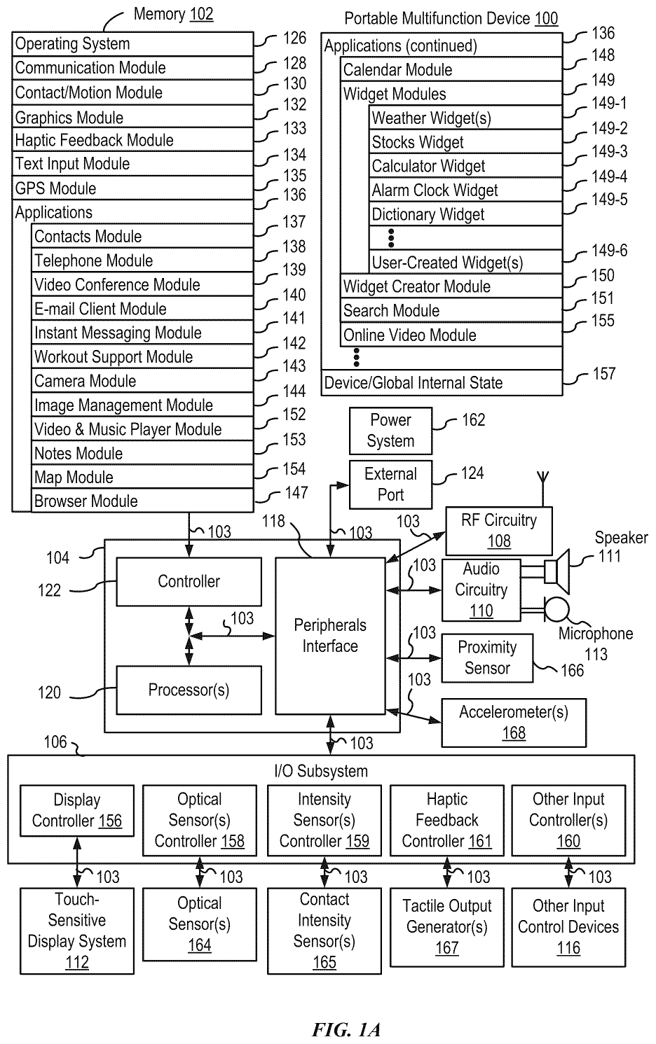

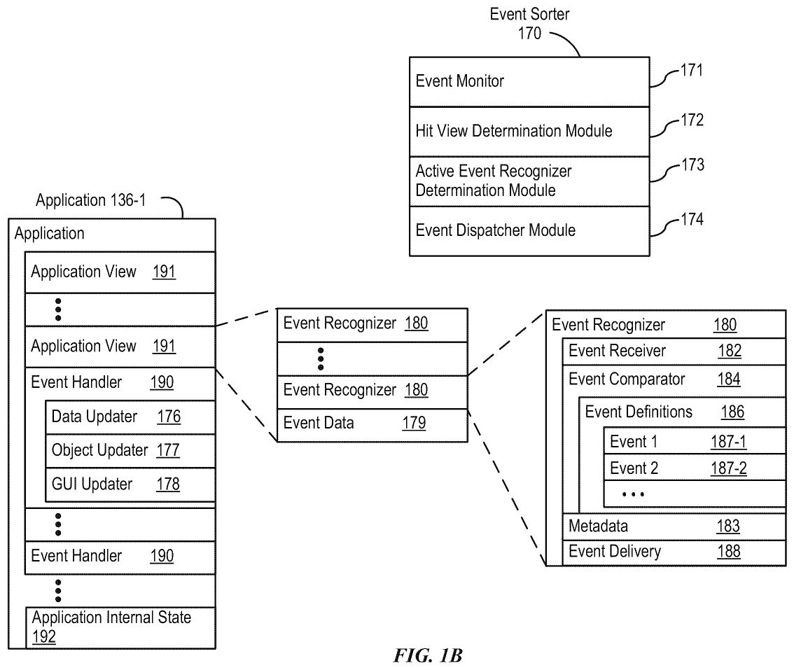

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

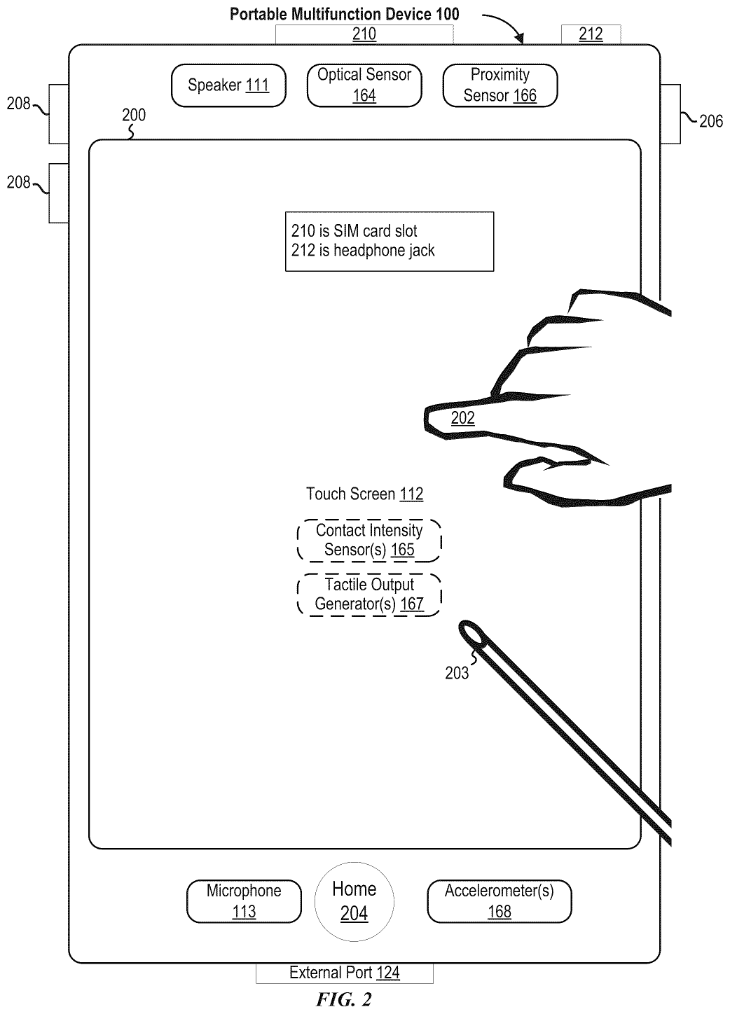

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

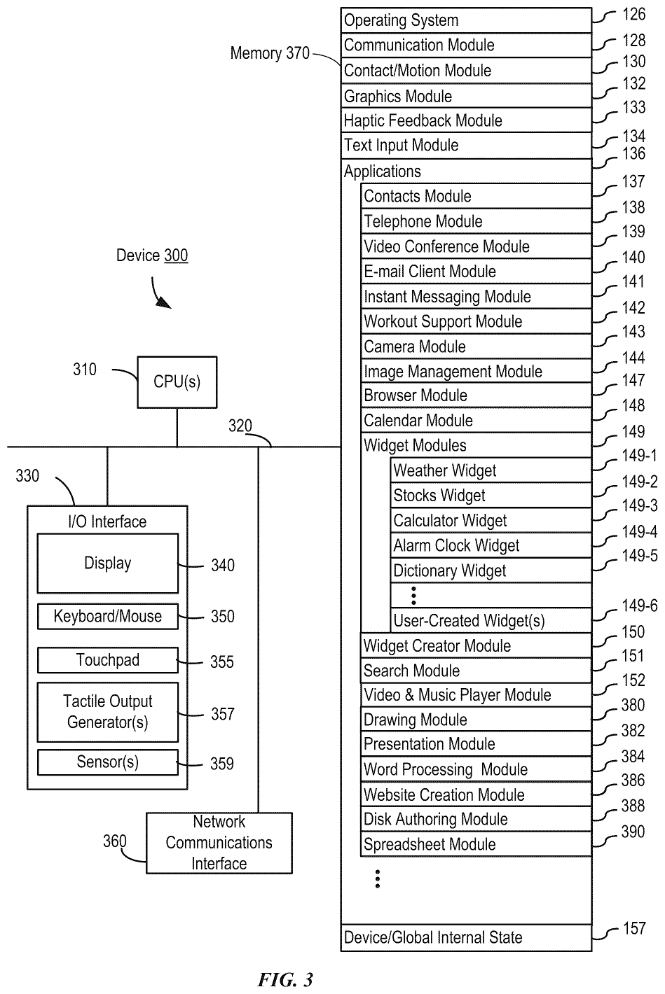

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

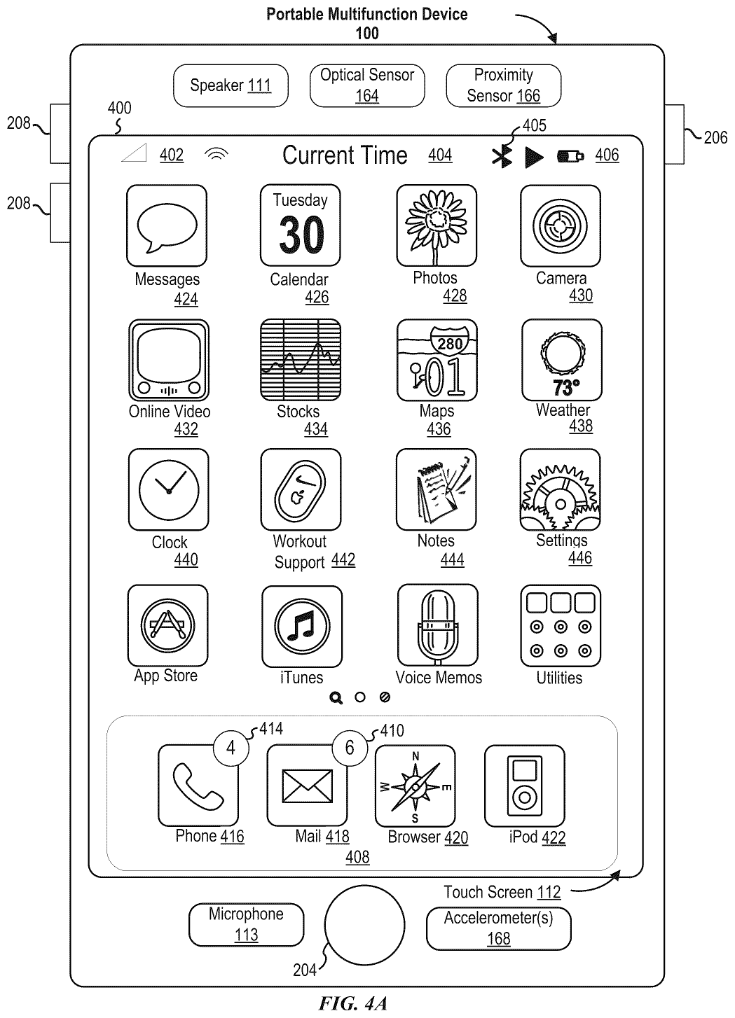

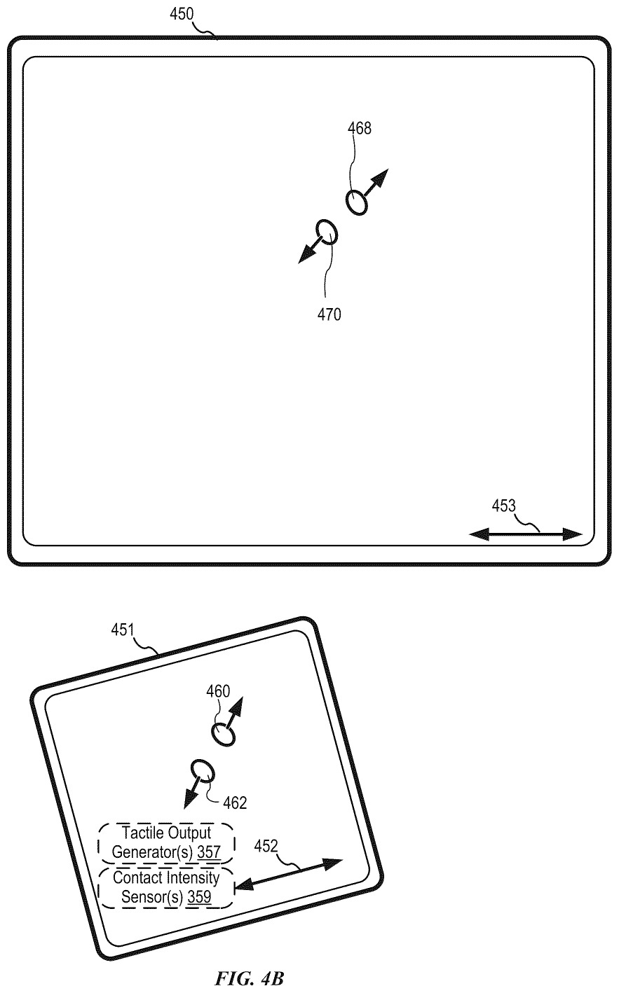

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

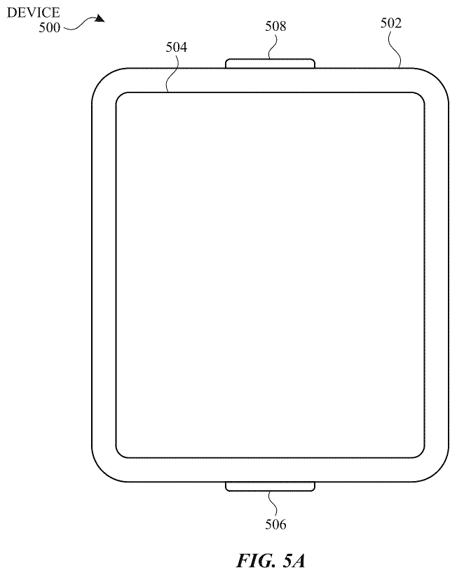

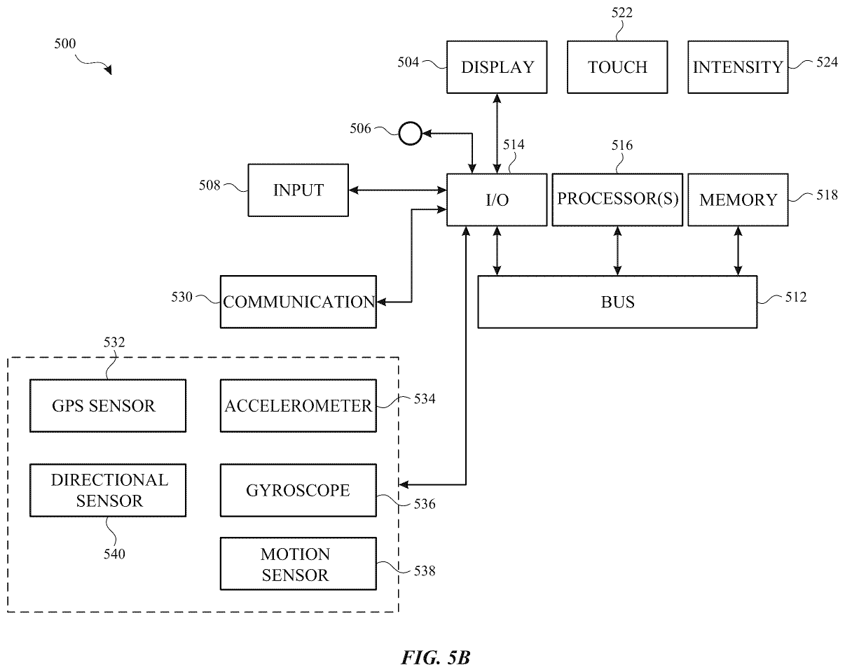

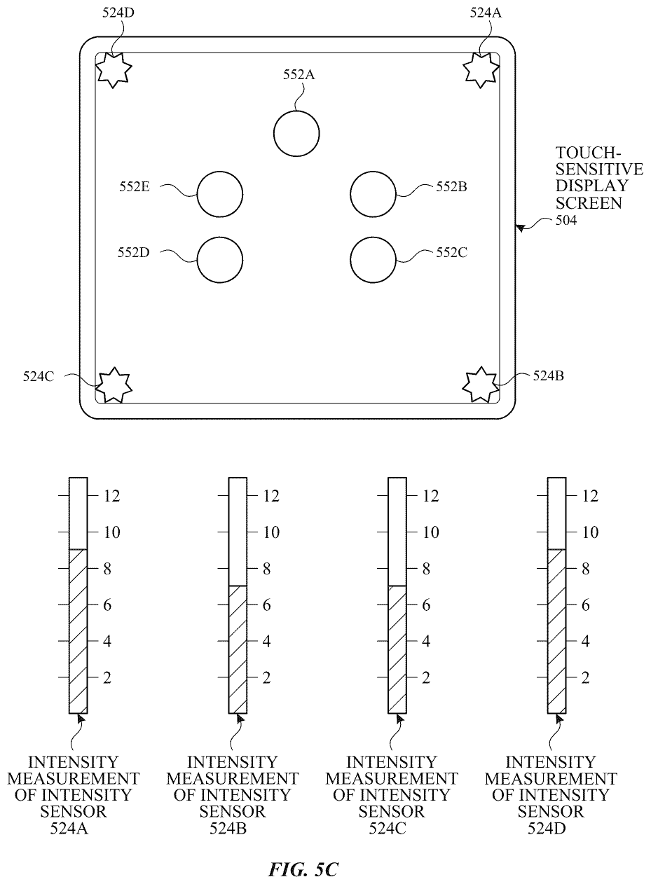

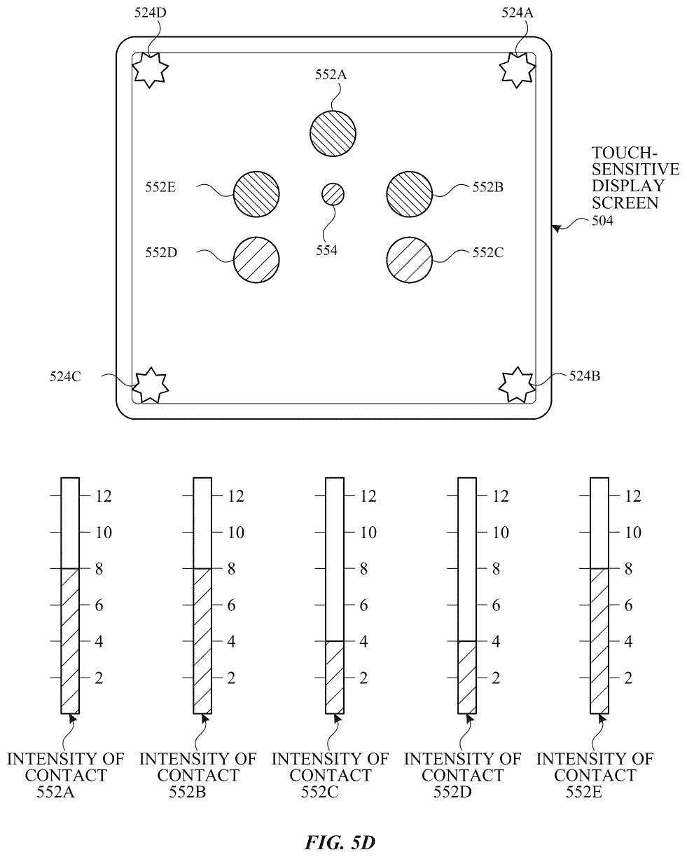

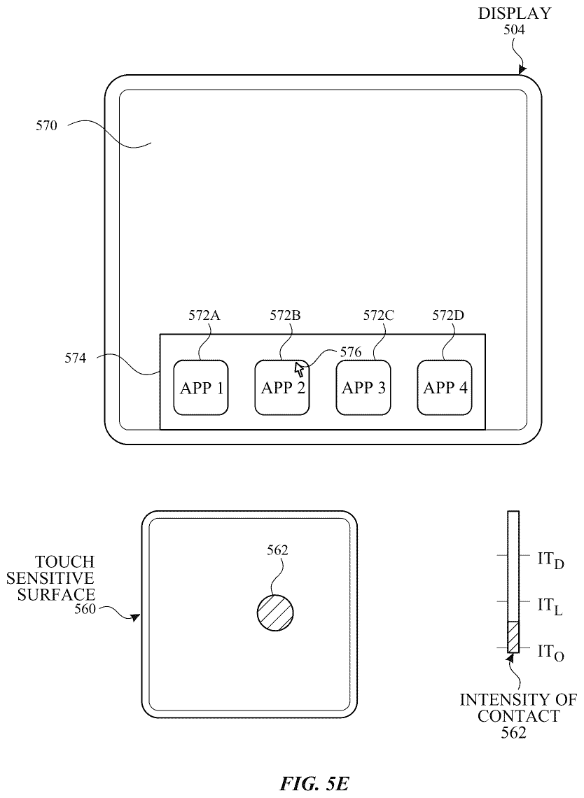

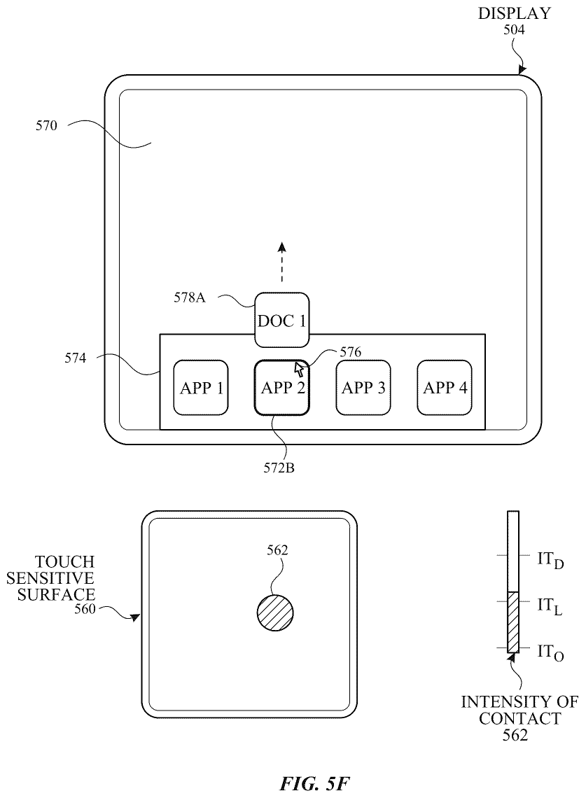

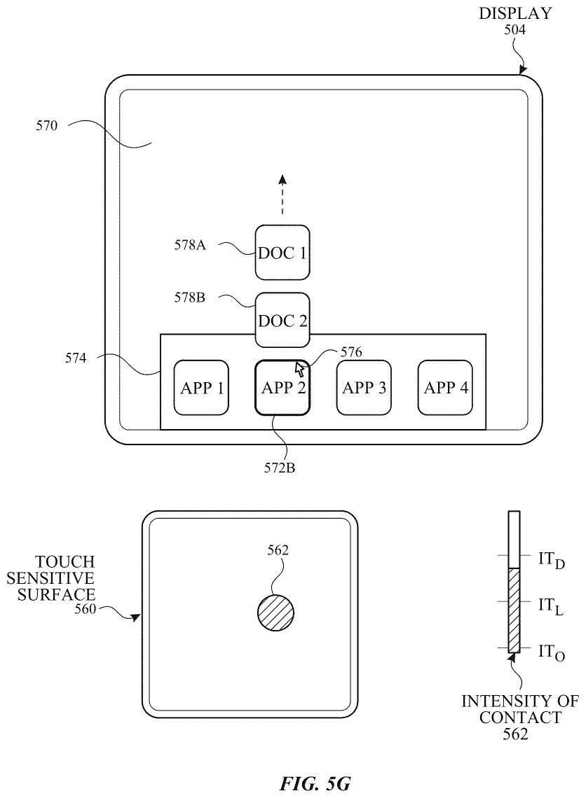

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

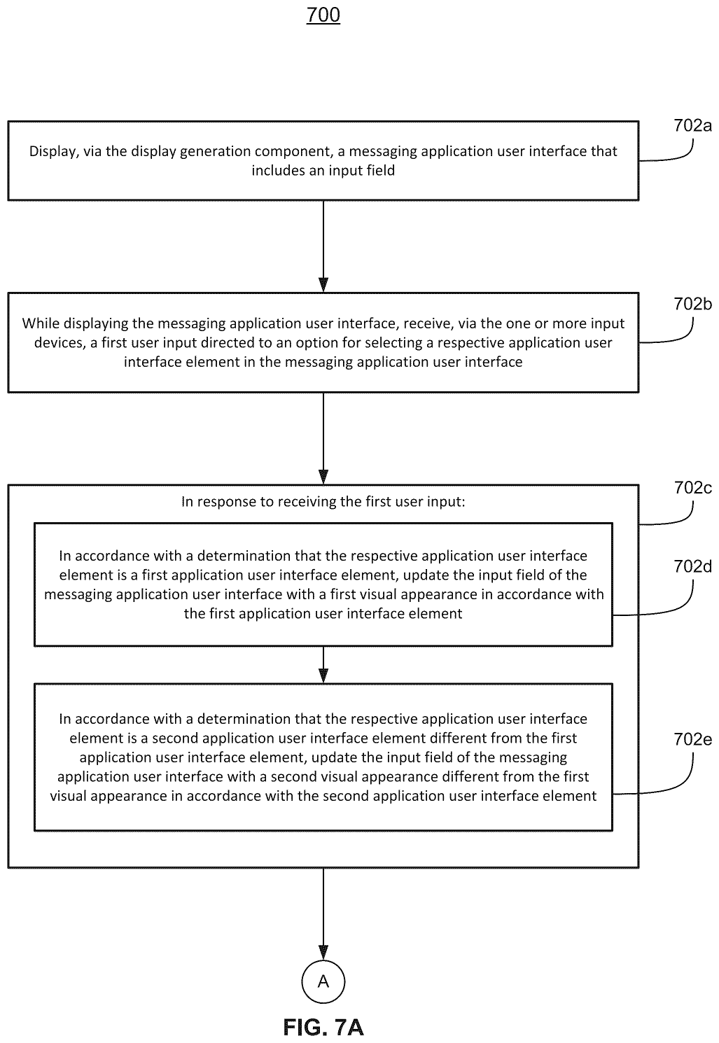

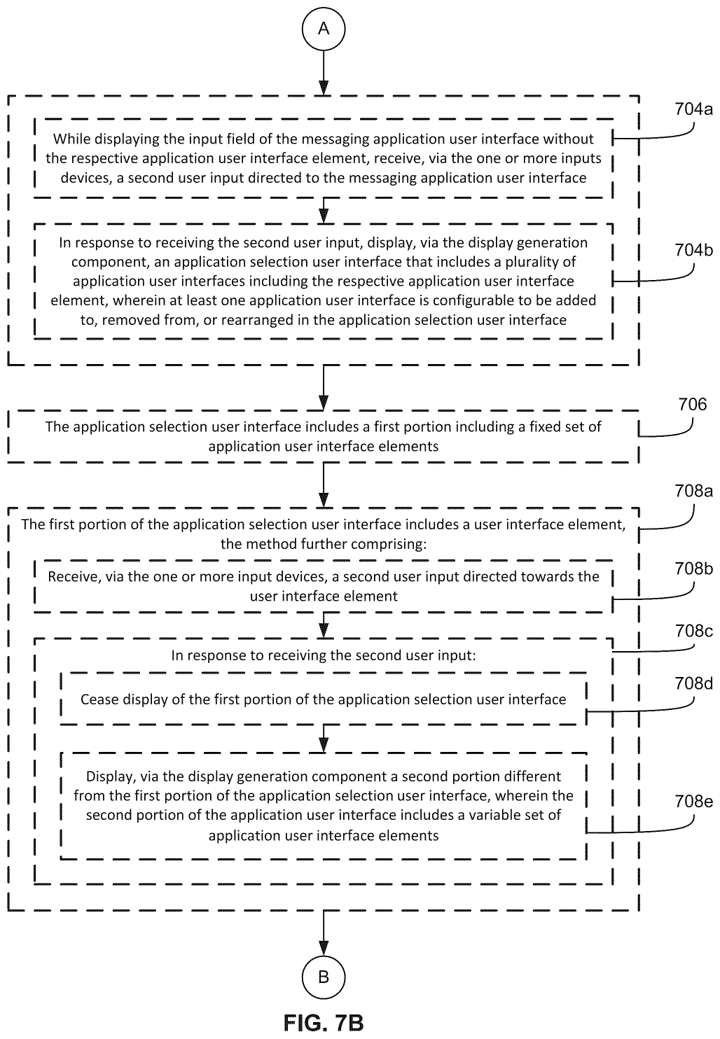

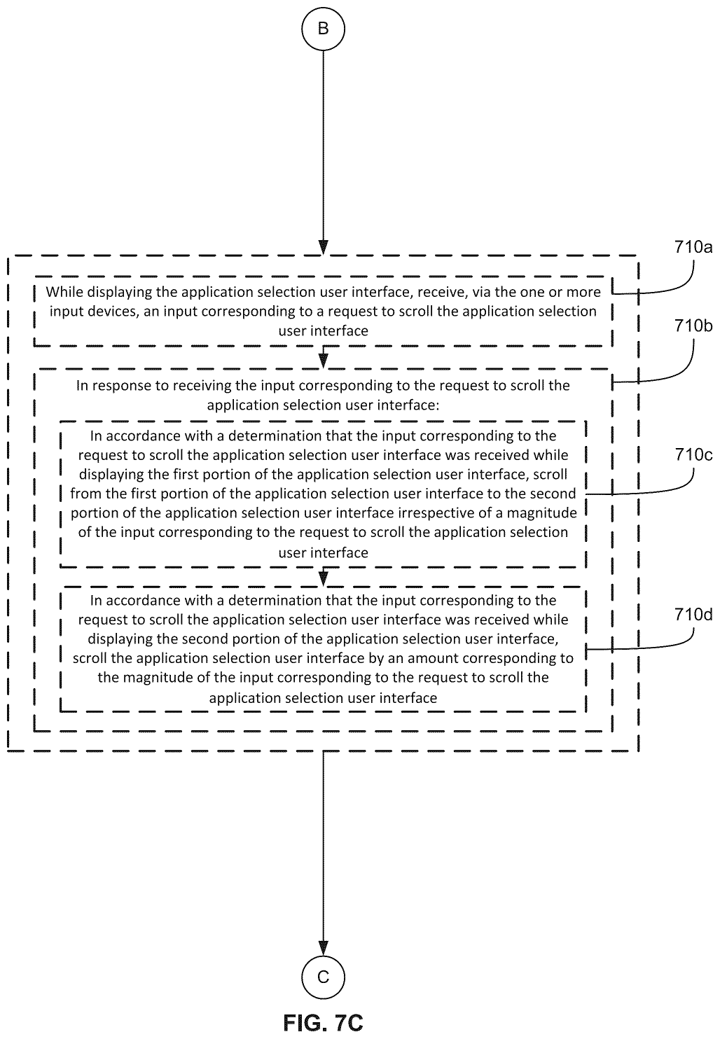

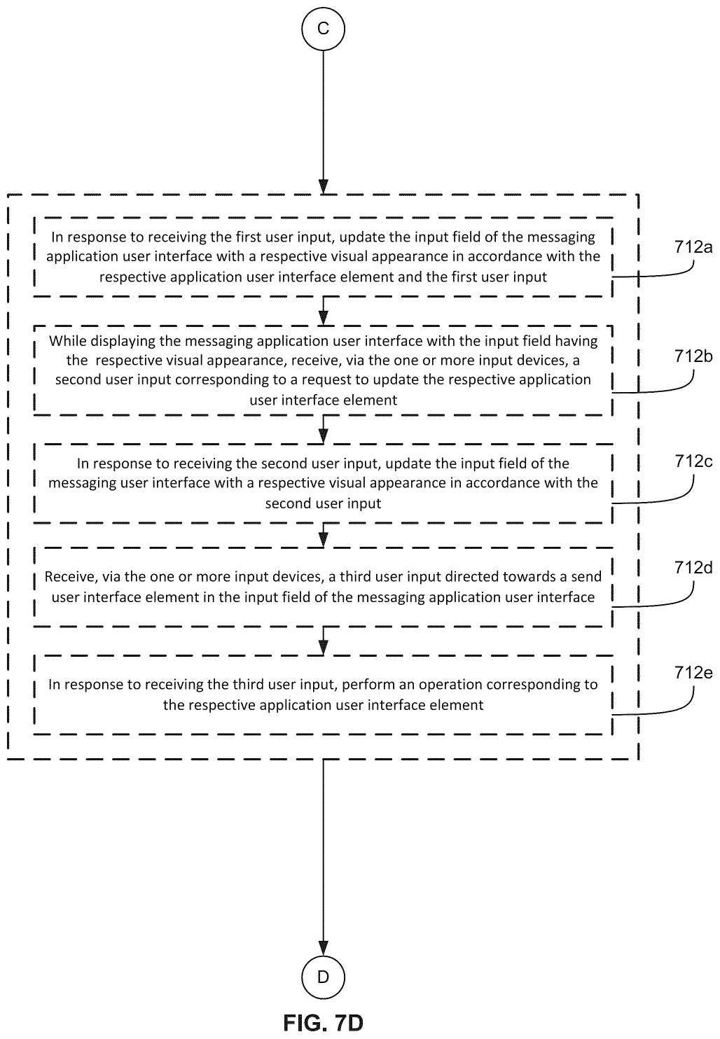

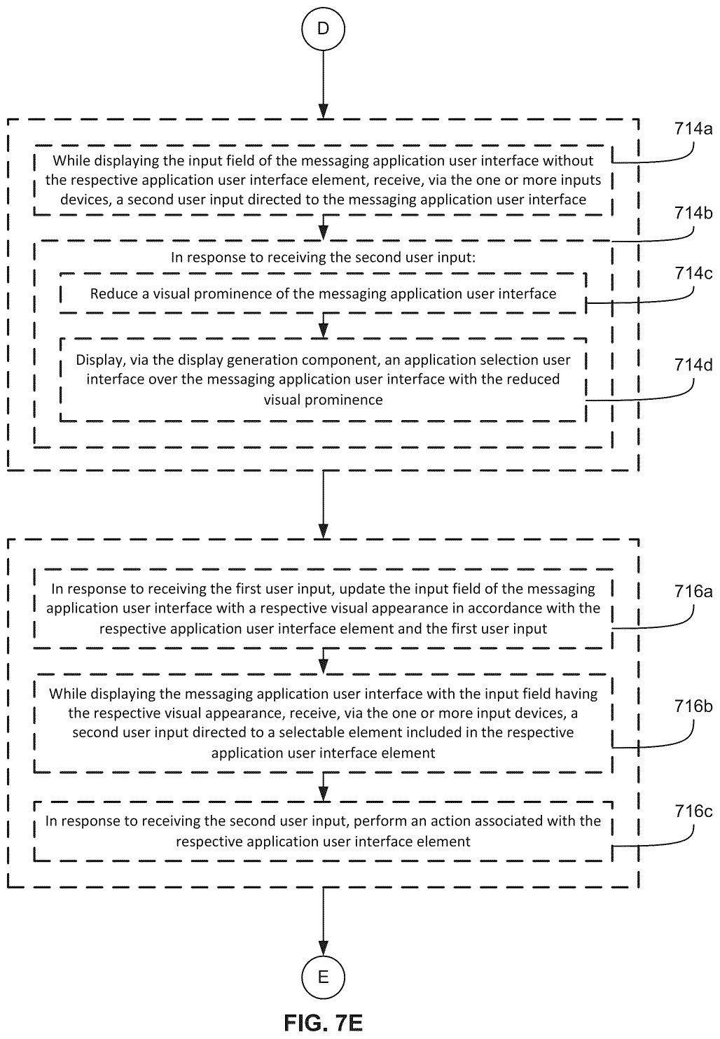

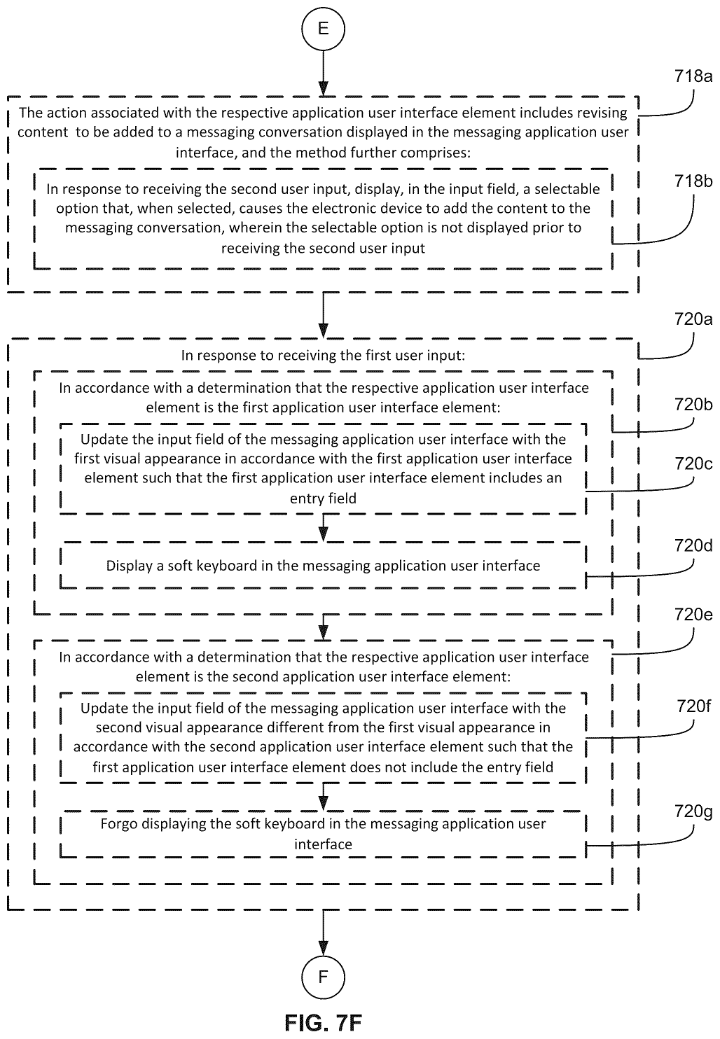

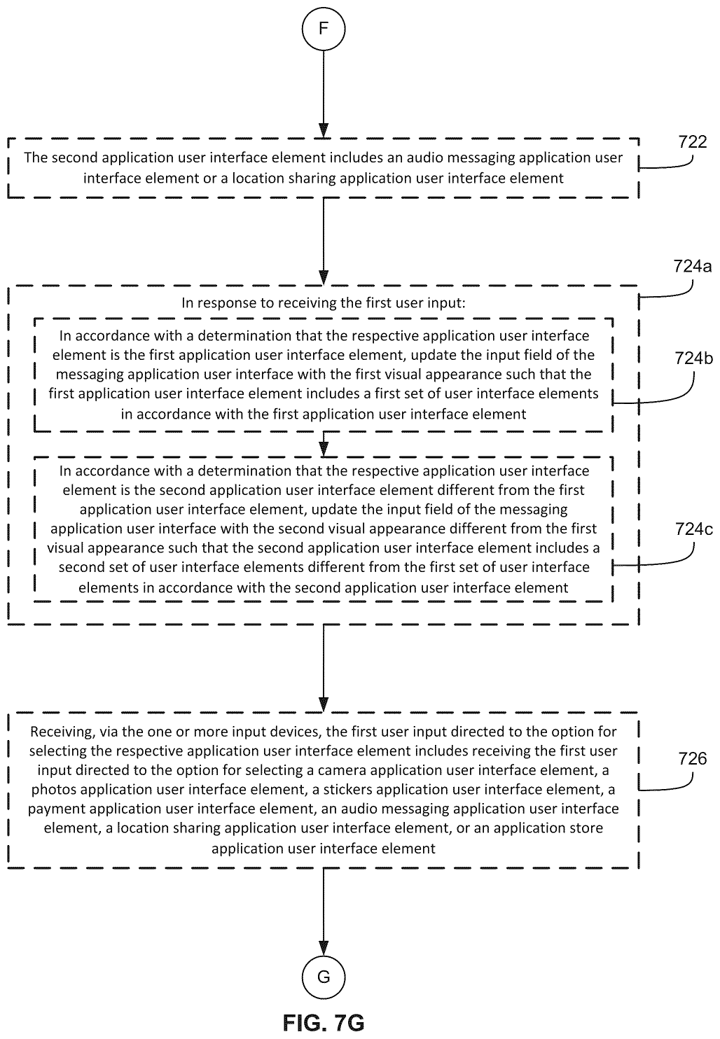

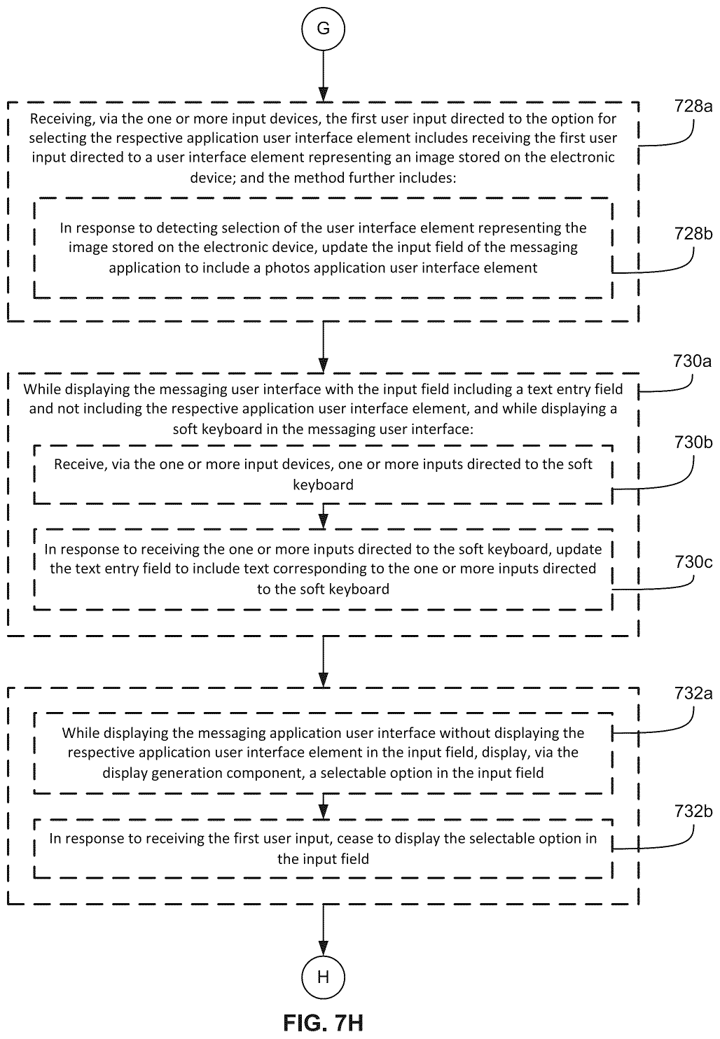

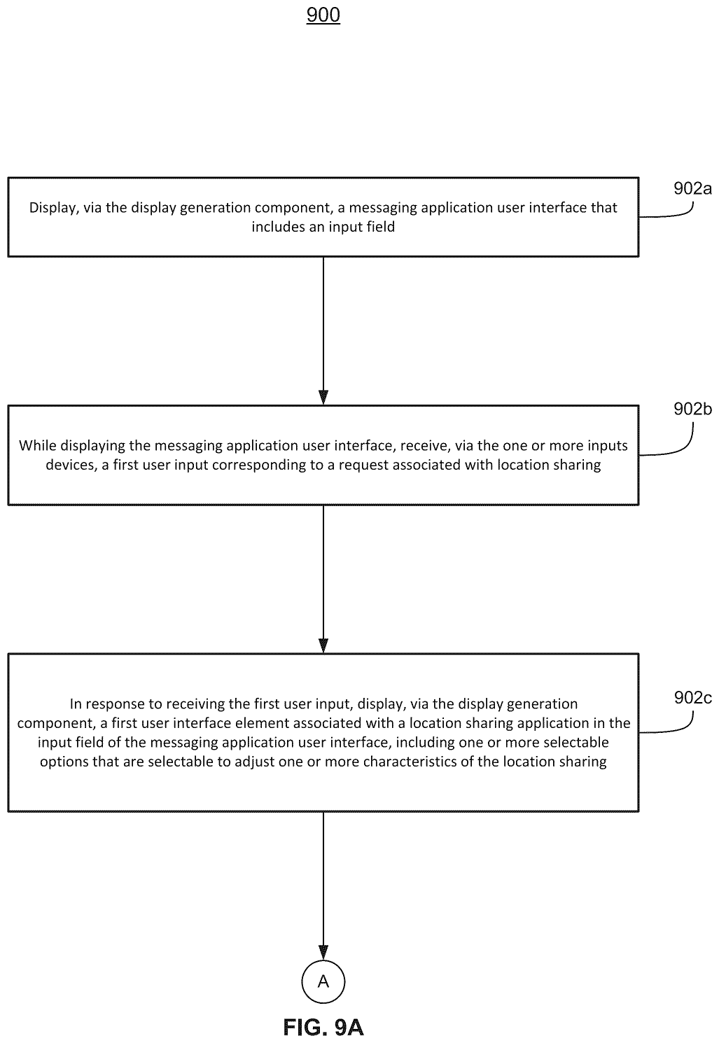

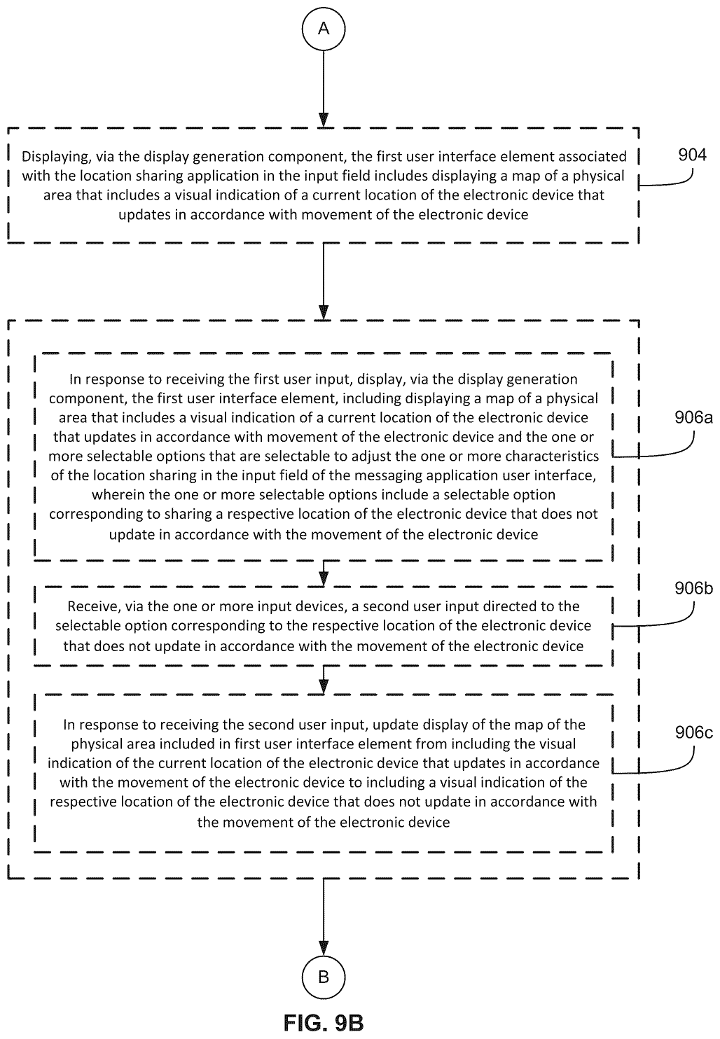

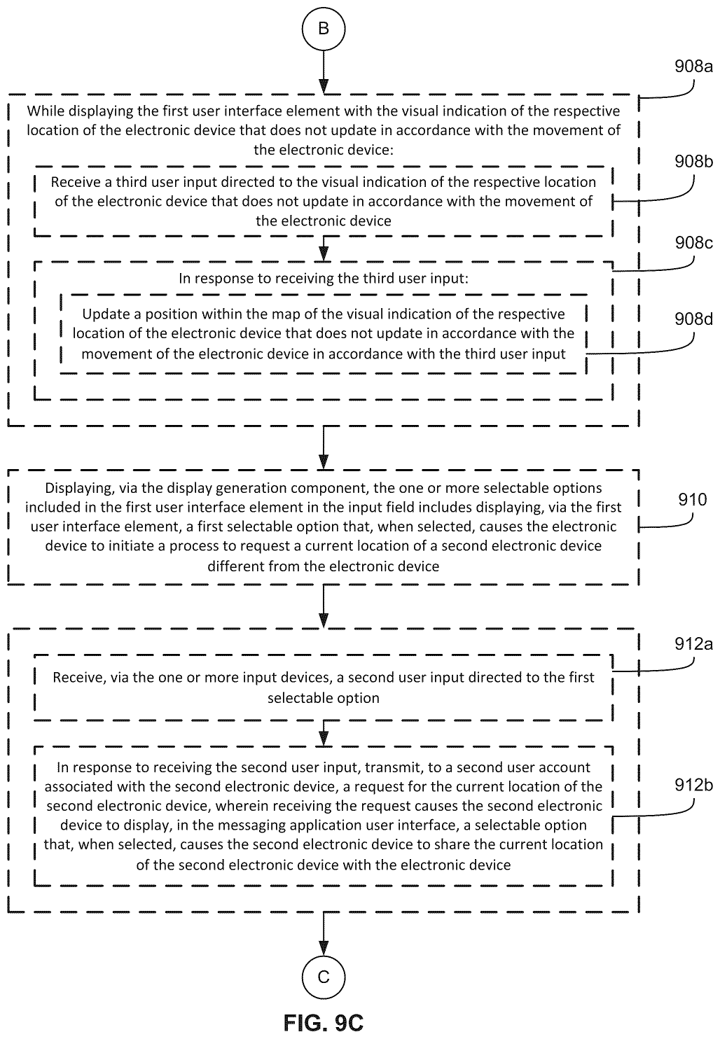

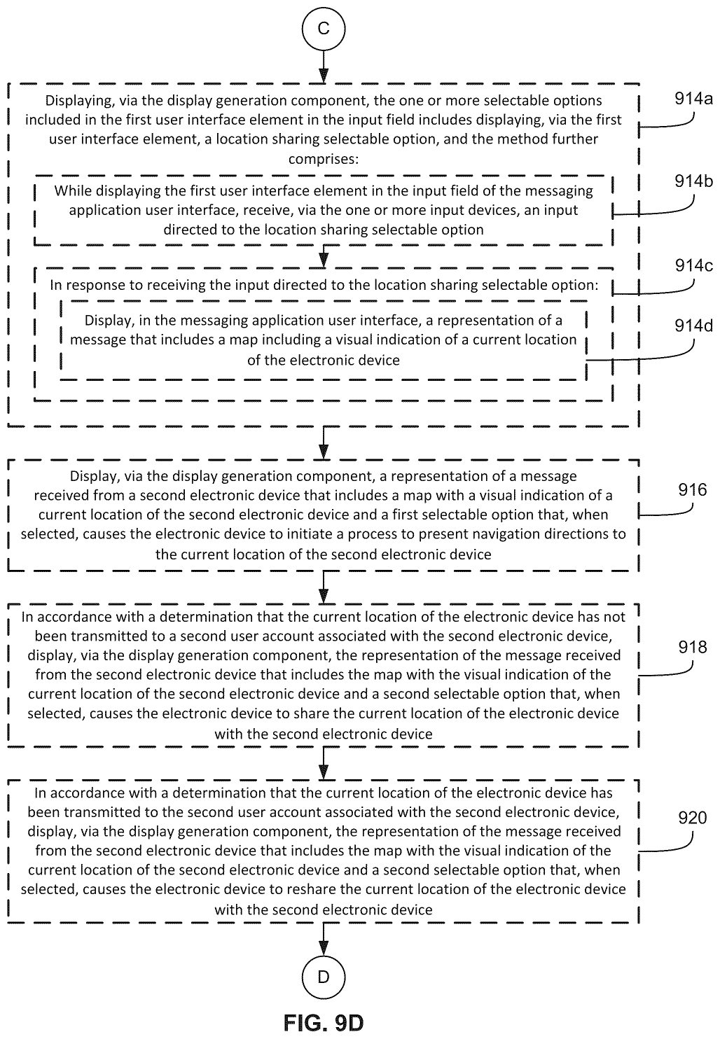

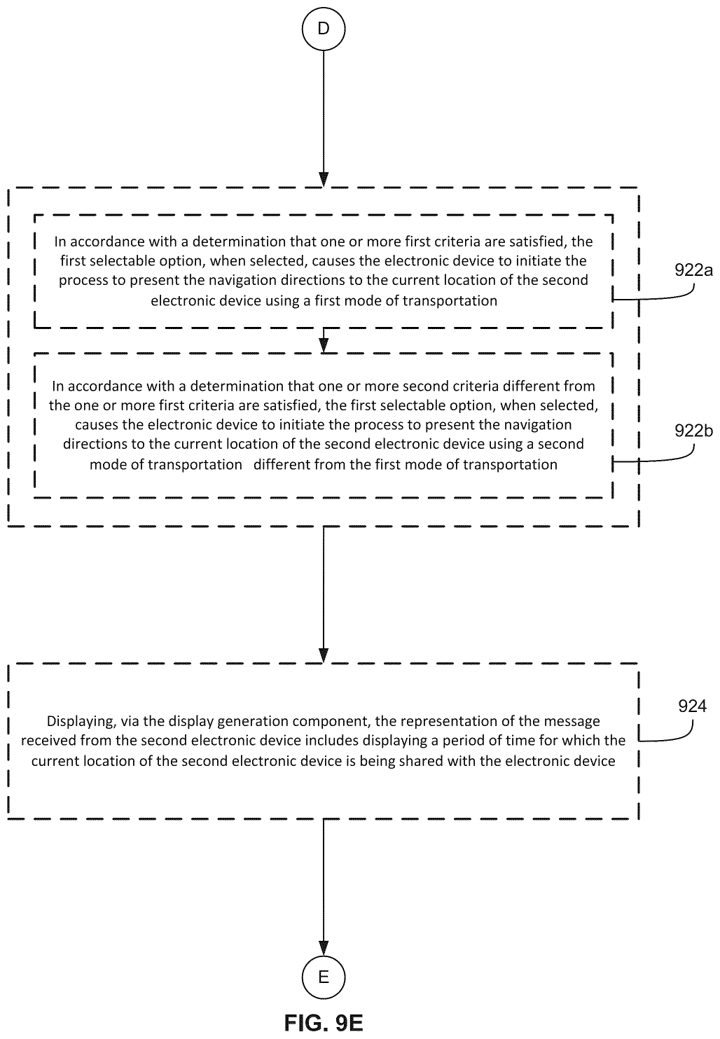

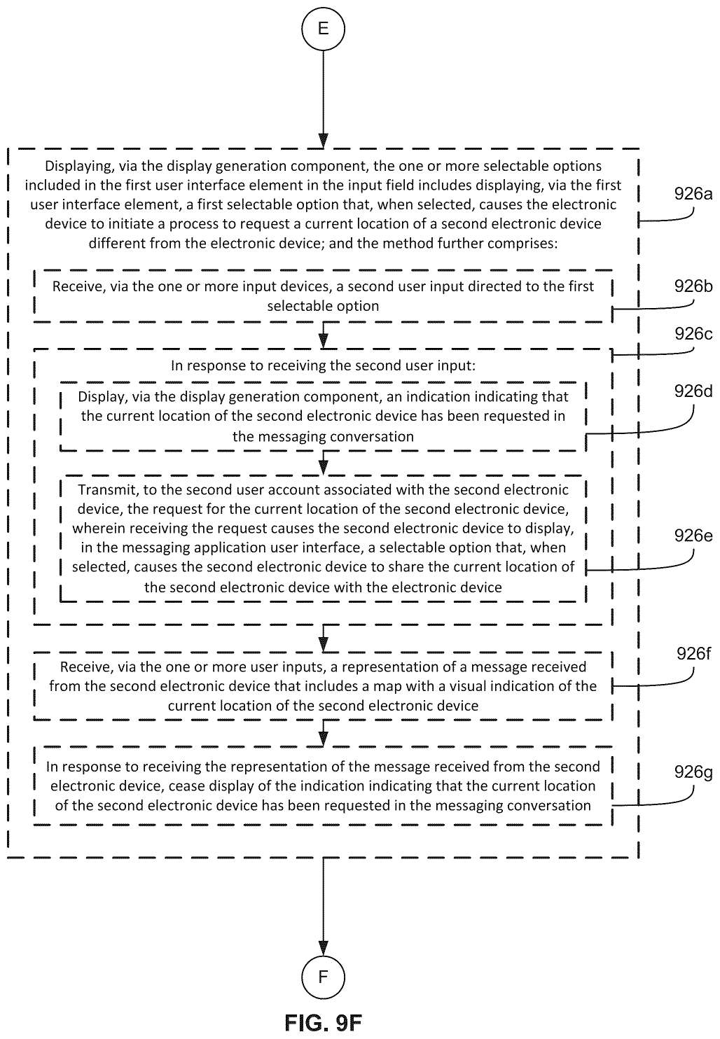

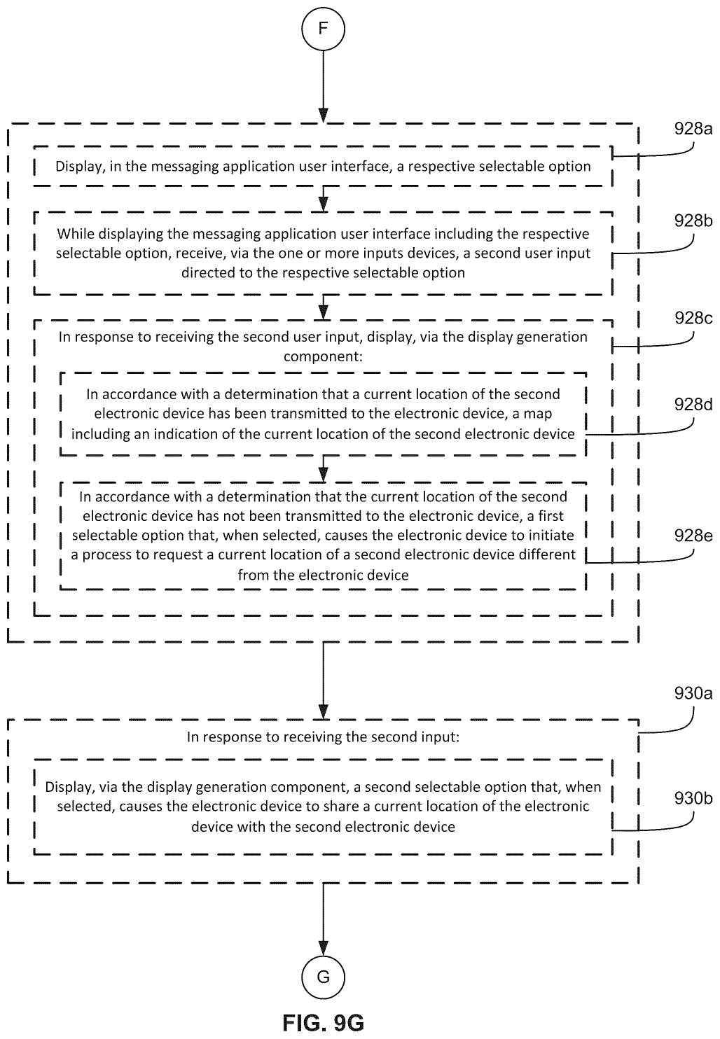

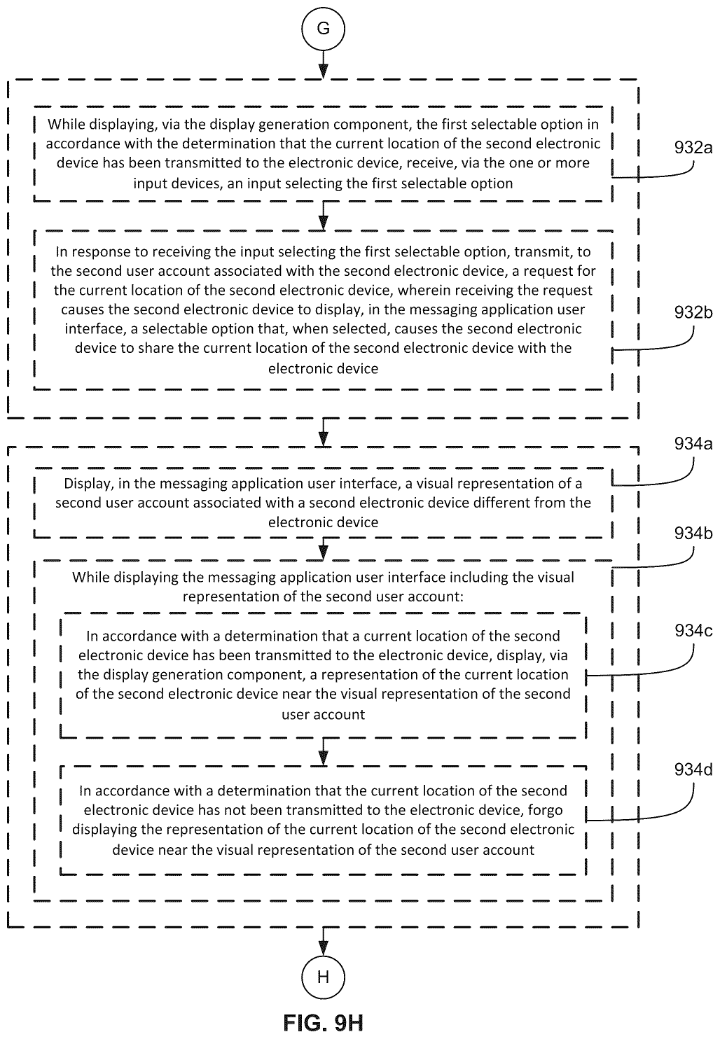

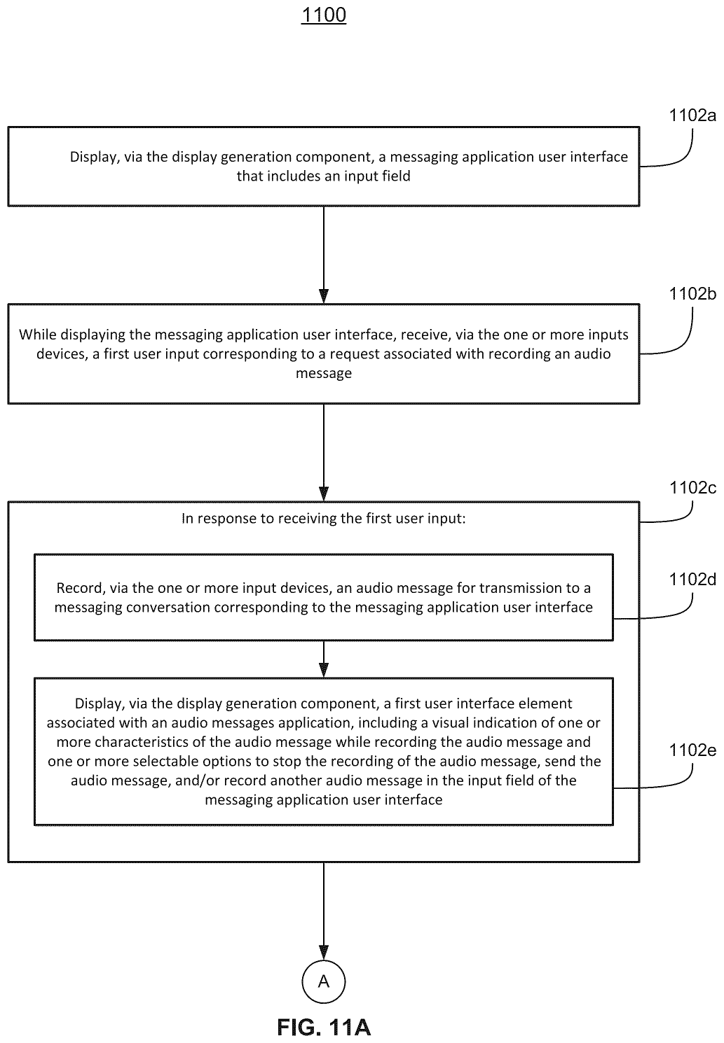

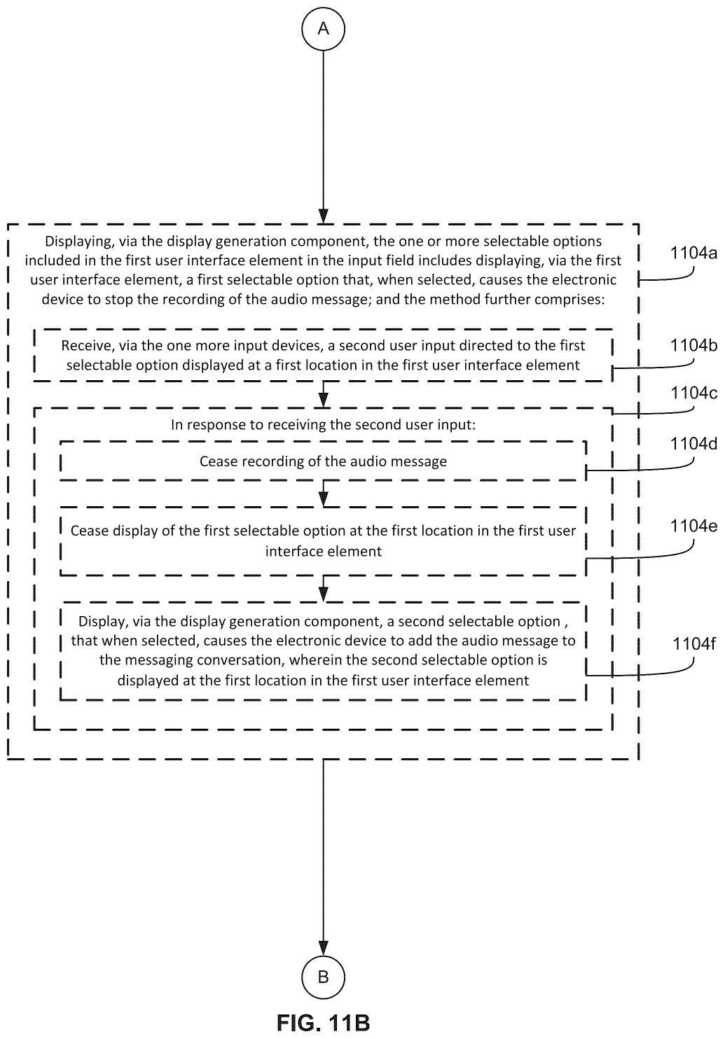

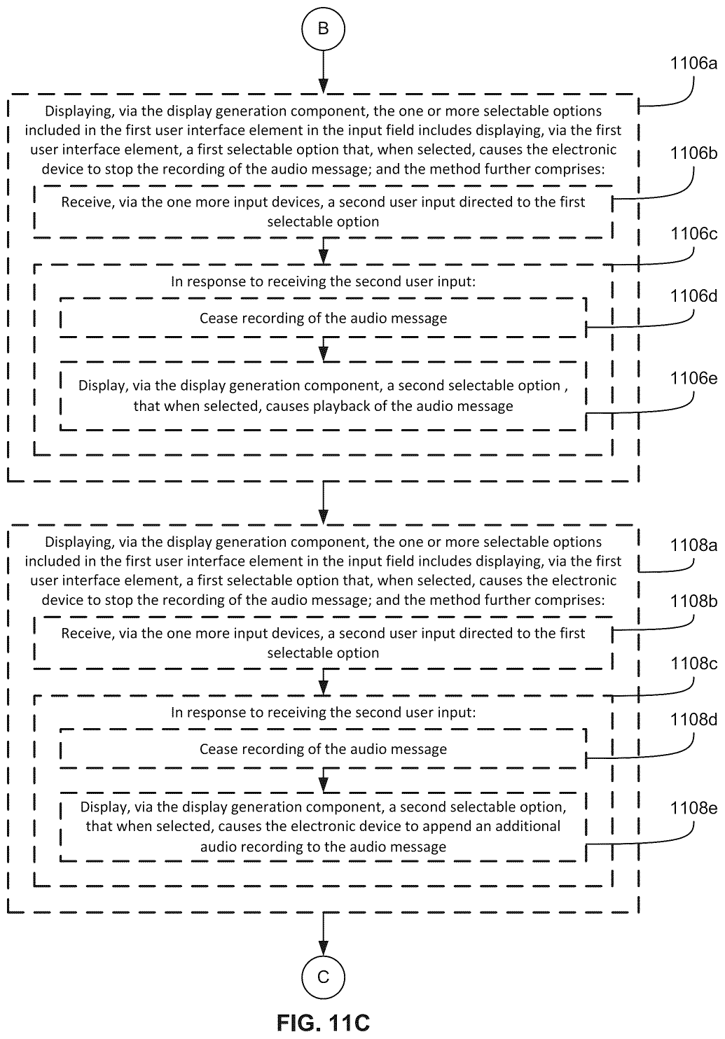

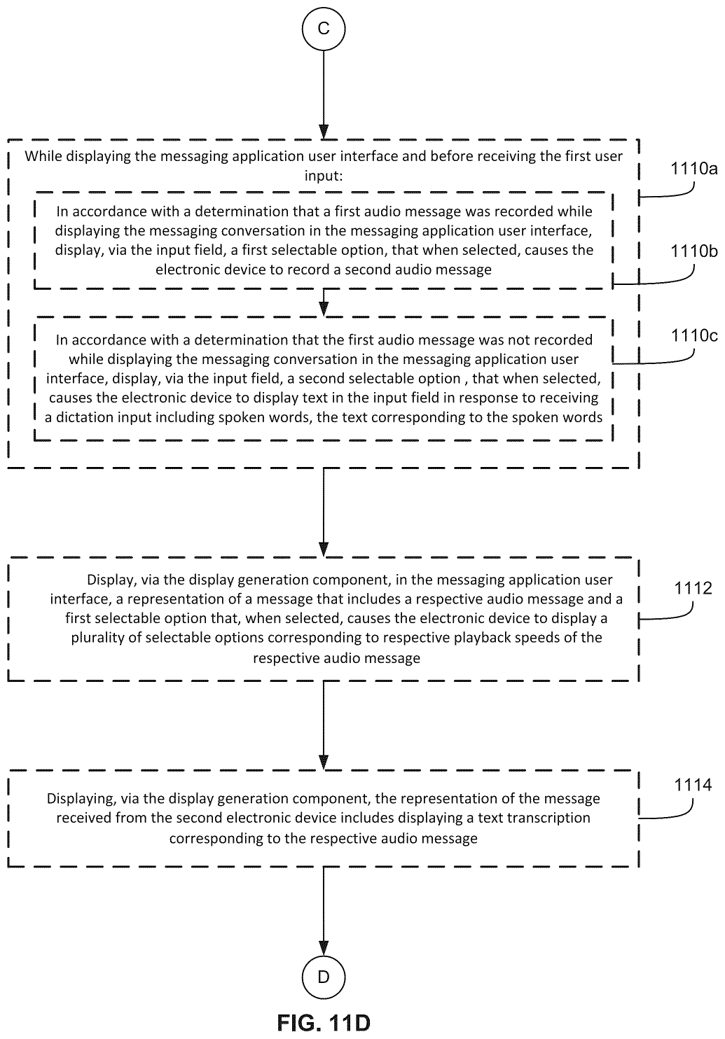

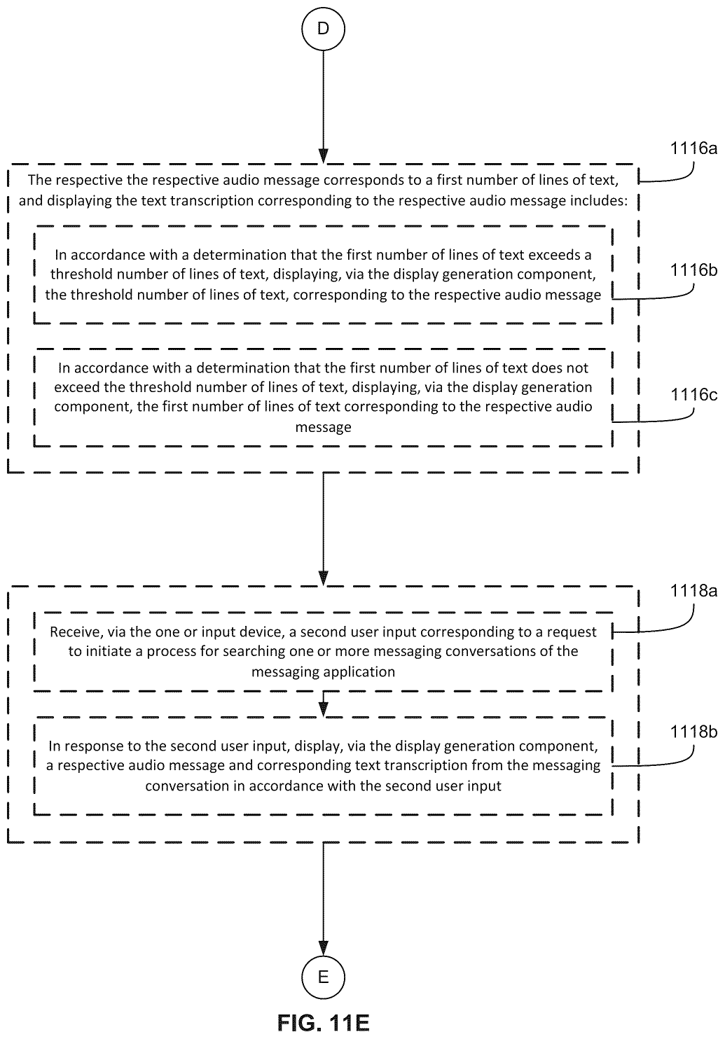

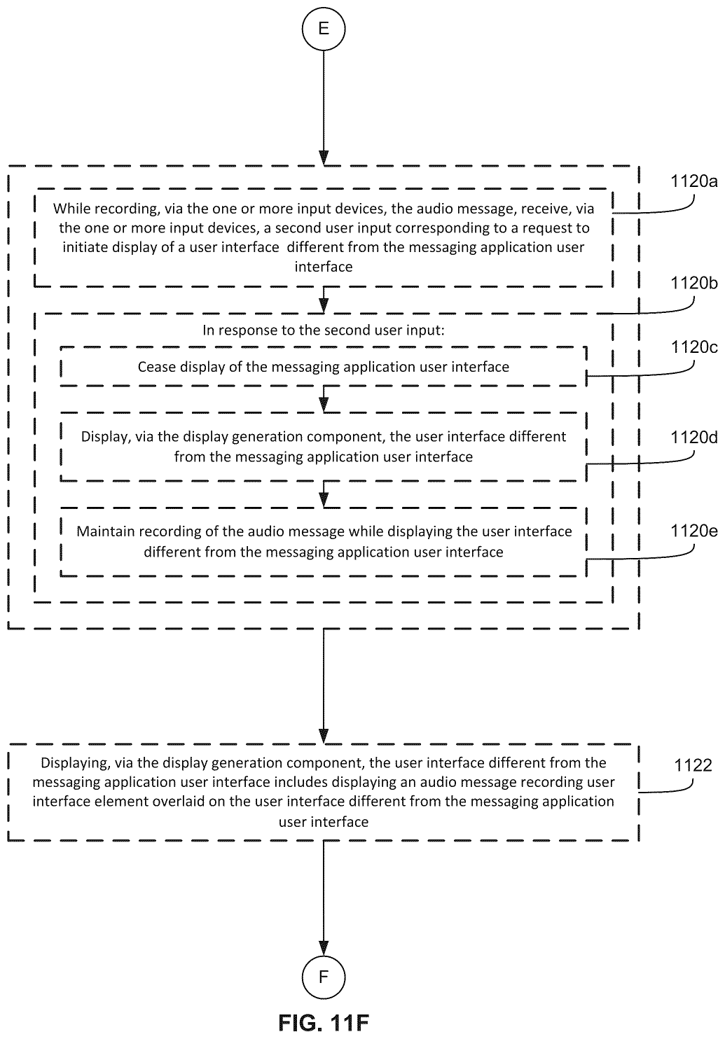

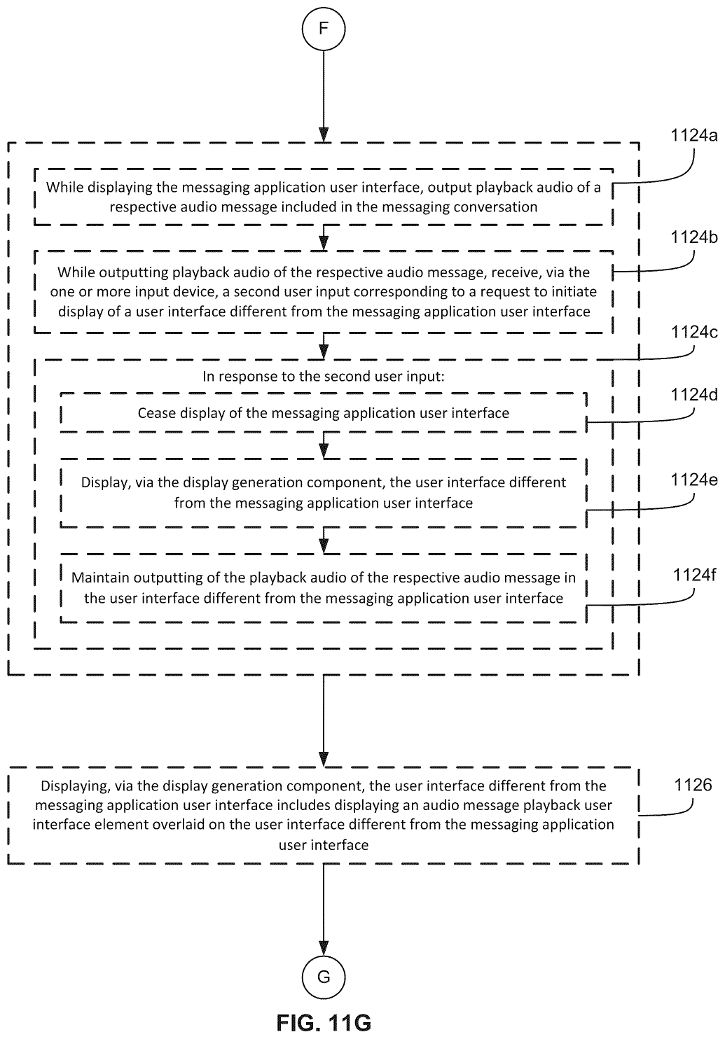

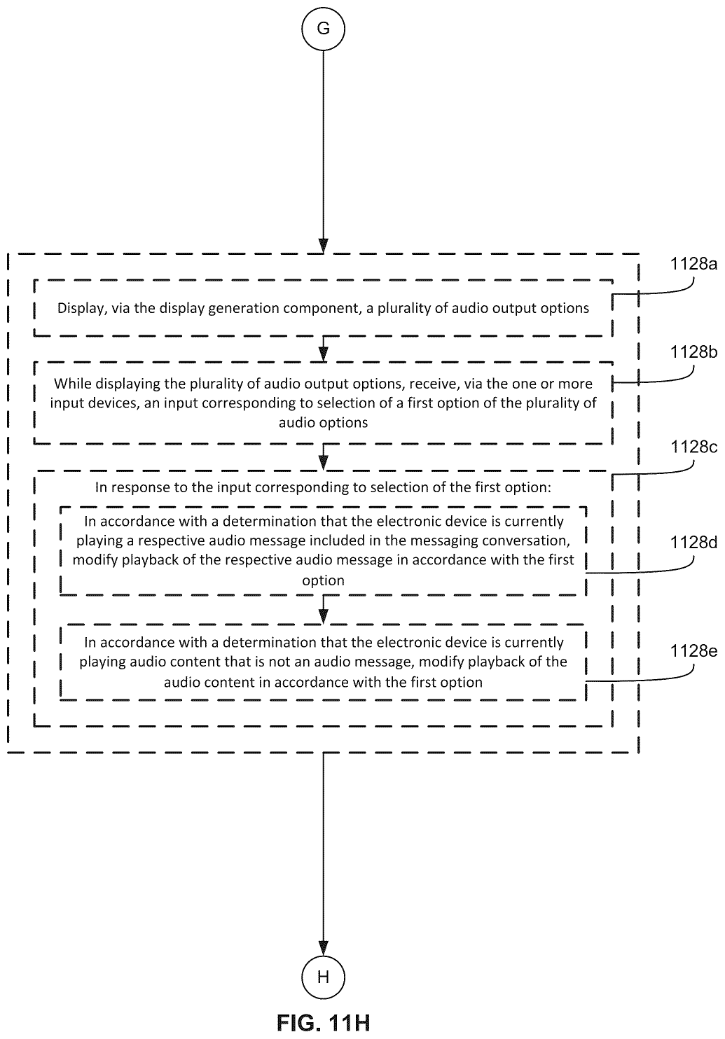

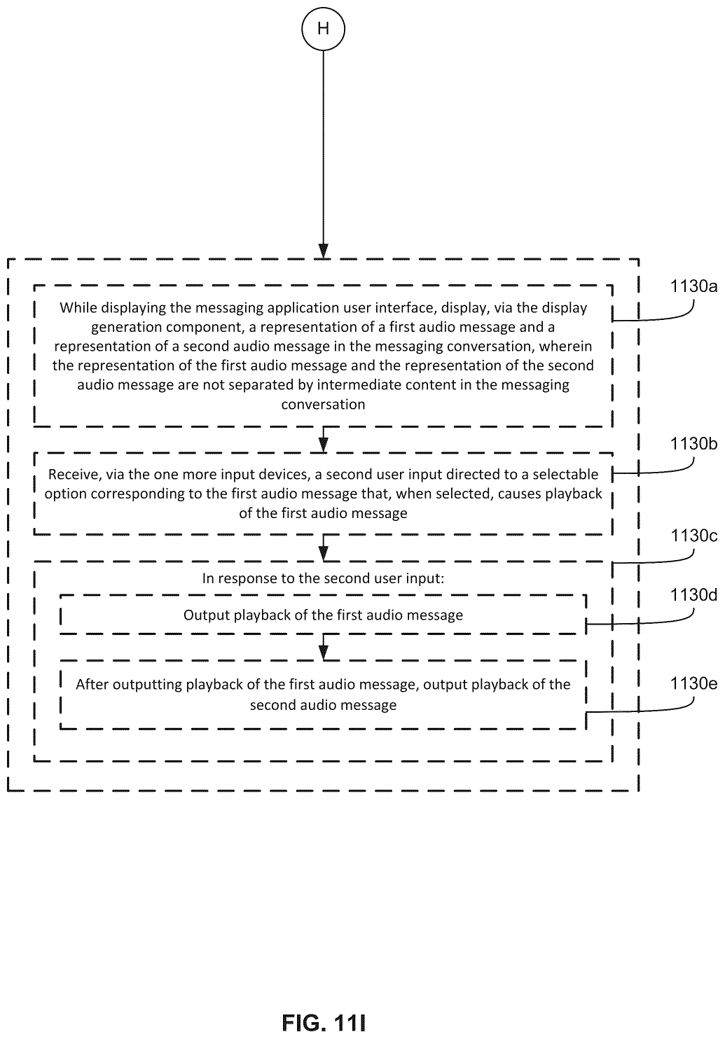

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700 (FIGS. 7A-7I), process 900 (FIGS. 9A-9I), and/or process (FIGS. 11A-11I). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D})”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D})”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D})”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For case of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

Updating an Input Field of a Messaging Application User Interface in Accordance with a Respective Application

Users interact with electronic devices in many different manners, including composing and/or sending messages. In some embodiments, an electronic device displays a messaging application user interface including an input field allowing a user to compose and/or send messages. The embodiments described below provide ways in which an electronic device updates an input field of a messaging application user interface in accordance with a respective application user interface. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

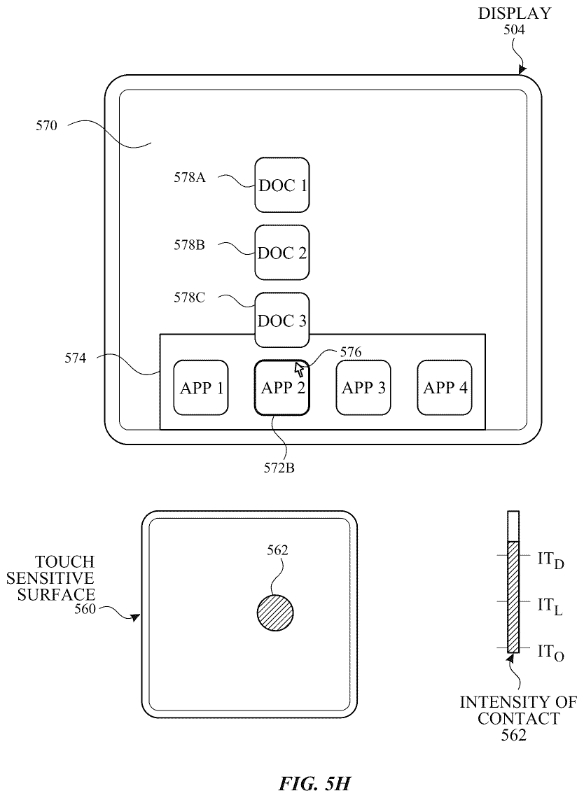

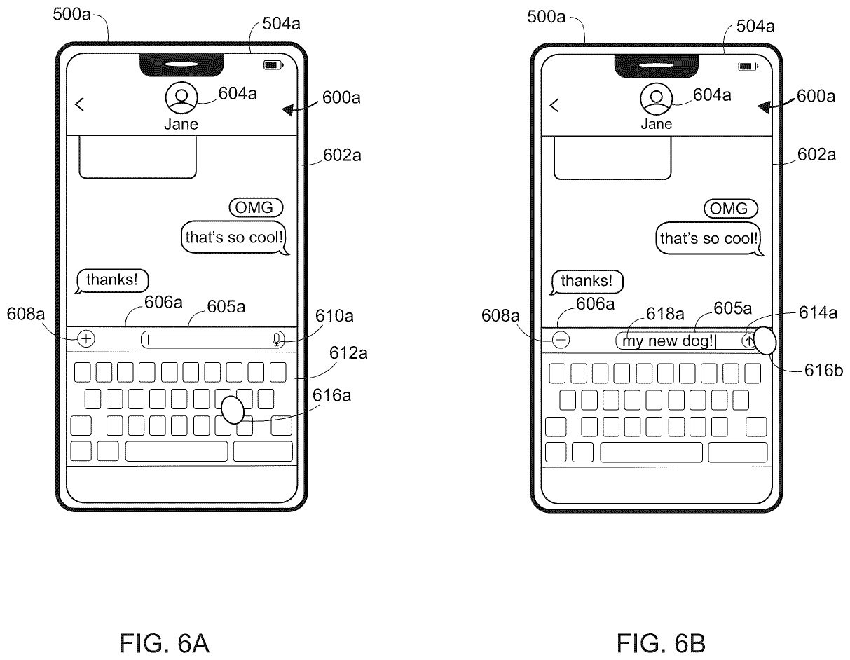

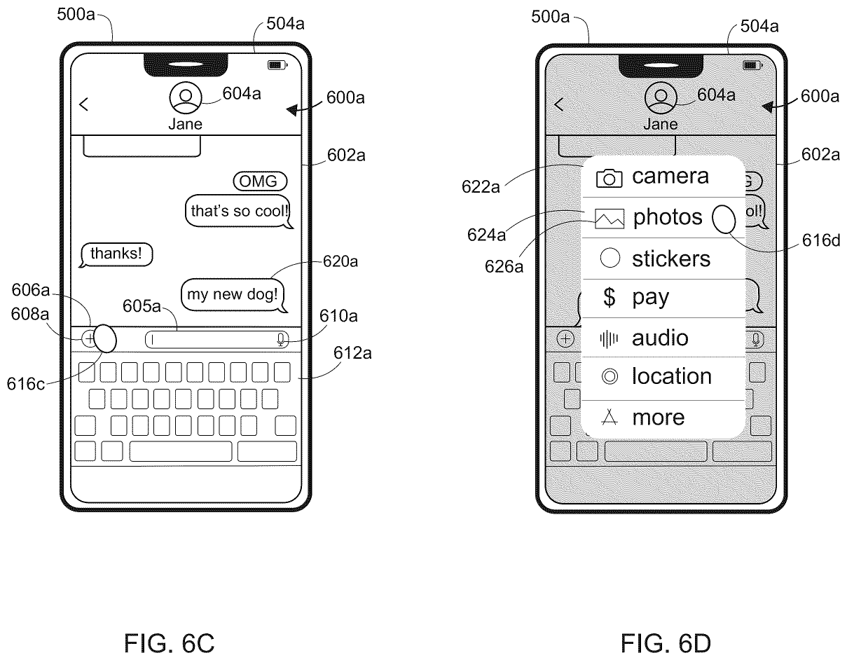

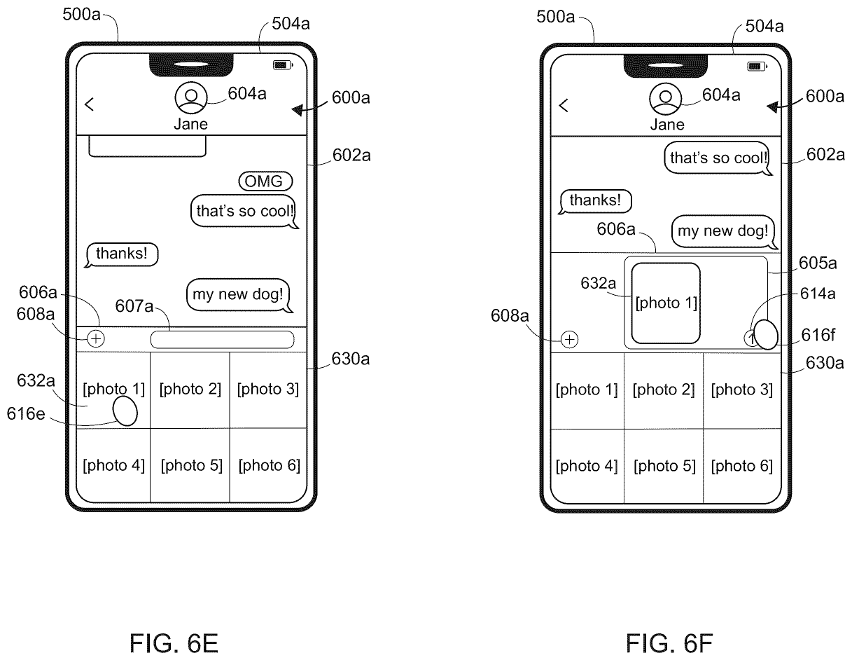

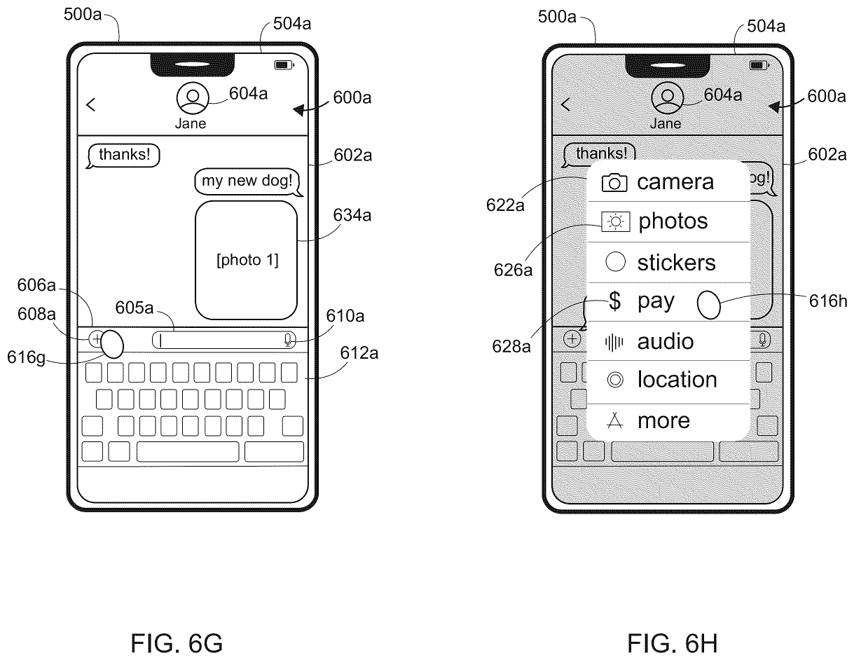

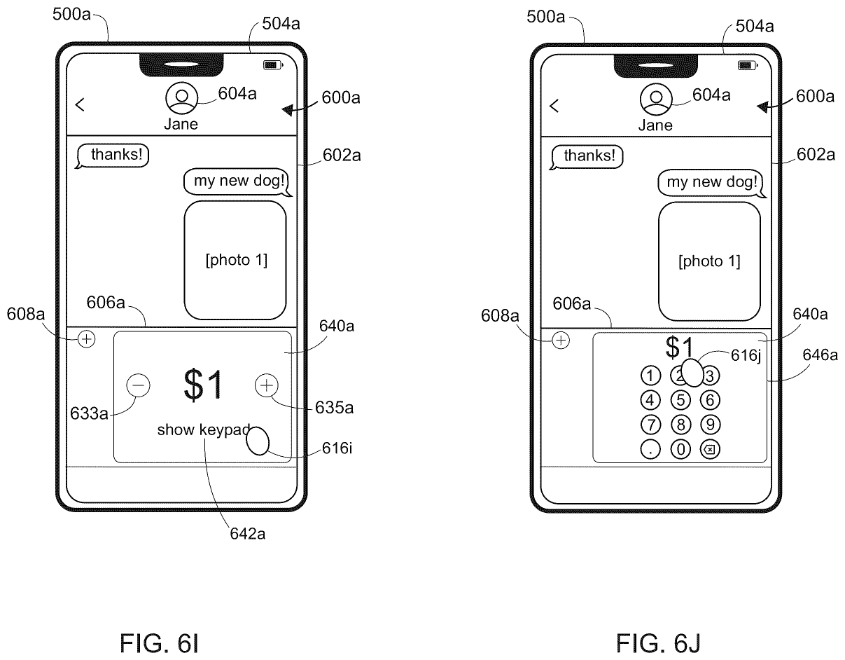

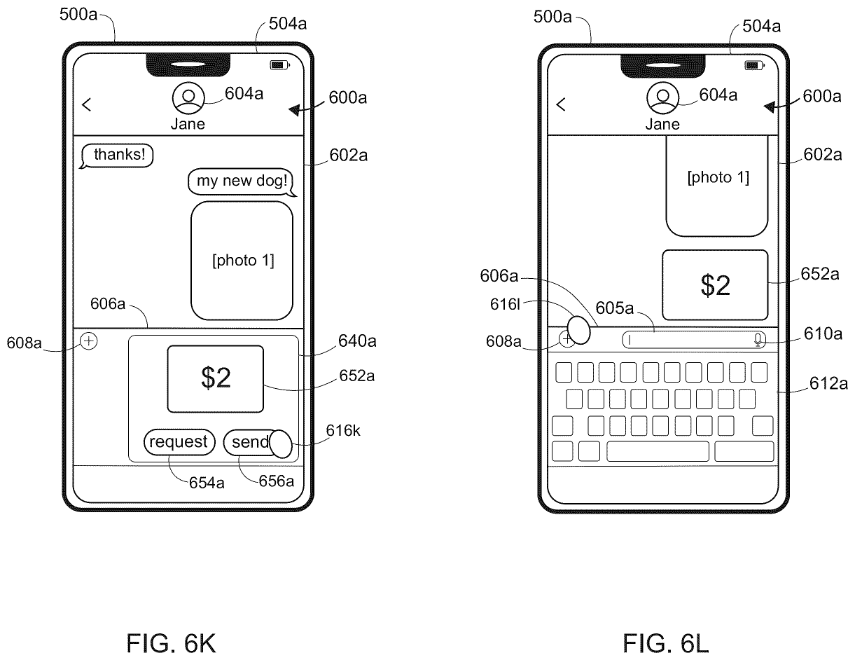

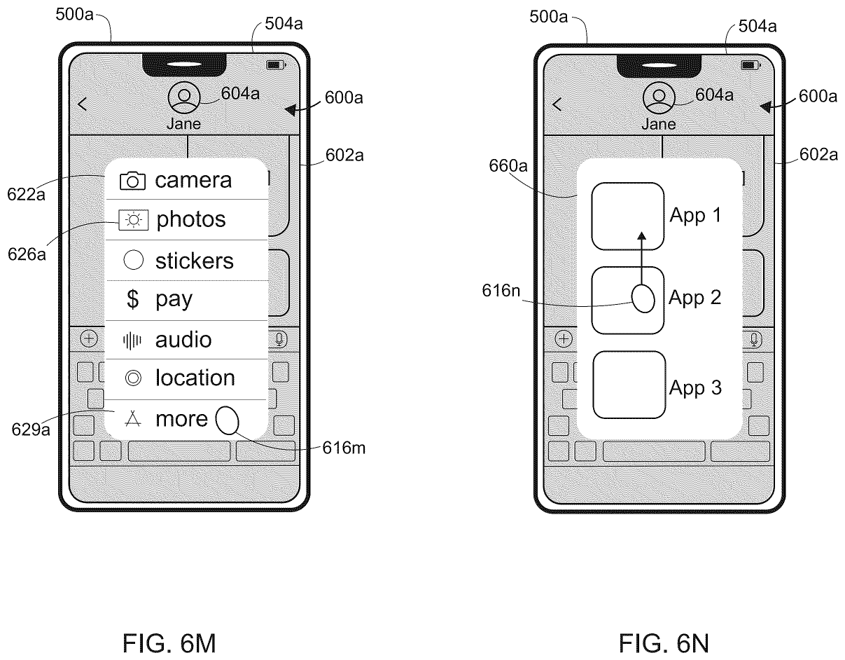

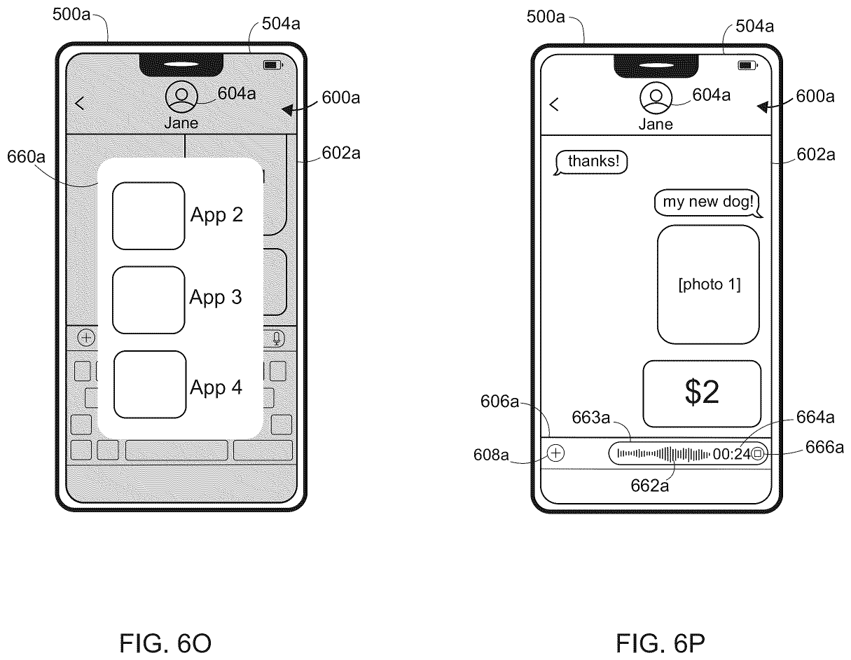

FIGS. 6A-6P illustrate exemplary ways of updating an input field of a messaging application user interface 600a in accordance with a respective application user interface in accordance with some embodiments of the disclosure. The embodiments in these figures are used to illustrate the processes described below, including the processes described with reference to FIGS. 7A-7I. These figures are not meant to be limiting; other user interfaces are possible in accordance with method 700 without departing from the scope of the disclosure.

FIGS. 6A-6P illustrate an example electronic device 500a displaying user interfaces for composing and/or sending messages that include content from a respective application user interface. As shown at least in FIG. 6A, the electronic device 500a includes a touch screen 504a. In FIG. 6A, the electronic device 500a displays a messaging application user interface 600a including a messaging conversation 602a, a visual representation 604a of a second user account (e.g., avatar of Jane) associated with a second electronic device different from the electronic device 500a, an input field 606a, and soft keyboard 612a. As shown in FIG. 6A, the messaging conversation is between a user account of the electronic device 500a and the second user account of the second electronic device. Messages sent from the user account associated with the electronic device 500a are optionally displayed on a right side of the messaging conversation 602a, and messages received from the second user account associated with the second electronic device are optionally displayed on the left side of the messaging conversation 602a. The input field 606a is a visual demarcation that includes an entry field 605a (e.g., text entry field) configured to accept text and/or content (e.g., images, videos, and/or audio messages) and/or one or more selectable options. The visual appearance of the input field 606a in FIGS. 6A-6C is controlled by an operating system of the electronic device 500a. In some embodiments, and as shown in FIG. 6A, the input field 606a includes selectable option 608a (e.g., plus sign icon) that, when selected, causes the electronic device 500a to display an application selection user interface as described with reference to method 700. As shown in FIG. 6A, the input field 606a also includes selectable option 610a (e.g., microphone icon) that, when selected, causes the electronic device 500a to enter text into the input field in response to receiving a dictation input including spoken words, the text corresponding to the spoken words, as described with reference to method 1100.

As illustrated in FIG. 6A, the electronic device 500a receives a user input 616a directed to one or more keys of the soft keyboard 612a. In some embodiments, the electronic device 500a detects an air pinch gesture (e.g., in which an index finger and thumb of a hand of the user come together to make contact) while attention of the user associated with the electronic device 500a is directed to the one or more keys of the soft keyboard 612a. In some embodiments, the electronic device 500a detects tap(s) of contact(s) at location(s) on the touch screen 504a where the electronic device 500a displays the one or more keys of the soft keyboard 612a. In some embodiments, user inputs illustrated in FIGS. 6A-6P (such as user input 616a in FIG. 6A) include one or more characteristics of the first user input described with reference to method 700.

In response to receiving the user input 616a directed to the one or more keys of the soft keyboard 612a in FIG. 6A, the electronic device 500a in FIG. 6B displays text 618a (e.g., “my new dog!!”) into the entry field 605a of the input field 606a corresponding to the user input 616a. From FIG. 6A to FIG. 6B, the electronic device 500a ceases display of the selectable option 610a (e.g., dictation option) and instead displays selectable option 614a (e.g., upward pointing arrow icon or send option) because the entry field 605a of the input field 606a has been populated with the text 618a. In some embodiments, when selected, the selectable option 614a causes the electronic device 500a to add content from the input field 606a as a message into the messaging conversation 602a. In FIG. 6B, the electronic device 500a receives user input 616b directed to the selectable option 614a (e.g., send option). In response to receiving the user input 616b directed to selectable option 614a (e.g., send option) in FIG. 6B, the electronic device 500a in FIG. 6C adds a message corresponding to representation 620a that includes the text 618a (e.g., “my new dog!!”) into the messaging conversation 602a.

FIGS. 6C-6G illustrate examples of the electronic device 500a sending a message including a photo after updating an input field in response to detecting selection of a photos application via an application selection user interface. Because the message corresponding to representation 620a including the text 618a has been sent to the second user account associated with the second electronic device, the input field 606a (including the entry field 605a) in FIG. 6C is no longer populated with text. As shown in FIG. 6C, since no text is currently displayed in the entry field 605a, the electronic device 500a ceases display of the selectable option 614a (e.g., send option) and instead redisplays the selectable option 610a (e.g., dictation option). In FIG. 6C, the electronic device receives user input 616c directed to the selectable option 608a (e.g., plus sign icon).

In response to receiving the user input 616b directed to selectable option 608a (e.g., plus sign icon) in FIG. 6C, the electronic device 500a displays an application selection user interface in the messaging application user interface 600a, as shown in FIG. 6D. In some embodiments, while displaying the application selection user interface, the electronic device 500a modifies the appearance of the messaging application user interface 600a to be dimmer (e.g., as in FIG. 6D), less bright, more blurry, less saturated in color, and/or with a reduced visual prominence compared to the appearance of the application user interface (e.g., a first portion of the application user interface 622a as shown in in FIG. 6D). As default, the electronic device 500a displays the first portion of the application selection user interface 622a in FIG. 6D in response to receiving the user input 616c shown in FIG. 6C. In some embodiments, in response to an additional input (e.g., a scrolling input) as described with reference to method 700, a second portion of the application selection user interface 622a is displayed instead of the first portion of the application selection user interface 622a. As illustrated, the first portion of the application selection user interface 622a includes selectable options corresponding to a camera application, a photos application 624a, a stickers application, a payment application, an audio messages application, and a location sharing application. Optionally, the first portion of the application selection user interface 622a also includes a “more” option that, when selected, causes the electronic device 500a to display an application store or library with various applications. In some embodiments, any number of applications from the application store or library can be added to the second portion of the application selection user interface as described with reference to method 700. The second portion the application selection user interface includes selectable options not displayed in the first portion of the application selection user interface 622a, for example. In FIG. 6D, the electronic device 500a receives user input 616d directed to a selectable option corresponding to photos application 624a. In some embodiments, the option for selecting the photos application 624a is represented by an image 626a stored on the electronic device 500a, such as a most recent photo (e.g., mountain photo as illustrated in FIG. 6D).

In response to receiving the user input 616d directed to a selectable option corresponding to photos application 624a in FIG. 6D, the electronic device 500a ceases display of the soft keyboard 612a from FIG. 6D and instead displays a gallery of photos 630a including photo 632a (e.g., photo 1), as shown in FIG. 6E. Further, as shown in FIG. 6E, the electronic device 500a updates the input field 606a in accordance with the photos application 624a such that the updated input field 606a is a visual demarcation including a user interface element 607a corresponding to the photos application 624a and one or more selectable options corresponding to the photos application 624a (e.g., selectable option 608a). The updated input field 606a no longer includes the entry field 605a of FIGS. 6A-6C into which text and/or content can be entered using the soft keyboard 612a of FIGS. 6A-6C. Instead, the electronic device 500a displays user interface element 607a corresponding to the photos application 624a (e.g. illustrated as an entry field in FIG. 6E but is different from the entry field 605a) into which the electronic device 500a can enter text and/or photos. Unlike the input field 606a of the FIGS. 6A-6C, the updated input field of FIGS. 6E-6F is controlled by the photos application 624a rather than the operating system of the electronic device 500a.

As shown in FIG. 6E, while six photos are displayed in the gallery of photos 630a, any suitable number of photos can optionally be displayed in the gallery of photos 630a. In some embodiments, the gallery of photos 630a is scrollable so that the user is able to select from more photos than the number of photos that the electronic device 500 displays concurrently. In some embodiments, the electronic device 500a updates the input field 606a in accordance with the photos application 624a by ceasing display of the selectable option 610a (e.g., dictation option) from FIGS. 6A-6C in the input field 606a and instead displays the gallery of photos 630a in the input field 606a as described with reference to method 700. In some embodiments, a soft keyboard is displayed in the messaging application user interface 600a when the input field 606a is updated to include the gallery of photos 630a. In some embodiments, a soft keyboard is not displayed in the messaging application user interface 600a when the input field 606a is updated to include the gallery of photos 630a. In FIG. 6E, user input 616e is directed to the photo 632a (e.g., photo 1).

In response to receiving an input 616e selecting the photo 632a (e.g., photo 1) in FIG. 6E, the electronic device 500a updates the input field 606a to include the photo 632a (e.g., photo 1) in FIG. 6F. Further, in FIG. 6F, the electronic device 500a displays the selectable option 614a (e.g., send option) corresponding to the photos application 624a in the input field 606a. In FIG. 6F, the electronic device 500a receives a user input 616f directed to the selectable option 614a (e.g., send option) in the input field 606a.

In response to selecting the selectable option 614a (e.g., send option) in FIG. 6F, the electronic device 500a adds a message including the photo 632a (e.g., photo 1) into the messaging conversation 602a, as shown in FIG. 6G. Because the message including the photo 632a has been sent to the second user account associated with the second electronic device, the electronic device 500a updates the appearance of the input field 606a to the appearance of the input field 606a in FIG. 6C (e.g., before receiving the user input 616d directed to the photos application 624a in FIG. 6D), such that the input field 606a includes the entry field 605a, and optionally redisplays the soft keyboard 612a. That is, in FIG. 6G, the electronic device 500a ceases display of the user interface element 607a including the selectable option 614a (e.g., send option) corresponding to the photos application 624a and instead redisplays the selectable option 610a (e.g., dictation option). In FIG. 6G, the electronic device 500a receives user input 616g directed to the selectable option 608a (e.g., plus sign icon). It should be understood that the order in which the user interfaces illustrated in FIGS. 6C through 6G is one example of the order in which the user interfaces can be presented.

FIGS. 6H-6L illustrate sending a message including a payment amount after updating an input field in accordance with selecting a payment application via the application selection user interface. In response to receiving user input 616g directed to selectable option 608a (e.g., plus sign icon) in FIG. 6G, the electronic device 500a displays an application selection user interface in the messaging application user interface 600a in FIG. 6H. The application selection user interface 622a in FIG. 6H includes one or more characteristics of the application selection user interface 622a displayed in FIG. 6D. As shown in FIG. 6H, the electronic device 500a has updated the image of 626a to reflect the update a change in the most recent photo stored on the electronic device 500a (e.g., change from the mountain photo in FIG. 6D to a sun photo in FIG. 6H). In FIG. 6H, the electronic device 500a receives a user input 616h directed to a selectable option corresponding to payment application 628a.

In response to receiving the user input 616h directed to a selectable option corresponding to payment application 628a in FIG. 6H, the electronic device 500a updates the input field 606a in accordance with the payment application 628a in FIG. 6I. As shown in FIG. 6I, updating the input field 606a in accordance with the payment application 628a includes displaying the updated input field 606a as a visual demarcation including a user interface element 640a corresponding to the payment application 628a and one or more selectable options corresponding to the payment application 628a (e.g., selectable options 633a and 635a). The updated input field 606a no longer includes the entry field 605a of FIG. 6G into which text and/or content can be entered using the soft keyboard 612c of FIG. 6G and no longer displays the soft keyboard 612c from FIG. 6G. Instead, the electronic device 500a displays the user interface element 640a corresponding to the payment application 628a into which the electronic device 500 can enter content to be sent to the messaging conversation. Unlike the input field 606a of the FIG. 6G, the updated input field of FIGS. 6I-6K is controlled by the payment application 628a rather than the operating system of the electronic device 500a. In some embodiments, and throughout this disclosure as described with reference to methods 700, 900 and/or 1100, when an application controls the input field 606a and/or the content of the input field 606a, the electronic device 500a replaces the input field 606a with a user interface of the application that is controlling the input field 606a and/or the content of the input field 606a.

As shown in FIG. 6I, the user interface element 640a includes options to enter an amount in a default or a user-defined currency (e.g., using the illustrated selectable option 633a (e.g., minus option to decrease amount in the default or the user-defined currency) and selectable option 635a (e.g., plus option to increase amount in the default or the user-defined currency)). In FIG. 6I, the electronic device 500a updates the input field 606 in accordance with the payment application 624a by ceasing display of the selectable option 610a (e.g., dictation option) from FIG. 6G in the input field 606a. As illustrated, the user interface element 640a of the input field 606 includes selectable option 642a that, when selected, causes the electronic device 500a to display an expanded state of the payment keypad.

In response to receiving the input 616i selecting selectable option 642 in FIG. 6I, the electronic device 500a displays a payment keypad 646a in the user interface element 640a corresponding to the payment application 628a in FIG. 6J. In FIG. 6J, the payment keypad 646a includes various keys, each of the keys corresponding to a respective numerical digit. As illustrated in FIG. 6J, the electronic device 500a receives user input 616j directed to a key corresponding to “2”.

Accordingly, in response to receiving the user input 616j in FIG. 6J, the electronic device 500a updates the user interface element 640a in the input field 606a to include a visual representation 652a of the amount entered (e.g., $2), selectable option 654a (e.g., request option), and selectable option 656a (e.g., send option) in FIG. 6K. When selected, the selectable option 654a (e.g., request option) causes the electronic device 500a to send a message requesting a payment amount (e.g., $2) from the second user account associated with the second electronic device in some embodiments. When selected, the selectable option 654a (e.g., request option) causes the electronic device 500a to send a message including a payment amount (e.g., $2) to the second user account associated with the second electronic device in some embodiments. In FIG. 6K, the electronic device 500a receives user input 616k directed to the selectable option 656a (e.g., send option). It should be noted that the visual appearance of an updated input field in accordance with a selected application, including selectable options, is controlled by the selected application; thus, the visual appearance of the selectable option 656a (e.g., send option) in FIG. 6K is different from the selectable option 656a (e.g., send option) corresponding to the photos application 624a in FIG. 6F. In some embodiments, and throughout this disclosure as described with reference to methods 700, 900 and/or 1100, the electronic device 500a interacts with a user interface of the application that is controlling the input field 606a and/or content of the input field 606a only after and/or while the user interface of the application that is controlling the input field 606a and/or content of the input field 606a has replaced and/or populated the input field 606a. In some embodiments, and throughout this disclosure as described with reference to methods 700, 900 and/or 1100, the electronic device 500a cannot interact with a user interface of the application that is controlling the input field 606a and/or content of the input field 606a unless and until the user interface of the application that is controlling the input field 606a and/or content of the input field 606a has replaced and/or populated the input field 606a.

In response to receiving the input 616k selecting the selectable option 656a (e.g., send option) in FIG. 6K, the electronic device 500a adds a message including the visual representation 652a (e.g., payment amount of $2) into the messaging conversation 602a in FIG. 6L. Because the message corresponding to the visual representation 652a has been sent to the second user account associated with the second electronic device, the electronic device 500a updates the appearance of the input field 606a to the appearance of the input field 606a in FIG. 6G (e.g., before receiving the user input 616h directed to the payment application 628a in FIG. 6H), such that the input field 606a includes the entry field 605a, and redisplays the soft keyboard 612a. That is, in FIG. 6L, the electronic device 500a ceases display of the user interface element 640a and instead redisplays the selectable option 610a (e.g., dictation option). In FIG. 6L, the electronic device 500 receives user input 616l directed to the selectable option 608a (e.g., plus sign icon). It should be understood that the order in which the user interfaces illustrated in FIGS. 6G through 6L is one example of the order in which the user interfaces can be presented.

In response to receiving user input 616l directed to selectable option 608a (e.g., plus sign icon) in FIG. 6M, the electronic device 500a displays the first portion of application selection user interface 622a in the messaging application user interface 600a in FIG. 6M. As described with reference to method 700, the first portion of the application selection user interface 622a includes a fixed set of application user interface elements that cannot be rearranged. As illustrated in FIG. 6M, the first portion of the application selection user interface 622a also includes selectable option 629a (e.g., “more” option). In some embodiments, the electronic device 500a does not accept scrolling from a first region to a second region within the first portion of the application selection user interface 622a. Instead, a scroll input received when the first portion of the of the application selection user interface 622a results in the display of a second portion of the application selection user interface instead of the first portion of the application selection user interface 622a.

As shown in FIG. 6M, the electronic device 500a receives an input 616m selecting selectable option 629a (the “more” option). In response to receiving the input 616m selecting the selectable option 629a (e.g., “more” option) in FIG. 6M, the electronic device 500a displays a second portion (e.g., second page) of the application selection user interface 660a and ceases display of the first portion (e.g., first page) of the application selection user interface 622a in FIG. 6N. As shown in FIG. 6N, receiving the input selecting the selectable option 629a (e.g., “more” option) optionally causes the electronic device 500a to vertically scroll from the first portion of the application selection user interface 622a in FIG. 6M to the second portion (e.g., second page) of the application selection user interface 660a in FIG. 6N. As described with reference to method 700, the second portion of the application selection user interface 660a includes a variable set of application user interface elements that can be rearranged based on “drag” and “drop” inputs in some embodiments. In some embodiments, application user interface elements can be added and/or removed from the second portion of the application selection user interface 660a. In some embodiments, as described with reference to method 700, receiving an input corresponding to a request to scroll can cause the electronic device 500a to scroll the second portion of the application selection user interface 660a by an amount corresponding to the magnitude of the input. As shown in FIG. 6N, the electronic device 500a displays “Application 1”, “Application 2”, and “Application 3” from top to bottom in the second portion of the application selection user interface 660a. Further, in FIG. 6N, the electronic device 500a receives user input 616n corresponding to a request to scroll the second portion of the application selection user interface 660a down.

In response to receiving the user input 616n corresponding to a request to scroll the second portion of the application selection user interface 660a down in FIG. 6N, the electronic device 500a scrolls the second portion of the application selection user interface 660a down, such that the electronic device 500a displays “Application 2”, “Application 3”, and “Application 4” from top to bottom in second portion of the application selection user interface 660a in FIG. 6O.

In FIG. 6P, the electronic device 500a displays the input field 606a in accordance with an audio messages application. The input field 606a corresponding to the audio messages application, including various inputs that cause the electronic device 500a to display the input field 606a corresponding to the audio messages application, are described in more detail below with reference to method 1100. The electronic device 500a updates the input field 606a to include user interface element 663a corresponding to the audio messages application. The user interface element 663a includes a representation of a sound waveform 662a corresponding to an audio message, a time indication 664a, and selectable option 666a to stop recording of the audio message as described in detail with reference to method 1100. As shown in FIG. 6P, for certain applications, such as the audio messages application, the electronic device 500a does not display a soft keyboard when updating the input field 606a in accordance with a respective application (e.g., because the user interface element 663a does not include an entry field to accept text from a soft keyboard).

FIGS. 7A-7I are flow diagrams illustrating a method of updating an input field of a messaging application user interface in accordance with a respective application user interface in accordance with some embodiments of the disclosure. The method 700 is optionally performed at an electronic device such as device 100, device 300, device 500a, 500b, and/or 500c as described above with reference to FIGS. 1A-1B, 2-3, 4A-4B and 5A-5H. Some operations in method 700 are, optionally combined and/or order of some operations is, optionally, changed.

As described below, the method 700 provides ways in which an electronic device updates an input field of a messaging application user interface in accordance with a respective application user interface. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, the method 700 is performed at an electronic device, such as electronic device 500a in FIG. 5, in communication with a display generation component and one or more input devices. For example, a mobile device (e.g., a tablet, a smartphone, a media player, or a wearable device), a computer (e.g., a desktop computer, a laptop computer), or a wearable device (e.g., a watch, a head-mounted device), is optionally in communication with one or more of a mouse (e.g., external), trackpad (optionally integrated or external), remote control device (e.g., external), another mobile device (e.g., separate from the electronic device), a handheld device (e.g., external), and/or a controller (e.g., external, etc.), or a set-top box in communication one or more input devices (e.g., a remote control). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc.

In some embodiments, the electronic device displays (702a), via the display generation component, a messaging application user interface, such as messaging application user interface 600a in FIG. 6A, that includes an input field, such as input field 606a in FIG. 6A. In some embodiments, the messaging application user interface corresponds to and/or includes a messaging conversation that includes messages sent from a user account (e.g., phone number, e-mail address, or social media account) associated with the electronic device and/or messages received from one or more other user accounts associated with respective users. In some embodiments, messages sent from the user account associated with the electronic device are displayed on a first side of the messaging conversation and/or user interface (e.g., the right side) and messages received from another user account associated with the other user account are displayed on a second side (e.g., the left side) of the messaging conversation and/or user interface. In some embodiments, the input field is a message composition field, and the messaging application user interface further includes a selectable option that, when selected, causes the electronic device to send the contents (e.g., text, images, videos, location sharing, location sharing request, payment, payment request, and/or audio messages) entered into the input field to the other user accounts and/or the messaging conversation in or as a message in the messaging conversation. In some embodiments, in response to one or more text entry inputs corresponding to a request to add user-specified text to the input field, the electronic device displays the user-specified text in the input field. In some embodiments, the one or more text entry inputs are received using a hardware keyboard, a soft keyboard, and/or dictation. In some embodiments, a selectable option corresponding to dictation is displayed in a portion of the input field. In some embodiments, the electronic device detects dictation by detecting speech via a microphone included in the one or more input devices. In some embodiments, the input field is a visual demarcation including an entry field (e.g., text entry field), editable content, and one or more selectable options (e.g., an option to display an application user interface as described with respect to step(s) 704, a send option as described with reference to step(s) 712, or a dictation option). In some embodiments, the option to display an application user interface as described with respect to step(s) 704 is displayed in the messaging applications user interface outside the input field.

In some embodiments, while displaying the messaging application user interface, the electronic device receives (702b), via the one or more input devices, a first user input, such as user input 616d in FIG. 6D, directed to an option for selecting a respective application user interface element in the messaging application user interface. In some embodiments, receiving the first user input includes interaction with one or more user interface elements in the messaging application user interface. For example, the electronic device detects an air pinch gesture (e.g., in which an index finger and thumb of a hand of the user come together to make contact) directed toward the one or more selectable options and/or the user interface object (e.g., while attention of the user is directed to a selectable option or a user interface object). In some embodiments, the electronic device detects the first user input via a hardware input device (e.g., a controller) in communication with the electronic device (e.g., press of a button on the controller). In some embodiments, the electronic device detects a tap of a contact at a location on a touch-sensitive display where the electronic device displays the user interface object. In some embodiments, the first user input has one or more characteristics of inputs described with reference to methods 900 and/or 1100. The respective applications optionally include a media application (e.g., television, camera, or photos), a location application, an audio messages application, a payment application, a health application, a web browsing application, and/or any application whose content can be shared into the messaging conversation. In some embodiments, the option for selecting a respective application user interface element is displayed with a respective visual indication such as an icon that represents the respective application (e.g., most recent photo for photos application). In some embodiments, the icon is unique and provides an indication that the option corresponds to a respective application.

In some embodiments, in response to receiving the first user input (702c), in accordance with a determination that the respective application user interface element is a first application user interface element, such as photos application 624a, the electronic device updates (702d) the input field of the messaging application user interface with a first visual appearance, such as a visual appearance of the input field 606a in FIGS. 6E and 6F, in accordance with the first application user interface element. In some embodiments, in response to receiving the first user input, the electronic device updates the input field in accordance with the first application user interface element such that the updated input field is a visual demarcation including editable content or a user interface corresponding to the first application and one or more selectable options (e.g., a send option as described with reference to step(s) 712) corresponding to the first application. In some embodiments, the entry field, such as the text entry field, (e.g., displayed in the input field prior to receiving the first user input) is replaced with a user interface corresponding to the first application in the input field. In some embodiments, no entry field exists outside the user interface corresponding to the first application, into which text and/or content can be entered (e.g., using a soft keyboard or otherwise). In some embodiments, in response to receiving the first user input, the only location into which text and/or content can be entered into is the user interface of the first application in the input field. In some embodiments, updating the input field with the first visual appearance includes displaying interactable visual representations corresponding to and/or user interfaces of the first application in the input field. In some embodiments, content from the first application user interface element and/or the second application user interface element cannot be interacted with and/or shared in the messaging conversation until the input field is updated with the first visual appearance and/or the second visual appearance (e.g., displaying interactable visual representations corresponding to the first application and/or the second application in the input field). For example, if the first application includes a media application such as a photos application and the option corresponds to the photos application (e.g., icon of most recent photo stored in the electronic device), then the electronic device optionally updates the input field with a visual appearance corresponding to the photos application by displaying a user interface element associated with and/or a user interface of the photos application in the input field. In some embodiments, the soft keyboard is replaced with a gallery of photos that are selectable. Once one or more photos are selected from the gallery of photos, the user interface of the photos application displayed in the input field includes the one or more selected photos. In some embodiments, the user interface of the photos application displayed in the input field includes a gallery of photos that are selectable in the input field. Once one or more photos are selected from the input field along with optionally a selectable option (e.g., send option) in the messaging application user interface, the electronic device optionally transmits the selected photos to another electronic device via the messaging application user interface and/or to the messaging conversation as a message. In some embodiments, the electronic device displays the first interactable visual representation and/or user interface of the first application without displaying the interactable visual representation and/or user interface of the second application described below. In some embodiments, the first application user interface element is associated with the first application.

In some embodiments, in response to receiving the first user input (702c), in accordance with a determination that the respective application user interface element is a second application user interface element, such as a payment application 628a in FIG. 6H, different from the first application user interface element, the electronic device updates (702e) the input field of the messaging application user interface with a second visual appearance, such as visual appearance of the input field 606a in FIGS. 6I to 6L, different from the first visual appearance in accordance with the second application user interface element. In some embodiments, in response to receiving the first user input, the electronic device updates the input field in accordance with the second application user interface element such that the updated the input field is a visual demarcation including editable content or a user interface corresponding to the second application and one or more selectable options (e.g., a send option as described with reference to step(s) 712) corresponding to the second application. In some embodiments, the editable content, user interface, and/or selectable options corresponding to the second application is different from the editable content, user interface, and/or selectable options corresponding to the first application. In some embodiments, the entry field, such as the text entry field, (e.g., displayed in the input field prior to receiving the first user input) is replaced with a user interface corresponding to the second application in the input field. In some embodiments, no entry field exists outside the user interface corresponding to the second application, into which text and/or content can be entered (e.g., using a soft keyboard or otherwise). In some embodiment, in response to receiving the first user input, the only location into which text and/or content can be entered into is the user interface of the second application in the input field. For example, if the second application includes a payment application, then the electronic device optionally updates the input field with the second visual appearance (e.g., displaying a user interface element associated with the payment application in the input field). In some embodiments, the input field with the second visual appearance includes the keypad corresponding to the payment application to enter an amount in a default or a user-defined currency to request or send a payment. Once the amount is entered via the keypad in the input field and the request option is selected, the electronic device optionally transmits a visual indication requesting payment to another electronic device. Once the amount is entered via the keypad in the input field and the send option is selected, the electronic device optionally transmits a visual indication sending the payment to another electronic device. In some embodiments, the electronic device does not update the input field with the first visual appearance and/or the second visual appearance before receiving the first user input. In some embodiments, the second application user interface element is associated with a second application different from the first application described above. In some embodiments, the soft keyboard is displayed concurrently with content from the first or second application user interface elements displayed in the input field. In some embodiments, the display of the soft keyboard was maintained before receiving the first user input. The display of the soft keyboard is optionally maintained while or in response to receiving the first user input. In some embodiments the soft keyboard displayed concurrently with the content from the first or second application user interface elements is the same soft keyboard used to enter text into the first input field prior to the input field being populated with content from the first or second application user interface elements and/or after the first input field is no longer populated with content from the first or second application user interface elements. In some embodiments, the input field is a visual demarcation including an entry field into which text or other content can be entered and/or selectable objects. Displaying a respective user interface element in an input field of a messaging application user interface based on a type of application selected allows for sending messages associated with a variety of applications, thereby improving user-device interactions.

In some embodiments, while displaying the input field of the messaging application user interface without the respective application user interface element (before receiving, via the one or more input devices, the first user input directed to the option for selecting the respective application user interface element in the messaging application user interface), the electronic device receives (704a), via the one or more inputs devices, a second user input, such as user input 616c in FIG. 6C (e.g., different from the first user input and/or includes one or more characteristics of the first user input), directed to the messaging application user interface.

In some embodiments, in response to receiving the second user input, the electronic device displays (704b), via the display generation component, an application selection user interface, such as application selection user interface in FIG. 6D, that includes a plurality of application user interfaces including the respective application user interface element, wherein at least one application user interface is configurable to be added to, removed from, or rearranged in the application selection user interface. In some embodiments, the application user interface includes one or more selectable options corresponding to user interfaces elements associated with respective applications. In some embodiments, in response to detecting selection of a selectable option corresponding to a respective application, the electronic device updates the input field of the messaging application user interface in accordance with the selected respective application, as described with respect to step(s) 702. In some embodiments, the selectable options displayed in the application selection user interface are displayed with respective visual indications such as an icon that represents the respective application (e.g., most recent photo for photos application). In some embodiments, the icon is unique and provides an indication that the selectable option corresponds to a respective application. In some embodiments, the electronic device does not display the application selection user interface unless and until receiving the second user input. In some embodiments, the electronic device displays the application selection user interface overlaid on the messaging conversation. In some embodiments, while displaying the application selection user interface, the electronic device displays the messaging conversation with reduced visual emphasis, such as displaying the messaging conversation with darker and/or less saturated colors, reduced brightness, and/or increased translucency compared to the appearance of the messaging conversation before displaying the application selection user interface. In some embodiments, when the electronic device displays the application selection user interface, the electronic device ceases display of the messaging conversation. In some embodiments, applications can be rearranged in the application selection user interface by dragging and/or dropping applications. Displaying an application selection user interface, in which application user interfaces can be added, removed, and/or rearranged, allows access to a variety of applications when sending messages, thereby improving user-device interactions.

In some embodiments, the application selection user interface includes a first portion, such as first portion of the application selection user interface 622a in FIG. 6D, including a fixed set of application user interface elements (706). In some embodiment, the fixed set of application user interface elements correspond to default applications, such as a camera application, a photos application, a stickers application, a payment application, an audio messages application, a location sharing application, and/or an application store. When the first portion is displayed, a second portion of the application selection user interface is optionally not displayed. In some embodiments, the order in which the applications are displayed in the first portion cannot be changed. In some embodiments, applications cannot be added to the first portion nor removed from the first portion. In some embodiments, applications can be added or removed from the second portion, as described in more detail below with reference to step(s) 708. Displaying a fixed set of application user interface elements in a first portion of an application selection user interface reduces the number of inputs needed to select default applications when sending messages, thereby improving user-device interactions.

In some embodiments, the first portion of the application selection user interface includes a user interface element, such as selectable option 628a in FIG. 6M (e.g., an icon or button corresponding to a more option) (708a).

In some embodiments, the electronic device receives (708b), via the one or more input devices, a second user input, such as user input 616m in FIG. 6M (e.g., different from the first user input and/or includes one or more characteristics of the first user input) directed towards the user interface element.

In some embodiments, in response to receiving the second user input (708c), the electronic device ceases (708d) display of the first portion of the application selection user interface and displays (708c), via the display generation component, a second portion, such as a second portion of the application selection user interface 660a in FIG. 6N, different from the first portion of the application selection user interface, wherein the second portion of the application user interface includes a variable set of application user interface elements (e.g., different from the fixed set of application user interface elements). When the second portion is displayed, the first portion of the application selection user interface is optionally not displayed. In some embodiments, the electronic device displays the second portion of the application selection user interface at the displayed location at which the first portion of the application selection user interface was previously displayed. In some embodiments, selection of the user interface element (e.g., an icon or button corresponding to a more option) causes scrolling from the first portion to the second portion of the application selection user interface. In some embodiments, the variable set of application user interfaces elements correspond to third party applications. In some embodiments, third party applications include applications that are provided by an entity other than the manufacturer of the electronic device, such as a third-party gaming application, a third-party weather application, a third-party health application. In some embodiments, one or more application user interface elements are optionally added to, removed from, and/or rearranged in the second portion of the application selection user interface as described above with reference to step(s) 704. In some embodiments, the order of the variable set of application user interface elements displayed in the second portion of the application selection user interface is based on amount of usage of each of the variable set of application user interface elements. For example, a more frequently selected variable application user interface element is displayed is optionally displayed first or at the top of the second portion compared to a less frequently selected variable application user interface element. Displaying a variable set of application user interface elements in a second portion of the application selection user interface allows access to additional applications not displayed in the first portion of the application selection user interface when sending messages, thereby improving user-device interactions.

In some embodiments, while displaying the application selection user interface, the electronic device receives (710a), via the one or more input devices, an input (e.g., different from the first user input) corresponding to a request to scroll the application selection user interface, such as user input 616n in FIG. 6N. In some embodiments, the electronic device detects a swipe gesture (e.g., swiping up, swiping down, swiping left, and/or swiping right) in contact with a touch-sensitive display of the electronic device, such that the swipe gesture causes the electronic device to scroll the application user interface. In some embodiments, the application user interface includes a selectable button (e.g., icon with upward pointing arrow, icon with downward pointing arrow, icon with left pointing arrow, and/or icon with right pointing arrow) that, when selected (e.g., tapped), causes the electronic device to scroll (e.g., up, down, left, and/or right) the application user interface.

In some embodiments, in response to receiving the input corresponding to the request to scroll the application selection user interface (710b), in accordance with a determination that the input corresponding to the request to scroll the application selection user interface was received while displaying the first portion of the application selection user interface, the electronic device scrolls (710c) from the first portion of the application selection user interface to the second portion of the application selection user interface (e.g., as a fixed scroll), such as scrolling from the first portion of the application selection user interface 622a in FIG. 6M to the second portion of the application selection user interface 660a in FIG. 6N, irrespective of a magnitude of the input corresponding to the request to scroll the application selection user interface. In some embodiments, scrolling from the first portion to the second portion of the application selection user interface includes vertical or horizontal scrolling. In some embodiments, the electronic device does not accept scrolling from a first region to a second region within the first portion of the application selection user interface. Instead, a scroll input received when the first portion of the of the application selection user interface results in the display of the second portion instead of the first portion of the application selection user interface.

In some embodiments, in response to receiving the input corresponding to the request to scroll the application selection user interface, in accordance with a determination that the input corresponding to the request to scroll the application selection user interface was received while displaying the second portion of the application selection user interface, the electronic device scrolls (710d) the application selection user interface by an amount corresponding to the magnitude of the input corresponding to the request to scroll the application selection user interface, such as scrolling the second portion of the application selection user interface 660a in FIG. 6O by an amount corresponding to the magnitude of user input 616n of FIG. 6N (e.g., as a free scroll). In some embodiments, the electronic device accepts scrolling from a first region to a second region within the second portion of the application selection user interface. In some embodiments, if the magnitude (e.g., of speed, duration, and/or distance) of the input is relatively high, then the electronic device scrolls through the second portion of the application selection user interface by a relatively large amount. In some embodiments, if the magnitude (e.g., of speed, duration, and/or distance) of the input is relatively low, then the electronic device scrolls through the second portion of the application selection user interface by a relatively small amount. In some embodiments, the electronic device scrolls from the second portion back to the first portion of the application selection user interface in response to a scrolling input with a magnitude (e.g., of speed, duration, and/or distance) of the input and/or direction of the input corresponding to scrolling to the first portion of the application selection user interface. In some embodiments, scrolling from the first region to the second region within the second portion and/or scrolling from the second portion back to the first portion of the application selection user interface includes vertical or horizontal scrolling. Scrolling from a first portion to a second portion of an application selection user interface as a fixed scroll but scrolling within the second portion as a free scroll prevents unintended results from erroneous input when navigating different portions of the application selection user interface, thereby improving user-device interactions.

In some embodiments, in response to receiving the first user input, the electronic device updates (712a) the input field of the messaging application user interface with a respective visual appearance, such as visual appearance of input field 606a in FIGS. 6E and 6F or visual appearance of input field 606a in FIGS. 6I to 6K (e.g., first visual appearance or second visual appearance), in accordance with the respective application user interface element (e.g., first application user interface element or second application user interface element) and the first user input (as described with reference to step(s) 702). In some embodiments, the respective visual appearance of the input field is a visual appearance of the user interface of the respective application after the input field has been updated in accordance with the respective application user interface, as described with respect to step(s) 702. In some embodiments, prior to receiving the first user input, the visual appearance of the input field is controlled by the operating system of the electronic device. In some embodiments, in response to and/or after receiving the first user input, the appearance of the input field that has been updated in accordance with the user interface of the respective application is controlled by the respective application installed on the electronic device. In some embodiments, if the respective application user interface element corresponds to a photos application, then the respective visual appearance of the input field includes a gallery of photos. In some embodiments, if the respective application user interface element corresponds to a photos application, then the respective visual appearance of the input field includes one or more selected photos (e.g., from a gallery of photos, which is displayed instead of the soft keyboard, in response to the first user input). For example, if the respective application user interface element corresponds to a payment application, then the respective visual appearance of the input field optionally includes a keypad corresponding to the payment application.

In some embodiments, while displaying the messaging application user interface with the input field having the respective visual appearance, the electronic device receives (712b), via the one or more input devices, a second user input (e.g., different from the first user input and/or includes one or more characteristics of the first user input) corresponding to a request to update the respective application user interface element, such as user input 616i in FIG. 6I.

In some embodiments, in response to receiving the second user input, the electronic device updates (712c) the input field of the messaging user interface with a respective visual appearance in accordance with the second user input, such as visual appearance of the input field 606a in FIG. 6J. In some embodiments, updating the input field of the messaging application user interface includes composing a message including the updated respective application user interface element and/or editing content corresponding to the respective application user interface such that the edited content is added to the messaging conversation. In some embodiments, the second user input includes direct interaction with content from the respective application user interface displayed in the input field of the messaging application user interface. In some embodiments, the second user input is directed to the gallery of photos displayed in the input field to select one or more photos. Accordingly, in response to the second user input, the respective visual appearance of the input field is updated from the gallery of photos to the one or more selected photos. In some embodiments, the second user input corresponds to a request to change a brightness, size, transparency, and/or other characteristic of the one more selected photos displayed in the input field. Accordingly, in response to the second user input, the respective visual appearance of the input field is updated from the one or more selected photos in accordance with the first user input to the modified one or more selected photos in accordance with the second user input. For example, the second user input is optionally directed to the keypad corresponding to the payment application (displayed in the input field) to enter an amount in a default or a user-defined currency to request or send a payment. Accordingly, in response to the second user input, the respective visual appearance of the input field is updated from the keypad corresponding to the payment application to the amount entered to request or send a payment, a request user interface element, and a send user interface element.

In some embodiments, the electronic device receives (712d), via the one or more input devices, a third user input, such as user input 616k in FIG. 6K (e.g., different from the first user input and/or includes one or more characteristics of the first user input), directed towards a send user interface element, such as selectable option 656a (e.g., send icon or button or a request icon or button), in the input field of the messaging application user interface. In some embodiments, the send user interface element is an icon and/or button indicating that selection of the send user interface element causes the electronic device to add content to the messaging conversation corresponding to the contents of the input field (e.g., the contents of the respective application user interface element).

In some embodiments, in response to receiving the third user input, the electronic device performs (712e) an operation corresponding to the respective application user interface element, such as sending a message including a payment to another electronic device as shown in FIG. 6L. In some embodiments, selecting the send user interface element causes the electronic device to add the updated content from the input field into the messaging conversation. In some embodiments, in response to the third user input, the electronic device optionally transmits the selected photos to another electronic device via the messaging conversation. For example, in response to the third user input, the electronic device optionally transmits a visual indication requesting payment to another electronic device or sending the payment to another electronic device via the messaging conversation. Displaying a respective user interface element in an input field of a messaging application user interface based on a type of application selected allows for sending messages associated with a variety of applications, thereby improving user-device interactions.

In some embodiments, while displaying the input field of the messaging application user interface without the respective application user interface element (before receiving, via the one or more input devices, the first user input directed to the option for selecting the respective application user interface element in the messaging application user interface), the electronic device receives (714a), via the one or more inputs devices, a second user input, such as user input 616c in FIG. 6C (e.g., different from the first user input and/or includes one or more characteristics of the first user input), directed to the messaging application user interface. In some embodiments, the second user input is directed to a selectable option (e.g., plus icon) in the messaging application user interface, such that the selectable option is selected.

In some embodiments, in response to receiving the second user input (714b), the electronic device reduces (714c) a visual prominence of the messaging application user interface, such as reducing the visual prominence of the messaging application user interface 600a in FIG. 6D. In some embodiments, reducing the visual prominence of the messaging application user interface includes updating the messaging application user interface to appear dimmer, less bright, more blurry, and/or less saturated in color than the appearance of the messaging application user interface prior to receiving the second user input.

In some embodiments, in response to receiving the second user input (714b), the electronic device displays (714d), via the display generation component, an application selection user interface, such as application selection user interface in FIG. 6D, over the messaging application user interface with the reduced visual prominence. In some embodiments, while the messaging application user interface appears dimmer, less bright, more blurry, and/or less saturated in color, a visual prominence of the application selection user interface is displayed with more visual prominence than the portions of the messaging application user interface currently being displayed. For example, the application selection user interface is displayed less dim, more bright, less blurry, and/or more saturated in color than the portions of the messaging application user interface currently being displayed. Reducing a visual prominence of messaging application user interface when displaying the application selection user interface reduces distractions to the user outside of the relevant portion (e.g., application selection user interface), thereby improving user-device interactions.

In some embodiments, in response to receiving the first user input, the electronic device updates (716a) the input field of the messaging application user interface with a respective visual appearance, such as visual appearance of the input field 606a in FIG. 6E (e.g., first visual appearance or second visual appearance), in accordance with the respective application user interface element (e.g., first application user interface element or second application user interface element) and the first user input (as described with reference to step(s) 702).

In some embodiments, while displaying the messaging application user interface with the input field having the respective visual appearance, the electronic device receives (716b), via the one or more input devices, a second user input, such as user input 616e in FIG. 6E (e.g., different from the first user input and/or includes one or more characteristics of the first user input), directed to a selectable element, such as photo 632 (e.g., button, icon, widget, affordance, playback control element, an image, a key of a keypad, or any other selectable object), included in the respective application user interface element In some embodiments, the second user input cause selection of the selectable element.

In some embodiments, in response to receiving the second user input, the electronic device performs (716c) an action associated with the respective application user interface element, such as adding the photo 632a to the input field 606a in FIG. 6F. In some embodiments, performing the action associated with the respective application user interface element includes displaying (e.g., additional) content in the input field that is associated with the respective application user interface element, such as an image, a location sharing map, video, and/or text, outputting audio, such as audio corresponding to music, podcast, and/or video and/or displaying a soft keyboard if not already displayed (e.g., for entering text in the input field of messaging application user interface). In some embodiments, performing the action associated with the respective application user interface element includes composing a message including content from respective application user interface element and/or editing content corresponding to the respective application user interface such that the edited content is added to the messaging conversation. In some embodiments, performing the action associated with the respective application user interface element includes adjusting a brightness, a volume, or other property of content included in the respective application user interface element. Direct interaction with selectable elements of the respective application user interface element in the input field of the messaging application user interface reduces the number of inputs needs to perform actions associated with the respective application user interface element, thereby improving user-device interactions.

In some embodiments, the action associated with the respective application user interface element includes revising content (e.g., that is associated with the respective application user interface element, such as an image, a location sharing map, video, text, audio message, or a numerical amount) to be added to a messaging conversation displayed in the messaging application user interface, such as adding the photo 632a to the input field 606a in FIG. 6F (718a). In some embodiments, in accordance with a determination that the action has a first characteristic, the electronic device revises (e.g., adjusts) the content in a first manner. For example, if the action with the first characteristic corresponds to changing a color saturation of a selected photo, the electronic optionally revises the content from the photos application in the first manner by updating the color saturation of the selected photo in a message added to the messaging conversation. In some embodiments, in accordance with a determination that the action has a second characteristic different from the first characteristic, the electronic device revises (e.g., adjusts) the content in a second manner different from the first manner. For example, if the action with the second characteristic corresponds to adding text in addition a selected photo in a message, the electronic optionally revises the content from the photos application in the second manner by including a text message along with the selected photo when adding the message to the messaging conversation.

In some embodiments, in response to receiving the second user input, the electronic device displays (718b), in the input field, a selectable option, such as selectable option 614a in FIG. 6F (e.g., a send icon or button) that, when selected, causes the electronic device to add the content to the messaging conversation, wherein the selectable option is not displayed prior to receiving the second user input, such as in FIG. 6E, which does not include option 614a included in FIG. 6F. In some embodiments, the selectable option not displayed unless and until the content to be added to the messaging conversation has been revised in accordance with the second user input. In some embodiments, the selectable option includes one or more characteristics of the send user interface element of step(s) 712. Displaying a selectable send option after receiving the second user input reduces erroneous inputs and/or prematurely sending a message that does not include the revised content, thereby improving user-device interactions.

In some embodiments, in response to receiving the first user input (720a), in accordance with a determination that the respective application user interface element is the first application user interface element (720b) (e.g., corresponding to a photos application, camera application, and/or sticker application), the electronic device updates (720c) the input field of the messaging application user interface with the first visual appearance in accordance with the first application user interface element (as described with respect to step(s) 702) such that the first application user interface element includes an entry field, such as entry field 607a in FIG. 6E (such as a text entry field that optionally accepts text input from a soft keyboard or an entry field that accepts content such as photos, stickers, and/or videos), and displays (720d) a soft keyboard, such optionally displaying soft keyboard 612a from FIG. 6A in FIG. 6E, in the messaging application user interface. In some embodiments, electronic device revises content of a message to be added to the messaging conversation based on interaction with elements other than the soft keyboard (e.g., selecting a sticker from a sticker gallery in the input field or selecting a photo from a photo gallery in the input field).

In some embodiments, in response to receiving the first user input (720a), in accordance with a determination that the respective application user interface element is the second application user interface element (720c) (e.g., corresponding to location sharing application or audio messages application), the electronic device updates (720d) the input field of the messaging application user interface with the second visual appearance different from the first visual appearance in accordance with the second application user interface element (as described with respect to step(s) 702) such that the first application user interface element does not include the entry field, such as the input field 606a not including an entry field in FIG. 6P (optionally cannot accept text input from the soft keyboard or other content), and forgoes (720g) displaying the soft keyboard in the messaging application user interface, such as forgoing display of a soft keyboard in FIG. 6P. In some embodiments, electronic device revises content of a message to be added to the messaging conversation based on interaction with elements other than the soft keyboard (e.g., location sharing user interface elements and/or audio messaging user interface elements displayed in the input field). In some embodiments, when updating the input field in accordance with a first application user interface element (e.g., stickers, camera, or photos application), the input field also includes a text entry field. However, in some embodiments, when updating the input field in accordance with a second application user interface element (e.g., location sharing or audio messages application), the input field does not include text entry field. Displaying a soft keyboard when the input field is updated in accordance with a first application user interface element but forgoing displaying of a soft keyboard when the input field is updated in accordance with a second application user interface element avoids consuming computing resources when not needed.

In some embodiments, the second application user interface element includes an audio messaging application user interface element, such as audio messaging application in FIG. 6P, or a location sharing application user interface element (722). In some embodiments, when updating the input field in accordance with a location sharing and/or audio messages application user interface element as described with reference to methods 900 and/or 1100, respective input fields do not include text entry fields. Forgoing display of a soft keyboard for in the messaging application user interface when the input field is updated in accordance with a location sharing application or an audio messages application avoids consuming computing resources when not needed.

In some embodiments, in response to receiving the first user input (724a), in accordance with a determination that the respective application user interface element is the first application user interface element, the electronic device updates (724b) the input field of the messaging application user interface with the first visual appearance such that the first application user interface element includes a first set of user interface elements, such as selectable option 616f in FIG. 6F, (e.g., button, icon, widget, affordance, playback control element, an image, a key of a keypad, and/or the application-specific selectable described below with reference to step 734) in accordance with the first application user interface element. In some embodiments, updating the input field in accordance with the first application user interface element includes displaying a user interface corresponding to the first application including a first set of user interface elements. In some embodiments, the type of user interface elements displayed in the updated input field and location of the user interface elements in the updated input field is based on the respective application user interface element that has been selected. For example, if a first application user interface element is selected, then a first type of the user interface elements is optionally displayed in the updated input field and/or the first type of the user interface elements are optionally displayed at respective first locations in the input field. For example, a send option (e.g., specific to photos application), a gallery of photos, and/or selected photos from the gallery of photos are optionally displayed in the updated input field when updating the input field in accordance with a photos application. In some embodiments, the first application user interface element does not include a second set of user interface elements as described below.

In some embodiments, in response to receiving the first user input, in accordance with a determination that the respective application user interface element is the second application user interface element different from the first application user interface element, the electronic device updates (724c) the input field of the messaging application user interface with the second visual appearance different from the first visual appearance such that the second application user interface element includes a second set of user interface elements, such as selectable options 654a and 656a in FIG. 6K, (e.g., button, icon, widget, affordance, playback control element, an image, a key of a keypad, and/or the application-specific selectable described below with reference to step 734) different from the first set of user interface elements in accordance with the second application user interface element. In some embodiments, updating the input field in accordance with the second application user interface element includes displaying a user interface corresponding to the second application including a second set of user interface elements. For example, if a second application user interface element is selected, then a second type of the user interface elements are optionally displayed in the updated input field and/or the second type of the user interface elements are displayed at respective second locations in the updated input field. For example, send and request options for location sharing and/or a map of a location of electronic device are optionally displayed in the input field when updating the input field in accordance with a location sharing application. In some embodiments, the second application user interface element does not include the first set of user interface elements. Updating user interface elements in the input field of a messaging application user interface in accordance with a respective application user interface element simplifies performing actions associated with the respective application user interface and reduces erroneous inputs, thereby improving user-device interactions.

In some embodiments, receiving, via the one or more input devices, the first user input directed to the option for selecting the respective application user interface element, such as respective application user interface element inf FIG. 6D, includes receiving the first user input directed to the option for selecting a camera application user interface element, a photos application user interface element, a stickers application user interface element, a payment application user interface element, an audio messaging application user interface element, a location sharing application user interface element, or an application store application user interface element (726). In some embodiments, if the camera application user interface element is selected when sending a message, the electronic device adds a message including a new image captured by a camera of the electronic device and/or an existing image stored on the electronic device to the messaging conversation. In some embodiments, if the photos application user interface element is selected when sending a message, the electronic device adds a message including an image stored on the electronic device to the messaging conversation. In some embodiments, if the stickers application user interface element is selected when sending a message, the electronic device adds a message including a sticker stored on the electronic device to the messaging conversation. In some embodiments, if the payment application user interface element is selected when sending a message, the electronic device adds a message including text and/or a numerical amount for sending or requesting a payment to the messaging conversation. In some embodiments, if the audio messaging application user interface element is selected when sending a message, the electronic device adds a message including an audio message (optionally corresponding text transcription) to the messaging conversation. In some embodiments, if the location application user interface element is selected when sending a message, the electronic device adds a message including a map of a location of the electronic device or text requesting location of another electronic device to the messaging conversation. In some embodiments, if the application store application user interface element is selected when sending a message, the electronic device adds a selected application from the application store to the second portion of the application selection user interface with reference to step(s) 708, updates the input field in accordance with the selected application, and/or adds a message including content from the selected application to the messaging conversation. Providing diverse options when selecting a respective application user interface allows for sending messages associated with a variety of applications, thereby improving user-device interactions.

In some embodiments, receiving, via the one or more input devices, the first user input directed to the option for selecting the respective application user interface element (e.g., corresponding to photos application) includes receiving the first user input directed to a user interface element representing an image, such as image 626a in FIG. 6D, (e.g., most recent photo or color sample of most recent photo) stored on the electronic device (728a) (e.g., displayed in the first portion of the application selection user interface of step 706). In some embodiments, the electronic device updates the image of the user interface element in response to new images being added to a photo library associated with the electronic device.

In some embodiments, in response to detecting selection of the user interface element representing the image stored on the electronic device, the electronic device updates (728b) the input field of the messaging application user interface to include a photos application user interface element, such as updating the input field 606a in accordance with the photos application 624a in FIG. 6E. In some embodiments, the photos application user interface element includes a gallery of photos based on selection of the user interface element representing the image stored on the electronic device. In some embodiments, the electronic device adds a message including selected photos from the gallery of photo to the messaging conversation. In some embodiments, the input field is not updated with the gallery of photos unless and until receiving the selection of the user interface element representing the image stored on the electronic device. In some embodiments, the input field is updated with the gallery of photos and/or selected photos from the gallery of photos based on the electronic device receiving an input directed to the user interface element displayed in the first portion of the application selection user interface of step 706, where the user interface element represents a most recent photo stored on the electronic device. A user interface element representing an image stored on the electronic device provides visual feedback indicating that the user interface element corresponds to the photos application user interface.

In some embodiments, while displaying the messaging user interface with the input field including a text entry field, such as entry field 605a in FIG. 6A, (and optionally a dictation user interface element) and not including the respective application user interface element (before receiving, via the one or more input devices, the first user input directed to the option for selecting the respective application user interface element in the messaging application user interface), and while displaying a soft keyboard in the messaging user interface (730a), the electronic device receives (730b), via the one or more input devices, one or more inputs (e.g., different from the first user input and/or includes one or more characteristics of the first user input) directed to the soft keyboard.

In some embodiments, in response to receiving the one or more inputs, such as user input 616a in FIG. 6A, directed to the soft keyboard, such as soft keyboard 612a in FIG. 6A, the electronic device updates (730c) the text entry field to include text, such as text 618a in FIG. 6B, corresponding to the one or more inputs directed to the soft keyboard. In some embodiments, composing a message includes the electronic device populating the text entry field with text corresponding to inputs directed to respective keys of a soft keyboard (e.g., tapping keys). In some embodiments, after the message is composed, the electronic device adds the message including the entered text to the messaging conversation in response to receiving input directed to a selectable option displayed in the input field, such as the selectable button (e.g., default send button) described below with respect to step(s) 732. In some embodiments, aside from the text entered into text entry field, a visual appearance of the text entry field maintains the same visual appearance before and after receiving the one or more inputs. In some embodiments, the visual appearance of the text entry field before and after receiving the one or more inputs is different from the visual appearance of the respective user interface element in the updated input field in response to the first user input. Displaying a text entry field in the input field without the respective application user interface element allows for sending messages with text, thereby improving user-device interactions.

In some embodiments, while displaying the messaging application user interface without displaying the respective application user interface element in the input field (before receiving, via the one or more input devices, the first user input directed to the option for selecting the respective application user interface element in the messaging application user interface), the electronic device displays (732a), via the display generation component, a selectable option, such as selectable option 614a in FIG. 6B, (e.g., button, icon, widget, affordance, playback control element, an image, a key of a keypad, or other selectable option) in the input field. In some embodiments, the selectable option is not associated with the respective application user interface selected in response to the first user input. For example, a dictation button or a default send button is optionally displayed in the input when the respective application user interface element is not displayed in the input field. In some embodiments, in response to detecting selection of the selectable option, the electronic device adds a message including text corresponding to inputs directed to keys of a soft keyboard and/or a dictation input including spoken words, where the text corresponds to the spoken words, to the messaging conversation.

In some embodiments, in response to receiving the first user input, the electronic device ceases (732b) to display the selectable option in the input field, such as ceasing to display selectable option 614a from FIG. 6B in FIG. 6C. In some embodiments, instead of displaying the selectable option (e.g., a dictation button or a default send button), the electronic device displays an application-specific selectable option (e.g., application specific send button) as described below with reference to step 734. Ceasing display of a default selectable option in response to the first user input and selection of the respective application user interface helps avoid consuming computing resources when not needed.

In some embodiments, in response to receiving the first user input, the electronic device displays (734), via the display generation component, a selectable option, such as selectable options 654a and 656a in FIG. 6K, (e.g., button, icon, widget, affordance, playback control element, an image, a key of a keypad, or other selectable option that is different from selectable option of step(s) 732) in the input field, wherein the selectable option was not displayed while displaying the messaging application user interface without displaying the respective application user interface element in the input field (before receiving, via the one or more input devices, the first user input directed to the option for selecting the respective application user interface element in the messaging application user interface). In some embodiments, the selectable option displayed in the input field in response to receiving the first user input is application specific. For example, a send option (e.g., specific to photos application) is optionally displayed in the input field when updating the input field in accordance with a photos application. Meanwhile, both send and request options (e.g., specific to payment or location sharing) are optionally displayed in the input field when updating the input field in accordance with a payment or a location sharing application. In some embodiments, the send option for a payment application, when selected, causes the electronic device to send a payment amount in a default or a user-defined currency in message to another electronic device via a messaging conversation. In some embodiments, the request option for a payment application, when selected, causes the electronic device to request a payment amount in a default or a user-defined currency from another electronic device via a message displayed in the messaging conversation. In some embodiments, a share or send option for a location sharing application, when selected, causes the electronic device to send, via a messaging conversation, a message that includes a map of a current location of a user associated with the electronic device to another electronic device or resend, via the messaging conversation, the message that includes the map of the current location of the user associated with the electronic device to the other electronic device. In some embodiments, the request option for a payment application, when selected, causes the electronic device to request a payment amount in a default or a user-defined currency from another electronic device via a message displayed in the messaging conversation. In some embodiments, a request option for a location sharing application, when selected, causes the electronic device to send, via a messaging conversation, a message requesting a current location of a second user associated with the other electronic device. However, both the send and request options are not displayed in the input field prior to receiving the first user input (e.g., instead a default send option or dictation option is optionally displayed in the input field prior to receiving the first user input). Updating user interface elements (not previously displayed) in the input field of a messaging application user interface in accordance with a respective application user interface element simplifies performing actions associated with the respective application user interface and reduces erroneous inputs, thereby improving user-device interactions.

In some embodiments, the input field is displayed, via the display generation component, with a first characteristic (e.g., first size, first shape, and/or first color), such as the input field 606a with a first characteristic in FIG. 6A, while displaying the messaging application user interface without displaying the respective application user interface element in the input field (736a) (before receiving, via the one or more input devices, the first user input directed to the option for selecting the respective application user interface element in the messaging application user interface).

In some embodiments, in response to receiving the first user input, the electronic device updates (736b) the input field of the messaging application user interface from being displayed with the first characteristic to being displayed with a second characteristic (e.g., second size, second shape, and/or second color), such as the input field 606a with a second characteristic in FIG. 6F, different from the first characteristic. In some embodiments, the size, shape, and/or color of the input field is not changed prior to receiving the first input. In some embodiments, the input field is larger after receiving the first input (e.g., to accommodate for additional and/or revised content associated with a respective application user interface that is added into the input field). In some embodiments, the size, shape, and/or color of the input field while displaying the messaging application user interface without displaying the respective application user interface element in the input field is the same as the size, shape, and/or color of the input field in response to receiving the first user input. In some embodiments, the size, shape, and/or color of the input field varies based on the type of respective application user interface element selected. For example, if the respective application user interface element is a first application user interface element that has a third size and/or third shape, then the electronic device optionally updates the input field to a fourth size and/or fourth shape in accordance with the third size and/or third shape of the first application user interface element. If the respective application user interface element is a second application user interface element that has a fifth size and/or fifth shape different from the third size and/or third shape of the first application user interface, then the electronic device optionally updates the input field to a sixth size and/or sixth shape different from the fourth size and/or fourth shape of the input field in accordance with the fifth size and/or fifth shape of the first application user interface element. Changing the size and/or shape of the input field allows content from various respective application user interface element to be appropriately displayed in the input field of the messaging application user interface, thereby improving user-device interactions.

In some embodiments, while displaying the messaging application user interface without displaying the respective application user interface element in the input field (before receiving, via the one or more input devices, the first user input directed to the option for selecting the respective application user interface element in the messaging application user interface), the electronic device displays (738a), using the display generation component, a soft keyboard, such as soft keyboard 612a in FIG. 6A (because the input field optionally has a text entry field and accepts text input from the soft keyboard).

In some embodiments, in response to receiving the first user input, the electronic device ceases (738b) display of the soft keyboard, such as ceasing to display a soft keyboard in FIG. 6E (e.g., and updating the input field of the messaging application user interface with a respective visual appearance in accordance with a respective application user interface element and the first user input). In some embodiments, when the input field is updated in accordance with the respective application user interface element and the first user input, the input field no longer includes the text entry field and does not accept text input from the soft keyboard, so the electronic device does not display the soft keyboard. Ceasing display of a soft keyboard in response to the first user input helps avoid consuming computing resources when not needed.

It should be understood that the particular order in which the operations in FIGS. 7A-7I have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900 and 1100) are also applicable in an analogous manner to method 700 described above with respect to FIGS. 7A-7I. For example, the operation of the electronic device to present images in accordance with the pose of the electronic device described above with reference to method 700 optionally has one or more of the characteristics of the presentation of content associated with a map, a summary of captured content, and video while in a communication session described herein with reference to other methods described herein (e.g., methods 900 and 1100). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIGS. 7A-7I are, optionally, implemented by components depicted in FIGS. 1A-1B. For example, displaying operation 702a and/or receiving operation 702b are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Updating an Input Field of a Messaging Application User Interface in Accordance with a Location Sharing Application

Users interact with electronic devices in many different manners, including composing and/or sending messages. In some embodiments, an electronic device displays a messaging application user interface including an input field allowing a user to compose and/or send messages. The embodiments described below provide ways in which an electronic device updates an input field of a messaging application user interface in accordance with a location sharing application user interface. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

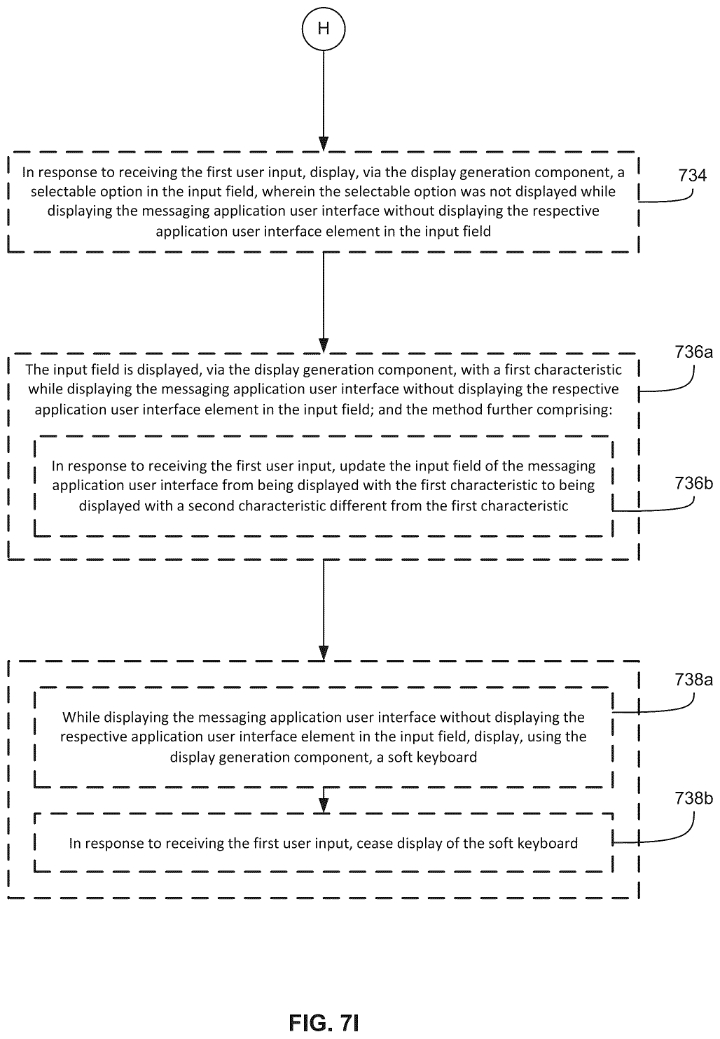

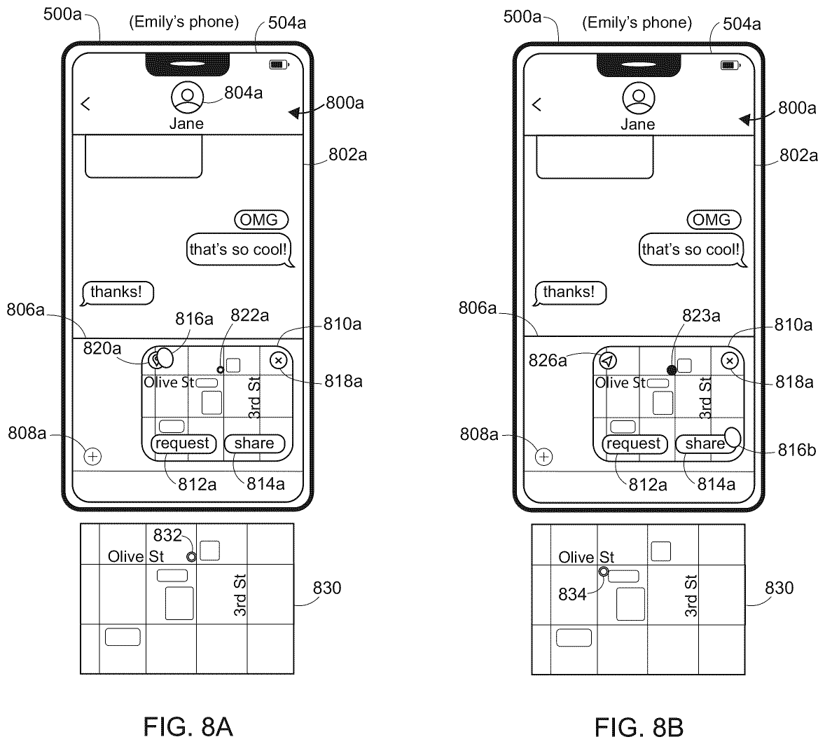

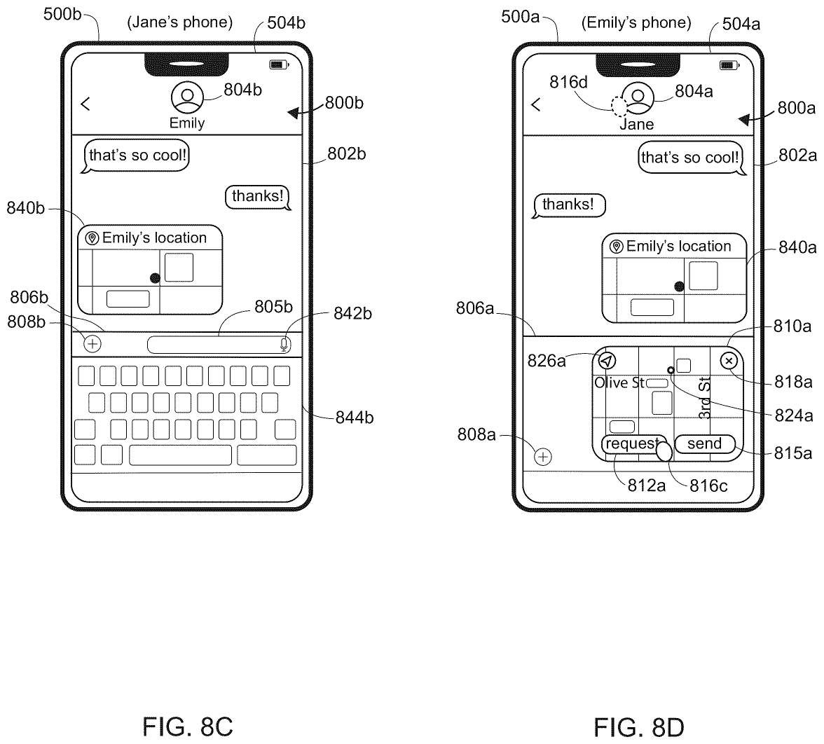

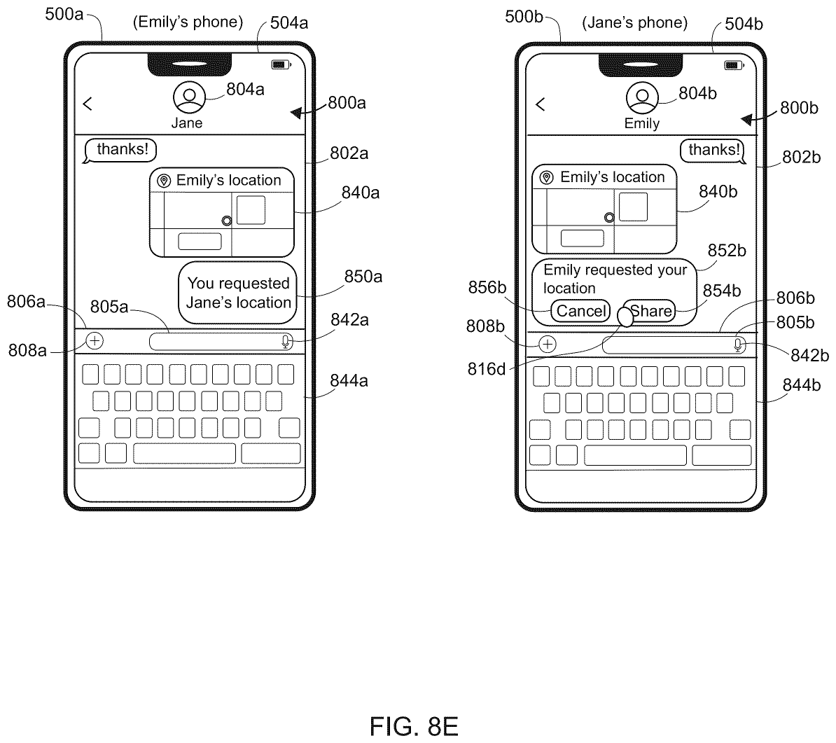

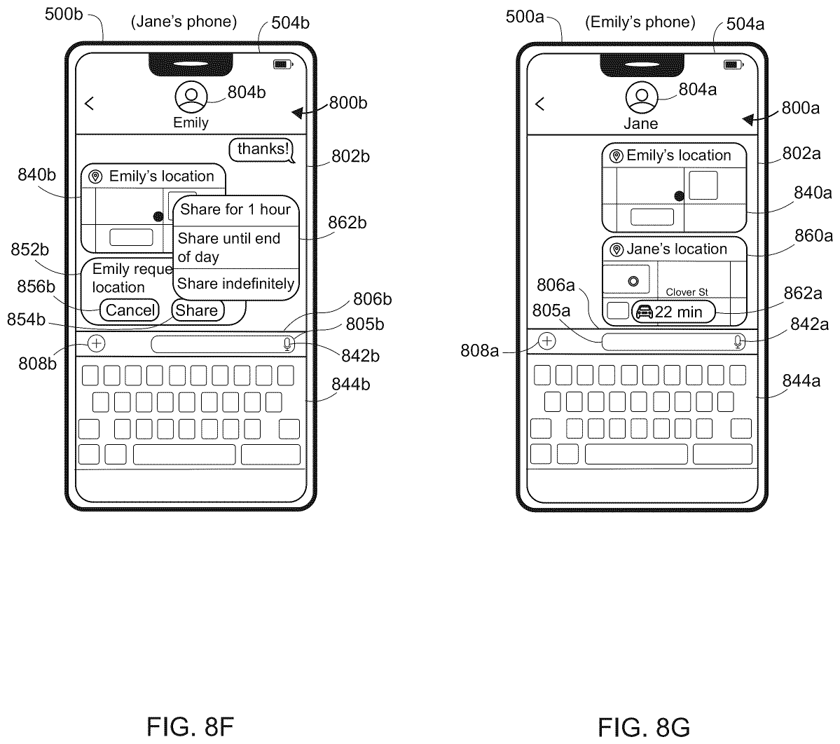

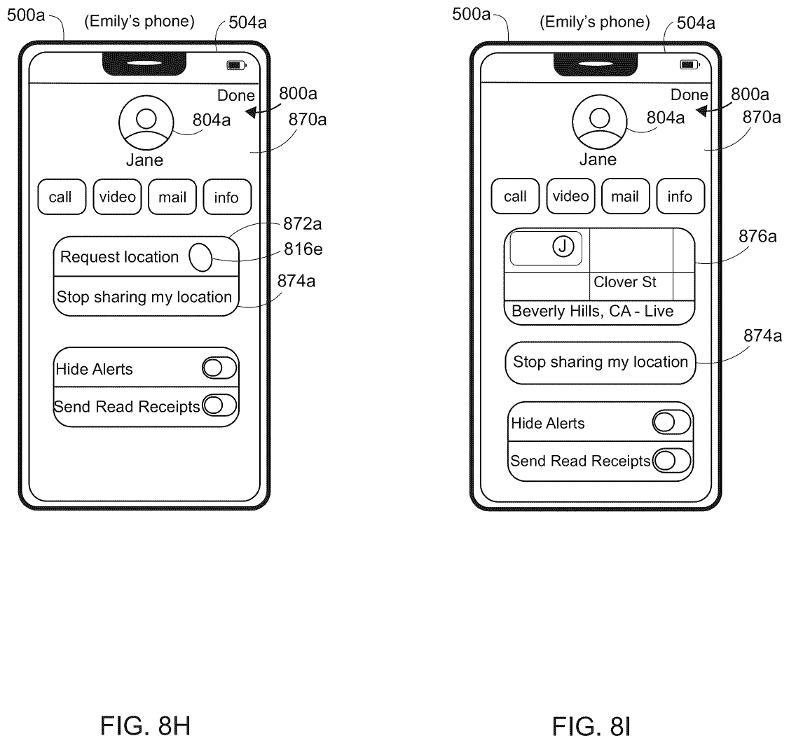

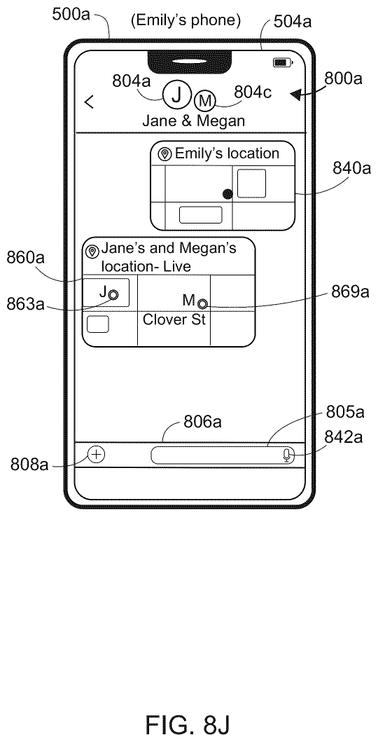

FIGS. 8A-8J illustrate exemplary ways of updating an input field of a messaging application user interface in accordance with a location application user interface in accordance with some embodiments of the disclosure. The embodiments in these figures are used to illustrate the processes described below, including the processes described with reference to FIGS. 9A-9I. These figures are not meant to be limiting; other user interfaces are possible in accordance with method 900 without departing from the scope of the disclosure.

FIGS. 8A-8J illustrate an example electronic device 500a or a second electronic device 500b displaying user interfaces for composing and/or sending messages that include content from a respective application user interface. As shown at least in FIG. 8A, the electronic device 500a includes a touch screen 504a. In FIG. 8A, the electronic device 500a displays a messaging application user interface 800a including a messaging conversation 802a, a visual representation 804a of a second user account (e.g., avatar of Jane) associated with a second electronic device different from the electronic device 500a, and an input field 806a. As shown in FIG. 8A, the messaging conversation is between a user account of the electronic device 500a and the second user account of the second electronic device. Messages sent from the user account associated with the electronic device 500a are optionally displayed on a right side of the messaging conversation 802a, and messages received from the second user account associated with the second electronic device are optionally displayed on the left side of the messaging conversation 802a. In FIGS. 8A-8B, the electronic device 500a has updated the input field 806a in accordance with a location sharing application as described with reference to method 700 such that the updated input field 806a is a visual demarcation including a user interface element 810a and one or more options corresponding to the location sharing application. The visual appearance of the input field 806a in FIGS. 8A-8B is controlled by the location sharing application installed on the electronic device 500a. In some embodiments, and as shown in FIG. 8A, the input field 806a includes selectable option 808a (e.g., plus sign icon) that, when selected, causes the electronic device 500a to display an application selection user interface as described with reference to method 700.

As shown in FIG. 8A, the user interface element 810a includes a map of a geographic area in which the electronic device 500a is located, wherein the current location of electronic device 500a is represented by visual indication 822a (e.g., pin, flag, or marker). The map optionally displays different levels of detail based on the zoom level. As shown in FIG. 8A, the map includes representations of roads, highways, buildings, businesses, and/or landmarks. The user interface element 810a includes selectable option 818a (e.g., cancel option) that, when selected, causes the electronic device 500a to optionally cease display of the user interface element 810a. The user interface element 810a includes selectable option 812a (e.g., request option) that, when selected, causes the electronic device 500a to optionally request location of the second electronic device associated with the second user account. The user interface element 810a includes selectable option 814a (e.g., share option) that, when selected, causes the electronic device 500a to optionally share location of the electronic device 500a with the second user account associated with the second electronic device. In some embodiments, the location of visual indication 822a within the map updates in accordance with the movement of the electronic device since the electronic device 500a is currently configured to send an updated location of the electronic device 500a to the messaging conversation. As shown in FIG. 8A, the actual location 832 of the electronic device 500a depicted in the legend 830 matches the current location the electronic device 500a represented by the visual indication 822a in the user interface element 810a. In some embodiments, while the electronic device 500a is configured to send an updated location of the electronic device 500a to the messaging conversation, the selectable option 820a in the user interface element 810a includes a first visual appearance as shown in FIG. 8A. When selected, the selectable option 820a causes the electronic device to be configured to send a static location of the electronic device 500a that does not update in accordance with movement of the electronic device 500a to the messaging conversation. In some embodiments, additionally or alternatively, in response to receiving selection of option 820a, the electronic device 500a updates the display of the map to include a visual indication of a respective location of the electronic device 500a that does not update in accordance with the movement of the electronic device 500a. In FIG. 8A, the electronic device 500a receives user input 816a directed to the selectable option 820a. In some embodiments, user inputs illustrated in FIGS. 8A-8J (such as user input 816a a in FIG. 8A) include one or more characteristics of the first user input described with reference to methods 700 and/or 900.

From FIG. 8A to 8B, the electronic device 500a has moved to a different location as depicted by actual location 834 in the legend 830. In response to receiving the input 816a in FIG. 8A directed to the selectable option 820a in FIG. 8A, the electronic device 500a became configured to send a static location of the electronic device 500a that does not update in accordance with further movement of the electronic device 500a to the messaging conversation. Additionally or alternatively, in response to receiving the input 816a in FIG. 8A directed to the selectable option 820a in FIG. 8A, the electronic device 500a updated the visual appearance of the selectable option 826a from the first visual appearance to a second visual appearance different from the first visual appearance in FIG. 8B. As shown in 8B, the electronic device 500a has replaced the visual indication from FIG. 8A with the visual indication 823a that corresponds to a static location of the electronic device 500a despite the electronic device 500a having moved to a different location as depicted by actual location 834 in the legend 830. Accordingly, in FIG. 8B, the visual indication 823a does not update in accordance with the movement of the electronic device 500a while selectable option 826a is displayed with the appearance shown in FIG. 8B. Further, the electronic device 500a receives user input 816b directed to the selectable option 814b (e.g., share option), as shown in FIG. 8B.

In response to receiving the user input 816a directed to the selectable option 816b (e.g., share option) in FIG. 8B, the electronic device 500a adds a message 840b including the respective location of the electronic device 500a into the messaging conversation in FIG. 8C. FIG. 8C illustrates a second electronic device 500b including a touch screen 504b. In FIG. 8C, the second electronic device 500b displays a messaging application user interface 800b including a messaging conversation 802b, a visual representation 804b of a user account (e.g., avatar of Emily) associated with the electronic device 500a, and an input field 806b. The input field 806a optionally is a visual demarcation that includes an entry field 805a (e.g., text entry field) configured to accept text and/or content (e.g., images, videos, and/or audio messages) (e.g., from a soft keyboard 844b) and/or one or more selectable options. The visual appearance of the input field 806a in FIG. 8C is controlled by an operating system of the second electronic device 500b, for example. In some embodiments, and as shown in FIG. 8C, the input field 806a includes selectable option 808a (e.g., plus sign icon) that, when selected, causes the second electronic device 500b to display an application selection user interface as described with reference to method 700. As shown in FIG. 8C, the input field 806a also includes selectable option 842b (e.g., microphone icon) that, when selected, causes the second electronic device 500b to enter text into the input field in response to receiving a dictation input including spoken words, the text corresponding to the spoken words, as described with reference to method 1100. Because the electronic device 500a has shared its current location with the second user account associated with the second electronic device 500b, the second electronic device 500b displays a message 840b including the current location of the electronic device 500a in FIG. 8C.

Because the electronic device 500a has already shared its location with the second user account associated with the second electronic device 500b in FIG. 8B, the electronic device 500a displays selectable option 815a (e.g., send option) in FIG. 8D rather than the selectable option (e.g., share option 814a from FIG. 8B. When selected, the selectable option 815a (e.g., send option) cause the electronic device 500a to reshare its current location (e.g., optionally as a new message in the messaging conversation 802a with the second user account associated with the second electronic device 500b. In FIG. 8D, the electronic device 500a receives user input 816c directed to the selectable option 812a (e.g., request option). Alternatively, in FIG. 8D, the electronic device 500a receives user input 816d directed to the visual representation 804a of a second user account (e.g., avatar of Jane). Because user input 816d is an alternative input, it is illustrated by dashed lines in FIG. 8D.

In response to the electronic device 500a receiving the input 816c directed to the selectable option 812a (e.g., request option) in FIG. 8D, the electronic device 500a displays a message 850a indicating that a user of the electronic device 500a has requested location of a second user of the second electronic device 500b in the messaging conversation 802a, as shown in FIG. 8E. In FIG. 8E, because the electronic device 500a sent the message requesting location of the second electronic device 500b associated with the second user account to the messaging conversation, the electronic device 500a updates the appearance of the input field 806a to an appearance before receiving user input directed to the location sharing application. In FIG. 8E, the updated input field 806a includes an entry field 805a, and the electronic device 500a optionally displays soft keyboard 844a. That is, in FIG. 8E, the electronic device 500a ceases display of the user interface element 810a corresponding to the location sharing application shown in FIG. 8D and instead displays the entry field 805a and selectable option 842a (e.g., dictation option). Additionally or alternatively in some embodiments, in response to the electronic device 500a sending the message requesting the location of the second electronic device 500b in response to the user input 816c shown in FIG. 8D, the second electronic device 500b displays message 852b indicating that the user account has requested location of the second electronic device 500b in the messaging conversation. The message 852b includes selectable option 854b (e.g., share option) that, when selected, causes the second electronic device 500b to share the current location of the second electronic device 500b with the user account of the electronic device 500a in the messaging conversation 802a. The message 852b also includes selectable option 856b (e.g., cancel option) that, when selected, causes the second electronic device 500b to forgo sharing current location of the second electronic device 500b with the user account of the electronic device 500a and optionally send an indication to the messaging conversation 802a that the location of the second electronic device 500b will not be shared. Further, In FIG. 8E, the second electronic device 500b receives user input 816d directed to the selectable option 854b (e.g., share option). For example, receiving user input 816d includes detecting a “long press” input in which the second electronic device 500b detects contact 816d at the location at which option 854b is displayed using touch screen 504b for more than a threshold time (e.g., 0.1, 0.2, 0.3, 0.5, 1, 2, or 3 seconds).

In some embodiments, in response to receiving the input 816d shown in FIG. 8E, the second electronic device 500b displays respective options 862b for sharing the current location of the second electronic device 500b with the user account of the electronic device 500a for an hour, till end of day, or indefinitely in FIG. 8F.

In some embodiments, the second electronic device 500b detects selection of one of the option 826b in FIG. 8F. In some embodiments, in response to detecting selection of one of the option 826b in FIG. 8F, the second electronic device 500b sends a message to the messaging conversation including the current location of the second electronic device 500b. In response to the second electronic device 500b sharing its current location with the user account associated with the electronic device 500, the electronic device 500a ceases display of message 850a from FIG. 8E and instead displays messages 860a including a map with the current location of the second electronic device 500b in FIG. 8G. Message 860a optionally replaces message 850a (e.g., message 860a is displayed in the same location as message 850a) in the messaging conversation 802a As shown in FIG. 8G, the message 860a includes selectable option 862a that, when selected, causes the electronic device 500a to initiate a process to present navigation directions to the current location of the second electronic device 500b as described with reference to method 900. In some embodiments, the selectable option 862a is a representation of a car (e.g., as illustrated in FIG. 8G), a train, a bus, a subway, a bicycle, a plane, a person walking, or any other available mode of transportation and/or corresponding estimated time of travel to the current location of the second electronic device 500b in accordance with the mode of transportation. For example, in response to detecting selection of selectable option 862a while option 862a includes in the indication of the car, the electronic device 500a initiates navigation to the current location of the second electronic device 500b by driving. As another example, if a different mode of transportation is indicated in option 862a, the electronic device 500a initiates navigation using the different mode of transportation in response to receiving an input selecting option 862a.

In some embodiments, the electronic device 500a receives inputs directed to location sharing options in a user interface 870a (e.g., details menu) instead of the messaging conversation 802a corresponding to the messaging application user interface. In some embodiments, the electronic device 500a displays a user interface 870a (e.g., details menu) in response to receiving an input directed to a visual representation (e.g., avatar) of a respective user account. Accordingly, in response to receiving the alternative user input 816d directed to the visual representation 804a of a second user account (e.g., avatar of Jane) in FIG. 8D, the electronic device 500a displays user interface 870a (e.g., details menu) instead of the messaging conversation 802a in the messaging application user interface 800a as described with reference to method 900. As shown in FIG. 8H, the user interface 870a (e.g., details menu) includes selectable option 872a (e.g., request option) that, when selected causes, the electronic device 500a to request current location of the second electronic device 500b because the second electronic device 500b is not sharing its location while the electronic device 500a displays the user interface in FIG. 8H. Selectable option 872a (e.g., request option) in the user interface 870a (e.g., details menu) serves as alternative manner for initiating the process for requesting the current location of the second electronic device 500b as described in FIGS. 8D-8E. Because the electronic device 500a has already shared location with the second user account associated with the second electronic device 500b in FIG. 8B, the electronic device 500a displays selectable option 874a that, when selected, causes the electronic device 500a to stop sharing its location with the second user account associated with the second electronic device 500b, in FIG. 8H. In some embodiments, if the electronic device 500a had not shared location with the second user account associated with the second electronic device 500b, the electronic device 500a displays, in the user interface 870a, instead a selectable option (e.g., share option) that, when selected, causes the electronic device 500a to share its location with the second user account associated with the second electronic device 500b. In FIG. 8H, the electronic device 500a receives user input 816e directed to the selectable option 872a (e.g., request option).

In response to the electronic device 500a requesting location of the second electronic device 500b in FIG. 8H, and the second electronic device 500b sharing its current location with the electronic device 500a as described in FIGS. 8E and 8F, the electronic device 500a ceases display of selectable option 872a (e.g., request option) and instead displays a map 876a including the current location of the second electronic device 500b in the user interface 870a (e.g., details menu) in FIG. 8I. As shown in FIG. 8I, the map 876a optionally replaces the selectable option 872a (e.g., request option) (e.g., map 876a is displayed in the same location as the selectable option 872a (e.g., request option)) in the user interface 870a (e.g., details menu).

FIG. 8J illustrates the electronic device 500a displaying message 860a including a location of the second electronic device 500b (e.g., Jane's device) and a location of a third electronic device (e.g., Megan's device as illustrated by visual representation 804c). For example, the map optionally includes a second visual indication 863a corresponding to a current location of a second electronic device 500b and a third visual indication 869b corresponding to a current location of a third electronic device. In some embodiments, the visual appearance of the second visual indication 863a is different from the visual appearance of the third visual indication 869b (e.g., to indicate which indication corresponds to which user/device). In some embodiments, the message includes the map with a current location of the electronic device 500a along with the second visual indication 863a and the third electronic device because the electronic device 500a has shared the current location of the electronic device 500a with the second electronic device 500b and the third electronic device as described with reference to method 900.

FIGS. 9A-9I are flow diagrams illustrating a method of updating an input field of a messaging application user interface in accordance with a location sharing application user interface in accordance with some embodiments of the disclosure. The method 900 is optionally performed at an electronic device such as device 100, device 300, device 500a, 500b, and/or 500c as described above with reference to FIGS. 1A-1B, 2-3, 4A-4B and 5A-5H. Some operations in method 900 are, optionally combined and/or order of some operations is, optionally, changed.

As described below, the method 900 provides ways in which an electronic device updates an input field of a messaging application user interface in accordance with a location sharing application user interface. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, the method 900 is performed at an electronic device, such as electronic device 500a in FIG. 5, in communication with a display generation component and one or more input devices. In some embodiments, the electronic device has one or more of the characteristics of the electronic device of methods 700 and/or 1100. In some embodiments, the display generation component has one or more of the characteristics of the display generation component of methods 700 and/or 1100. In some embodiments, the one or more input devices have one or more of the characteristics of the one or more input devices of methods 700 and/or 1100.

In some embodiments, the electronic device displays (902a), via the display generation component, a messaging application user interface, such as messaging application user interface 800a in FIG. 8A, that includes an input field, such as input field 806a in FIG. 8A. In some embodiments, the messaging application user interface has one or more characteristics of the messaging application user interface of methods 700 and/or 1100. In some embodiments, the input field has one or more characteristics of the input field of methods 700 and/or 1100. In some embodiments, the input field is a visual demarcation including an entry field (e.g., text entry field), editable content, and one or more selectable options (e.g., send option or dictation option).

In some embodiments, while displaying the messaging application user interface, the electronic device receives (902b), via the one or more inputs devices, a first user input corresponding to a request associated with location sharing, such as a user input directed to a selectable option corresponding to a location sharing application before displaying a first user interface element 810a associated with a location sharing application in FIG. 8A. In some embodiments, the first user input has one or more characteristics of the first user input of methods 700 and/or 1100. In some embodiments, the first user input is directed to a selectable option corresponding to a location sharing application in the messaging application user interface, such as selection from a menu of available applications as described with reference to method 700.

In some embodiments, in response to receiving the first user input, the electronic device displays (902c), via the display generation component, a first user interface element, such as user interface element 810a in FIG. 8A, associated with a location sharing application in the input field of the messaging application user interface, including one or more selectable options, such as selectable options 812a and 814a in FIG. 8A, that are selectable to adjust one or more characteristics of the location sharing. In some embodiments, in response to receiving the first user input, the electronic device updates the input field in accordance with the location sharing application such that the updated input field is a visual demarcation that includes the first user interface element including the one or more selectable options corresponding to the location sharing application. In some embodiments, the entry field, such as the text entry field, (e.g., displayed in the input field prior to receiving the first user input) is replaced with the first user interface element corresponding to the location sharing application in the input field. In some embodiments, no entry field exists outside the first user interface element, into which text and/or content can be entered (e.g., using a soft keyboard or otherwise). In some embodiments, in response to receiving the first user input, the only location into which text and/or content can be entered into is the first user interface element. In some embodiments, the first user interface element is an interactable visual representation corresponding to the location sharing application. For example, the first user interface element optionally includes a map with a visual indication (e.g., a pin, a marker, or a flag) of a location of the electronic device. In some embodiments, the map and/or the visual indication on the map is updated in or near real-time based on changes in location of the electronic device. In some embodiments, the first user interface element is interactable (e.g., modify characteristics of location sharing) while the first user interface element is displayed in the input field. In some embodiments, the computer system displays the first user interface element associated with a location sharing application in the input field of the messaging application user interface prior receiving a request and/or initiating any operation related to location sharing in a messaging conversation. In some embodiments, the first user interface element includes selectable options to request a (e.g., live or real-time) location of a different electronic device (e.g., the electronic device associated with another user account in the messaging conversation) and/or share the (e.g., live or real-time) location of the user of the electronic device. If the request option is selected, then the electronic device optionally transmits, to the messaging conversation, an indication of messaging activity corresponding to the location sharing that causes the electronic device to display, in the messaging conversation, a visual indication of that messaging activity, such as a visual indication that include a message requesting a location of and/or location sharing from the other user via the messaging conversation. The message requesting location and/or selectable option to share location is optionally displayed in a messaging application user interface of the other electronic device. For example, the message requesting the location of the other electronic device optionally includes text such as “User X is requesting your location.” After the visual indication requesting location is transmitted to the other user account, the electronic device updates the first user interface element to be displayed outside of the input field (e.g., displayed in the messaging conversation transcript in the messaging user interface) and to include a visual indication that the location of the other user has been requested. If the other user indeed shares the location of the other electronic device with the user of the electronic device, then the map in the first user interface element is updated to include a (e.g., live or real-real time) location of the other user. If the electronic device detects selection of the share option while the first user interface element is displayed in the input field, then the electronic device optionally transmits, to the messaging conversation, an indication of messaging activity corresponding to the location sharing that causes the electronic device to display, in the messaging conversation, a map with a (e.g., live or real-time) location of the electronic device to the other user account. In some embodiments, after the share option is selected, the electronic device optionally updates the first user interface element to include a selectable option to stop sharing the location of the electronic device with the other user account. In some embodiments, the first user interface element has one or more of the characteristics of the first application user interface element and/or second application user interface element of methods 700 and/or 1100. In some embodiments, the first user interface element interface element is partially or fully displayed in the input field. In some embodiments, the electronic device does not display the first user interface element before receiving the first user input. In some embodiments, a soft keyboard is not displayed concurrently with the first user interface element displayed in the input field. In some embodiments, a soft keyboard is displayed concurrently with the first user interface element displayed in the input field. In some embodiments, the display of the soft keyboard was maintained before receiving the first user input. The display of the soft keyboard is optionally maintained while or in response to receiving the first user input. In some embodiments the soft keyboard displayed concurrently with the first user interface element is the same soft keyboard used to enter text into the first input field prior to the input field being populated with the first user interface element and/or after the first input field is no longer populated with first user interface element. Displaying a user interface element corresponding to a location sharing application in an input field of a messaging application user interface allows for direct interaction with the location sharing application when sending messages, reduces the number of inputs needed to send a message requesting and/or sharing a location, and simplifies user interaction with the computer system, thereby improving user-device interactions.

In some embodiments, displaying, via the display generation component, the first user interface element associated with the location sharing application in the input field includes displaying a map of a physical area that includes a visual indication, such as visual indication 822a in FIG. 8A (e.g., a pin, a marker, or flag), of a current location of the electronic device that updates in accordance with movement of the electronic device (904). In some embodiments, the map is displaying a geographic area in which a user associated with the electronic device is located. In some embodiments, the map is interactable by the user to view different geographic locations. In some embodiments, the map is interactable by the user to change a zoom level. In some embodiments, the map displays different levels of detail based on the zoom level. For example, at a first zoom level, the map includes representations of roads and highways, and at a second zoom level, closer than the first zoom level (e.g., zoomed in further than the first zoom level), the map includes representations of buildings, businesses, and/or landmarks). In some embodiments, if the visual indication is at a first location on the map and the electronic device moves from the first location to a second location different from the first location, then the electronic device updates the visual indication of the current location of the electronic device on the map from the first location to the second location. In some embodiments, the electronic device updates the current location of the electronic device in accordance with the movement of the electronic device continuously, in or near real time, and/or at periodic time intervals (e.g., every 0.01, 0.1, 1, 10, 100 s). In some embodiments, the electronic device receives an input corresponding to a request share the current location of the electronic device, and in response to the input, the electronic device adds a message including the current location of the electronic device that updates in accordance with movement of the electronic device to the messaging conversation. Automatically updating a visual indication in accordance with changes in location of an electronic device provides visual feedback of a current location of the electronic device and reduces the number of inputs to do so, thereby improving user-device interactions.

In some embodiments, in response to receiving the first user input, the electronic device displays (906a), via the display generation component, the first user interface element, including displaying a map of a physical area that includes a visual indication of a current location of the electronic device that updates in accordance with movement of the electronic device (as described with reference to step 904) and the one or more selectable options that are selectable to adjust the one or more characteristics of the location sharing in the input field of the messaging application user interface (as described with reference to step(s) 902)), wherein the one or more selectable options include a selectable option (e.g., button, icon, widget, or affordance) corresponding to sharing a respective location of the electronic device that does not update in accordance with the movement of the electronic device. In some embodiments, the selectable option has a first visual appearance.

In some embodiments, the electronic device receives (906b), via the one or more input devices, a second user input (e.g., different from the first user input and/or includes one or more characteristics of the first user input) directed to the selectable option, such as selectable option 820a in FIG. 8A, corresponding to the respective location of the electronic device that does not update in accordance with the movement of the electronic device.

In some embodiments, in response to receiving the second user input, the electronic device updates (906c) display of the map of the physical area included in first user interface element from including the visual indication of the current location of the electronic device that updates in accordance with the movement of the electronic device, such as visual indication 822a in FIG. 8A to including a visual indication of the respective location of the electronic device that does not update in accordance with the movement of the electronic device, such as visual indication 822a in FIG. 8B. In some embodiments, the visual indication of the respective location of the electronic device that does not update in accordance with the movement of the electronic device has the same visual appearance as the visual indication of the current location of the electronic device that updates in accordance with the movement of the electronic device. In some embodiments, the visual indication of the respective location of the electronic device that does not update in accordance with the movement of the electronic device has a different visual appearance compared to the visual indication of the current location of the electronic device that updates in accordance with the movement of the electronic device. In some embodiments, in response to receiving the second user input, the selectable option is updated from the first visual appearance to a second visual appearance different from the first visual appearance. In some embodiments, the selectable option is not updated from the first visual appearance to the second visual appearance unless and until the second user input is received. In some embodiments, if a visual indication is at a first location on the map and the electronic device moves from the first location to a second location different from the first location, then the electronic device still maintains display of the visual indication at the first location on the map. The electronic device optionally does not update the visual indication of the current location of the electronic device on the map from the first location to the second location because the selectable option corresponding to the respective location of the electronic device that does not update in accordance with the movement of the electronic device has been selected. In some embodiments, in response to receiving a respective user input (e.g., different from the first user input and/or includes one or more characteristics of the first user input) directed to the selectable option with the second visual appearance, the electronic device updates display of the map from the respective location of the electronic device that does not update in accordance with the movement of the electronic device to a current location of the electronic device that does update in accordance with the movement of the electronic device. In response to selecting the selectable option with the second visual appearance in accordance with the respective user input, the electronic device updates the selectable option from the second visual appearance back to the first visual appearance. In some embodiments, the electronic device receives an input corresponding to a request share the respective location of the electronic device, and in response to the input, the electronic device adds a message including the respective location of the electronic device that does not update in accordance with movement of the electronic device to the messaging conversation. Forging updating a visual indication in accordance with changes in location of an electronic device reduces computing resources for updating the visual indication when not needed, thereby improving computer-device interactions.

In some embodiments, while displaying the first user interface element with the visual indication of the respective location of the electronic device that does not update in accordance with the movement of the electronic device (908a) (as described with reference to step(s) 906), the electronic device receives (908b) a third user input (e.g., different from the first user input), such as a dragging input if a third user input was received in FIG. 8B, directed to the visual indication of the respective location of the electronic device that does not update in accordance with the movement of the electronic device. In some embodiments, the third user input includes a tap of a contact at a location on a touch-sensitive display where the electronic device displays the visual indication causes selection of the visual indication and a subsequent dragging gesture corresponds to movement of the visual indication on the map. In some embodiments, the third user input includes a first tap of a contact at a first location on the touch-sensitive display where the electronic device displays the visual indication followed by a second tap of a contact at a second location on the touch-sensitive display, such that the visual indication is moved from the first location to the second location on the map in accordance with the first tap and the second tap.

In some embodiments, in response to receiving the third user input (908c), the electronic device updates (908d) a position within the map of the visual indication of the respective location of the electronic device that does not update in accordance with the movement of the electronic device in accordance with the third user input, such as dragging a position of the visual indication 822a if a third user input was received in FIG. 8B. In some embodiments, dragging the visual indication along the map causes a change in position of the visual indication. In some embodiments, a position of the visual indication of the respective location of the electronic device that does not update in accordance with the movement of the electronic device is not changed on the map unless and until the third user input is received. In some embodiments, the electronic device receives an input corresponding to a request share an updated location of the electronic device, and in response to the input, the electronic device adds a message including the updated location of the electronic device that does not update in accordance with movement of the electronic device to the messaging conversation. Updating a position of a visual indication on a map in accordance with user input allows further precision when displaying the visual indication of the respective location of the electronic device on the map, thereby improving user-device interactions.

In some embodiments, displaying, via the display generation component, the one or more selectable options included in the first user interface element in the input field includes displaying, via the first user interface element, a first selectable option, such as selectable option 812a in FIG. 8D, (e.g., button, icon, widget, or affordance) that, when selected, causes the electronic device to initiate a process to request a current location of a second electronic device different from the electronic device (910). In some embodiments, the first user interface element displayed in the input field of the electronic device includes a map with a visual indication of a current location of the electronic device that updates in accordance with the movement of the electronic device (as described with reference to step 904) or a visual indication of a respective location of the electronic device that does not update in accordance with the movement of the electronic device (as described with respect to step(s) 906). In some embodiments, the first user interface element also includes the first selectable option (e.g., request option) for requesting a current location of the second electronic device and/or a second selectable option (e.g., a share or a send option) different from the first selectable option as described with reference to step(s) 914, 918, and 920. Displaying a selectable option in the input field for requesting location of a second electronic device provides visual feedback and reduces the number of inputs needed for initiating a process to request location of the second electronic device, thereby improving user-device interactions.

In some embodiments, the electronic device receives (912a), via the one or more input devices, a second user input, such as user input 816c in FIG. 8D, (e.g., different from the first user input and/or includes one or more characteristics of the first user input) directed to the first selectable option (to initiate a process to request a current location of a second electronic device different from the electronic device).

In some embodiments, in response to receiving the second user input, the electronic device transmits (912b), to a second user account associated with the second electronic device (e.g., second user account associated with a second user different from account associated with user of the electronic device), a request, such as message 852b in FIG. 8E, for the current location of the second electronic device, wherein receiving the request causes the second electronic device to display, in the messaging application user interface, a selectable option, such as selectable option 854b in FIG. 8E, that, when selected, causes the second electronic device to share the current location of the second electronic device with the electronic device. For example, receiving the request causes the second electronic device to optionally display text such as “User X is requesting your location,” the first selectable option (e.g., a share option) for sharing the current location of the second electronic device with the electronic device, and/or a second selectable option (e.g., a cancel option) for not sharing the current location of the second electronic device with the electronic device outside of the input field in the messaging application user interface. In some embodiments, transmitting the request for the current location of the second electronic device causes the electronic device to display text such as “You have requested location of User Y” outside the input field in the messaging application user interface. Requesting a current location of a second electronic device causes the second electronic device to display a selectable option for sharing current location of the second electronic device with the electronic, thereby reducing the number of inputs needed for initiating a process to share current location of the second electronic device with the electronic device and improving user-device interactions.

In some embodiments, displaying, via the display generation component, the one or more selectable options included in the first user interface element in the input field includes displaying, via the first user interface element, a location sharing selectable option, such as selectable option 814a in FIG. 8B (914a).

In some embodiments, while displaying the first user interface element in the input field of the messaging application user interface, the electronic device receives (914b), via the one or more input devices, an input (e.g., different from the first user input and/or includes one or more characteristics of the first user input), such as input 816b in FIG. 8B, directed to the location sharing selectable option. In some embodiments, the first user interface element includes a map including a visual indication of a current location of the electronic device and the location sharing selectable option (e.g., a share option for sharing the current location of the electronic device). In some embodiments, “long pressing” the location sharing selectable option includes displaying respective options for sharing the current location of the electronic device with a second electronic device for an hour, till end of day, or indefinitely. In some embodiments, detecting a “long press” includes detecting a contact at the location of the user interface element to which the “long press” is directed for at least a threshold amount of time (e.g., 0.1, 0.2, 0.3, 0.5, 1, 2, or 3 seconds).

In some embodiments, in response to receiving the input directed to the location sharing selectable option (914c), the electronic device displays (914d), in the messaging application user interface, a representation of a message, such as message 840a in FIG. 8D, that includes a map including a visual indication of a current location of the electronic device. In some embodiments, in response to selecting the location sharing selectable option, the electronic device adds the map including the visual indication of the location of the electronic device (e.g., current location of the electronic device that updates in accordance with movement of the electronic device or respective location of the electronic device that does not update in accordance with movement of the electronic device) as a message to the messaging conversation (e.g., sends the message to a second electronic device). In some embodiments, after displaying the representation of the message via the messaging conversation, the electronic device updates the visual appearance of the input field to a default visual appearance. The default input field no longer includes the first user interface element, but instead includes a text entry field, a dictation button, and/or a selectable option (e.g., send icon) that, when selected, causes the electronic device to display the application selection user interface of method 700. In some embodiments, if display of a soft keyboard was not maintained while displaying the first user interface element, then the soft keyboard is redisplayed once the message is added to the messaging conversation and the input field has been updated to the default input field. Displaying a location sharing selectable option in the input field for sharing location of the electronic device provides visual feedback and reduces the number of inputs needed for initiating a process to share location of the electronic device, thereby improving user-device interactions.

In some embodiments, the electronic device displays (916), via the display generation component, a representation of a message, such as message 860a in FIG. 8G, received from a second electronic device (e.g., different from the electronic device) that includes a map with a visual indication of a current location of the second electronic device and a first selectable option, such as selectable option 862a in FIG. 8G, that, when selected, causes the electronic device to initiate a process to present navigation directions to the current location of the second electronic device. In response to the second electronic device selecting an option to share location of the second electronic device with the electronic device in response to receiving a request from the electronic device as described with respect to claim 6, the electronic device display the respective message from the second electronic device that includes the current location of the second electronic device. In some embodiments, the first selectable option is a representation of a car, a train, a bus, a subway, a bicycle, a plane, a person walking, or any other available mode of transportation and/or corresponding estimated time of travel to the current location of the second electronic device in accordance with the mode of transportation. In some embodiments, the fastest mode of transportation for traveling to the current location of the second electronic device is displayed via the first selectable option as default. “Long pressing” the first selectable option causes the electronic device to display other modes of transportation to navigate to the current location of the second electronic device other than the default mode of transportation. In some embodiments, pressing or tapping (e.g., not “long pressing”) the first selectable option causes the electronic device to display navigation directions to the current location of the second electronic device. Displaying an option to present navigation directions in the messages applications reduces the number of inputs for navigating to the current location of the second electronic device (e.g., without opening a different application for navigation), thereby improving user-device interactions.

In some embodiments, in accordance with a determination that the current location of the electronic device has not been transmitted to a second user account associated with the second electronic device (e.g., second user account associated with a second user different from account associated with user of the electronic device), the electronic device displays (918), via the display generation component, the representation of the message received from the second electronic device that includes the map with the visual indication of the current location of the second electronic device and a second selectable option, such as selectable option 816b in FIG. 8B (e.g., share option), that, when selected, causes the electronic device to share the current location of the electronic device with the second electronic device. In some embodiments, if the current location of the electronic device has not already been shared with the second user account of the second electronic device, the message from the second electronic device (e.g., received by the electronic device via the messaging conversation) includes the share option that, when selected, causes the electronic device to share the current location of the electronic device with the second electronic device for one hour, end of day, and/or indefinitely. Displaying an option in a received message for sharing location of the electronic device if the electronic device has not already shared location provides visual feedback and reduces the number of inputs needed for initiating a process to share location of the electronic device, thereby improving user-device interactions.

In some embodiments, in accordance with a determination that the current location of the electronic device has been transmitted to the second user account associated with the second electronic device (e.g., second user account associated with a second user different from account associated with user of the electronic device), the electronic device displays (920), via the display generation component, the representation of the message received from the second electronic device that includes the map with the visual indication of the current location of the second electronic device and a second selectable option, such a selectable option 815a in FIG. 8D (e.g., send option), that, when selected, causes the electronic device to reshare the current location of the electronic device with the second electronic device. In some embodiments, if the current location of the electronic device has already been shared with the second account of the second electronic device, the message from the second electronic device (e.g., received by the electronic device via the messaging conversation) includes the send option that, when selected, causes the electronic device to reshare the current location of the electronic device with the second electronic device. In some embodiments, the electronic device reshare the current location of the electronic device with the second electronic device by adding a new message that includes the current location of the electronic device in the messaging conversation. In some embodiments, the send option replaces the share option of claim 9 once the electronic device has shared location with the second electronic device at least once. Displaying an option in a received message for resharing location of the electronic device if the electronic device has already shared location provides visual feedback and reduces the number of inputs needed for initiating a process to reshare location of the electronic device, thereby improving user-device interactions.

In some embodiments, in accordance with a determination that one or more first criteria are satisfied, the first selectable option, when selected, causes the electronic device to initiate the process to present the navigation directions to the current location of the second electronic device using a first mode of transportation, such as the first mode of transportation corresponding to driving in FIG. 8G (922a) (e.g., a car, a train, a bus, a subway, a bicycle, a plane, a person walking, or any other available mode of transportation). In some embodiments, the first selectable option corresponds to navigation direction using a first mode of transportation because the one or more first criteria are satisfied (e.g., distance and/or estimated time of travel to the current location of the second electronic device corresponds to the most efficient route and/or is the fastest using the first mode of transportation). For example, if the electronic device is relatively close to the second electronic device, then the electronic device optionally selects walking as the first mode of transportation. If the electronic device is relatively far from the second electronic device, then the electronic device optionally selects driving as the first mode of transportation. If the electronic device is not relatively far from and not relatively close to the second electronic device, then the electronic device optionally selects cycling as the first mode of transportation. In some embodiments, the first selectable option includes a visual indication of the first mode transportation and an estimated time of travel to the current location of the second electronic device using the first mode of transportation. In some embodiments, the estimated time of travel to the current location of the second electronic device is updated based on distance and/or movement of the electronic device relative to the second electronic device. For example, the electronic device updates the estimated time of travel to a shorter amount of time as the electronic device moves closer to the second electronic device. In some embodiments, the one or more first criteria include a criterion that is satisfied when the first mode of transportation is an available mode of transportation to the current location of the second electronic device. A user input does not define the mode of transportation, but rather the electronic device automatically determines the first mode of transportation.

In some embodiments, in accordance with a determination that one or more second criteria different from the one or more first criteria are satisfied, the first selectable option, when selected, causes the electronic device to initiate the process to present the navigation directions to the current location of the second electronic device using a second mode of transportation (e.g., a car, a train, a bus, a subway, a bicycle, a plane, a person walking, or any other available mode of transportation) different from the first mode of transportation, such as the second mode of transportation corresponding to a mode of transportation other than driving in FIG. 8G if the one or more second criteria were satisfied (922b). In some embodiments, the second selectable option corresponds to navigation direction using a second mode of transportation because the one or more second criteria are satisfied (e.g., distance and/or estimated time of travel to the current location of the second electronic device corresponds to the most efficient route and/or is the fastest using the second mode of transportation). For example, if the electronic device is relatively close to the second electronic device, then the electronic device optionally selects walking as the first mode of transportation. If the electronic device is relatively far from the second electronic device, then the electronic device optionally selects driving as the first mode of transportation. If the electronic device is not relatively far from and not relatively close to the second electronic device, then the electronic device optionally selects cycling as the first mode of transportation. In some embodiments, the first selectable option includes a visual indication of the second mode transportation and an estimated time of travel to the current location of the second electronic device using the second mode of transportation. In some embodiments, the estimated time of travel to the current location of the second electronic device is updated based on distance and/or movement of the electronic device relative to the second electronic device. For example, the electronic device updates the estimated time of travel to a shorter amount of time as the electronic device moves closer to the second electronic device. In some embodiments, the one or more second criteria include a criterion that is satisfied when the second mode of transportation is an available mode of transportation to the current location of the second electronic device. A user input does not define the mode of transportation, but rather the electronic device automatically determines the second mode of transportation. Presenting a different mode of transportation based on distance and/or estimates time of travel to the current location of a second electronic device provides the most efficient option for navigating to the current location of the second electronic device, thereby improving user-device interactions.

In some embodiments, displaying, via the display generation component, the representation of the message received from the second electronic device includes displaying a period of time for which the current location of the second electronic device is being shared with the electronic device, such the message 860a in FIG. 8G including a period of time corresponding to one of the plurality of selectable options 862b from FIG. 8F (924). In some embodiments, the electronic device receives a message from the second electronic device including an indication of a time period for how long (e.g., an hour, till end of day, or indefinitely) the current location of the second electronic device is being shared with the electronic device. In some embodiments, the sharing of the current location of the second electronic device with the electronic device ends when the time period of sharing the current location of the second electronic device with the electronic device expires. Displaying a period of time for location sharing in a message received by the electronic device provides visual feedback for how long the current location of the second electronic device is being shared with the electronic device, thereby improving user-device interactions.

In some embodiments, displaying, via the display generation component, the one or more selectable options included in the first user interface element in the input field includes displaying, via the first user interface element, a first selectable option, such as selectable option 812a in FIG. 8D (e.g., button, icon, widget, or affordance) that, when selected, causes the electronic device to initiate a process to request a current location of a second electronic device different from the electronic device (926a). In some embodiments, the first user interface element displayed in the input field of the electronic device includes a map with a visual indication of a current location of the electronic device that updates in accordance with the movement of the electronic device (as described with reference to step 904) or a visual indication of a respective location of the electronic device that does not update in accordance with the movement of the electronic device (as described with respect to step(s) 906).

In some embodiments, the electronic device receives (926b), via the one or more input devices, a second user input, such as user input 816c in FIG. 8D (e.g., different from the first user input and/or includes one or more characteristics of the first user input), directed to the first selectable option (to initiate a process to request a current location of a second electronic device different from the electronic device).

In some embodiments, in response to receiving the second user input (926c), the electronic device displays (926d), via the display generation component, an indication, such as message 850a in FIG. 8E, indicating that the current location of the second electronic device has been requested in the messaging conversation. For example, the electronic device displays text such as “You have requested location of User Y” outside the input field in the messaging application user interface.

In some embodiments, in response to receiving the second user input (926c), the electronic device transmits (926c), to the second user account associated with the second electronic device (e.g., second user account associated with a second user different from account associated with user of the electronic device), the request for the current location of the second electronic device, such as message 852b in FIG. 8E, wherein receiving the request causes the second electronic device to display, in the messaging application user interface, a selectable option, such as selectable option 854b in FIG. 8E that, when selected, causes the second electronic device to share the current location of the second electronic device with the electronic device. For example, receiving the request causes the second electronic device to optionally display text such as “User X is requesting your location,” the first selectable option (e.g., a share option) for sharing the current location of the second electronic device with the electronic device, and/or a second selectable option (e.g., a cancel option) for not sharing the current location of the second electronic device with the electronic device outside of the input field in the messaging application user interface.

In some embodiments, the electronic device receives (926f), via the one or more user inputs, a representation of a message received from the second electronic device that includes a map with a visual indication of the current location of the second electronic device, such as the message 860a including a map with a visual indication of the current location of the second electronic device 500b in FIG. 8G (e.g., as described with respect to step 916).

In some embodiments, in response to receiving the representation of the message received from the second electronic device, the electronic device ceases (926g) display of the indication indicating that the current location of the second electronic device has been requested in the messaging conversation, such as ceasing display of the message 850a from FIG. 8E in FIG. 8G. In some embodiments, after the second electronic device has shared location with the electronic device, the electronic device ceases display of the indication indicating that the current location of the second electronic device has been requested in the messaging conversation and instead (e.g., simultaneously) displays the representation of the message received from the second electronic device. Ceasing display of an indication that location of the second electronic device has been requested in the messaging conversation once the second electronic device shares location with the electronic device reduces computing resources (e.g., associated with displaying the indication) when not needed, thereby improving user-device interactions.

In some embodiments, the electronic device displays (928a), in the messaging application user interface, a respective selectable option, such as selectable option 804a in FIG. 8D (e.g., a visual representation (e.g., avatar or image of a second user) of a second user account associated with a second electronic device different from the electronic device).

In some embodiments, while displaying the messaging application user interface including the respective selectable option, the electronic device receives (928b), via the one or more input devices, a second user input, such as user input 816d in FIG. 8D, (e.g., different from the first user input and/or includes one or more characteristics of the first user input) directed to the respective selectable option.

In some embodiments, in response to receiving the second user input, the electronic device displays (928c), via the display generation component, in accordance with a determination that a current location of the second electronic device has been transmitted to the electronic device, a map including an indication of the current location of the second electronic device, such as map 876a in user interface 870a in FIG. 8I (928d). In some embodiments, selecting the visual representation of the second user account causes the electronic device to cease display of the messaging conversation, the input field, and or the soft keyboard described with reference to step(s) 902. Instead, the electronic device optionally displays a user interface (e.g., menu) corresponding to the messaging application user interface but different from the messaging conversation and the input field. In some embodiments, if the current location of the second electronic device has been shared with the user account of the electronic device, then the menu includes a map with a pin or flag of the current location of the second electronic device. In some embodiments, the menu includes an option that, when selected, cause the electronic device to audio call the second electronic device. In some embodiments, the menu includes an option that, when selected, cause the electronic device to video call the second electronic device. In some embodiments, the menu includes an option that, when selected, cause the electronic device to send an email to the second electronic device. In some embodiments, the menu includes an option that, when selected, cause the electronic device to display information, such as contact information, corresponding to the second electronic device. In some embodiments, the menu includes the visual representation of the second electronic device. In some embodiments, the messaging conversation is between the electronic device and at least two other electronic devices. Accordingly, the selectable option optionally includes respective visual representations of the at least two other electronic devices. In some embodiments, if the respective current locations of the at least two other electronic devices have been shared with the user account of the electronic device, then the menu includes a map with respective pins of the respective current locations of the at least two other electronic devices (e.g., a first pin of the current location of the second electronic device and a second pin of the current location of a third electronic device).

In some embodiments, in response to receiving the second user input, the electronic device displays (928c), via the display generation component, in accordance with a determination that the current location of the second electronic device has not been transmitted to the electronic device, a first selectable option, such as selectable option 872a in user interface 870a in FIG. 8H, (e.g., request option, button, widget, icon, or affordance) that, when selected, causes the electronic device to initiate a process to request a current location of a second electronic device different from the electronic device (928c). In some embodiments, if the current location of the second electronic device has not been shared with the user account of the electronic device, then the menu includes a request option for requesting the current location of the second electronic device. In some embodiments, the messaging conversation is between the electronic device and at least two other electronic devices. Accordingly, the selectable option optionally includes respective visual representations of the at least two other electronic devices. In some embodiments, if the respective current locations of the at least two other electronic devices have not been shared with the user account of the electronic device, then the menu includes respective request options for requesting the current locations of the at least two other electronic devices (e.g., a first request option for requesting the current location of the second electronic device and a second request option for requesting the current location of a third electronic device). Displaying a current location of the second electronic device via a menu accessible from a visual representation of a second user account reduces the number of inputs needed to access to the current location of the second electronic device (e.g., without having to scroll through a messaging conversation to find the current location of the second electronic device), thereby improving user-device interactions.

In some embodiments, in response to receiving the second input (930a), the electronic device displays (930b), via the display generation component, a second selectable option (e.g., share or send option, button, widget, icon, or affordance) that, when selected, causes the electronic device to share a current location of the electronic device with the second electronic device, such as a selectable option corresponding to sharing the current location of the electronic device 500a in the user interface 870a in FIG. 8H if the electronic device 500a had not already shared its location with a second user account associated with the second electronic device 500b. In some embodiments, the menu includes a share option for sharing the current location of the second electronic device as described with reference to step 918. In some embodiments, the menu includes a send option for resharing the current location of the second electronic device as described with reference to step 920. In some embodiments, the messaging conversation is between the electronic device and at least two other electronic devices. In some embodiments, the menu includes respective share options for sharing the current location of the electronic device with the at least two other electronic devices (e.g., a first share option for sharing the current location of the electronic device with the second electronic device and a second share option for sharing the current location of the electronic device with a third electronic device). Displaying an option for sharing the current location of the electronic device with the second electronic device via a menu accessible from a visual representation of a second user account provides an alternative way to share the current location of the electronic device with the second electronic device, thereby improving user-device interactions.

In some embodiments, while displaying, via the display generation component, the first selectable option (e.g., request option, button, widget, icon, or affordance) in accordance with the determination that the current location of the second electronic device has been transmitted to the electronic device, the electronic device receives (932a), via the one or more input devices, an input, such as user input 816e in FIG. 8H, selecting the first selectable option.

In some embodiments, in response to receiving the input selecting the first selectable option, the electronic device transmits (932b), to the second user account associated with the second electronic device, a request, such as message 850a in FIG. 8E, for the current location of the second electronic device, wherein receiving the request causes the second electronic device to display, in the messaging application user interface, a selectable option, such as selectable option 845b in FIG. 8E that, when selected, causes the second electronic device to share the current location of the second electronic device with the electronic device (e.g., as described with respect to step(s) 912). In some embodiments, the electronic device receiving selection of the request option from the menu displayed based on input directed to the avatar of the second user account causes the second electronic device to receive a request for the current location of the second electronic device. For example, receiving the request causes the second electronic device to optionally display text such as “User X is requesting your location,” the first selectable option (e.g., a share option) for sharing the current location of the second electronic device with the electronic device, and/or a second selectable option (e.g., a cancel option) for not sharing the current location of the second electronic device with the electronic device in the messaging application user interface. In some embodiments, transmitting the request for the current location of the second electronic device causes the electronic device to display text such as “You have requested location of User Y” in the menu. In some embodiments, the messaging conversation is between the electronic device and at least two other electronic devices (e.g., the second electronic device and a third electronic device). Accordingly, the electronic device also transmits a second request for the current location of the third electronic device. For example, receiving the request causes the third electronic device to optionally display text such as “User X is requesting your location,” the first selectable option (e.g., a share option) for sharing the current location of the third electronic device with the electronic device, and/or a second selectable option (e.g., a cancel option) for not sharing the current location of the third electronic device with the electronic device in the messaging application user interface. In some embodiments, transmitting the request for the current location of the third electronic device causes the electronic device to also display text such as “You have requested location of User Z” in the menu. Displaying an option for requesting the current location of the second electronic device with the electronic device via a menu accessible from a visual representation of a second user account provides an alternative way to share the current location of the second electronic device with the electronic device, thereby improving user-device interactions.

In some embodiments, the electronic device displays (934a), in the messaging application user interface, a visual representation (e.g., an avatar or an image), such as visual representation 804a in FIG. 8G, of a second user account associated with a second electronic device different from the electronic device. In some embodiments, selecting the visual representation causes the electronic device to display a user interface (e.g., menu) as described with respect to step(s) 928.

In some embodiments, while displaying the messaging application user interface including the visual representation of the second user account (934b), in accordance with a determination that a current location of the second electronic device has been transmitted to the electronic device, the electronic device displays (934c), via the display generation component, a representation of the current location of the second electronic device near the visual representation of the second user account, such as optionally displaying a representation of the current location of the second electronic device 500b in FIG. 8G. In some embodiments, if the current location of the second electronic device has been shared with the user account of the electronic device, then the representation of the current location of the second electronic device is displayed at a top portion of the messaging conversation between the electronic device and the second electronic device. For example, the representation of the current location of the second electronic device is optionally displayed under a header or conversation name of the messaging conversation. The representation of the current location of the second electronic device is optionally displayed under the visual representation of the second user account in the messaging conversation. In some embodiments, the representation of the current location of the second electronic device is a text representation. In some embodiments, the messaging conversation is between the electronic device and at least two other electronic devices (e.g., the second electronic device and a third electronic device). Accordingly, the electronic device displays the visual representation of the second user account and another visual representation of a third user account corresponding to the third electronic device. In some embodiments, if the current location of the second electronic device and the current location of the third electronic device have been shared with the user account of the electronic device, then the electronic device displays the representation of the current location of the second electronic device near the visual representation of the second user account and another representation of the current location of the third electronic device near the visual representation of the third user account at the top portion of the messaging conversation.

In some embodiments, while displaying the messaging application user interface including the visual representation of the second user account (934b), in accordance with a determination that the current location of the second electronic device has not been transmitted to the electronic device, the electronic device forgoes (934d) displaying the representation of the current location of the second electronic device near the visual representation of the second user account, such as forgoing displaying a representation of the current location of the second electronic device 500b in FIG. 8G. In some embodiments, if the current location of the second electronic device has not been shared with the user account of the electronic device, then the menu does not include a representation of the current location of the second electronic device. In some embodiments, the messaging conversation is between the electronic device and at least two other electronic devices (e.g., the second electronic device and a third electronic device). Accordingly, the electronic device displays the visual representation of the second user account and another visual representation of a third user account corresponding to the third electronic device. In some embodiments, if the current location of the second electronic device and the current location of the third electronic device have not been shared with the user account of the electronic device, then the electronic device forgoes displaying the representation of the current location of the second electronic device near the visual representation of the second user account and another representation of the current location of the third electronic device near the visual representation of the third user account at the top portion of the messaging conversation. Displaying a text representation of a current location of the second electronic device (e.g., if the current location of the second electronic device has been shared with the electronic device) via a menu accessible from a visual representation of a second user account reduces the number of inputs needed to access to the current location of the second electronic device (e.g., without having to scroll through a messaging conversation to find the current location of the second electronic device), thereby improving user-device interactions.

In some embodiments, the electronic device displays (936), via the display generation component, a representation of a message received from a second electronic device or a third electronic device that includes a map with a (e.g., second) visual indication, such as second visual indication 863a in FIG. 8J, of a current location of the second electronic device and a (e.g., third) visual indication, such as third visual indication 869a in FIG. 8J, of a current location of the third electronic device, wherein the second electronic device and the third electronic device are different from the electronic device. In some embodiments, a single message received by the electronic device includes a map including respective visual indications of respective current location of respective electronic devices (e.g., second and third electronic devise) because each of the respective electronic devices has shared locations with the electronic device. For example, the map optionally includes a second visual indication corresponding to a current location of a second electronic device and a third visual indication corresponding to a current location of a third electronic device. In some embodiments, the visual appearance of the second visual indication is different from the visual appearance of the third visual indication (e.g., to indicate which indication corresponds to which user/device). In some embodiments, the message includes the map with a current location of the electronic device along with the second visual indication and the third electronic device because the electronic device has shared the current location of the electronic device with the second electronic device and the third electronic device. In some embodiments, the message includes the map with the second visual indication corresponding to the current location of the second electronic device because the second electronic device has shared locations with the electronic device. In some embodiments, the electronic device updates the message including the map to also include the third visual indication corresponding to the current location of the third electronic device along with the second visual indication once the third electronic device has shared the current location of the third electronic device with the electronic device. Displaying current locations of various electronic devices in the messaging application user interface allows for simultaneously viewing and comparing the current locations of different electronic devices, thereby improving user-device interactions.

In some embodiments, while displaying the first user interface element associated with the location sharing application in the input field of the messaging application user interface, the electronic device receives (938a), via the one or more input devices, a second user input (e.g., different from the first user input and/or includes one or more characteristics of the first user input) directed to the first user interface element, such as user input 816b directed to first user interface element 810a in FIG. 8B. In some embodiments, the second user input is directed to a share or a request option displayed in the first user interface element.

In some embodiments, in response to receiving the second user input, the electronic device adds (938b) location sharing content associated with the location sharing application to the messaging conversation, such as adding message 840b to the messaging conversation 802a in FIG. 8C. In some embodiments, in response to receiving the second user input directed to a share or a request option displayed in the first user interface element, the electronic device adds a message to the messaging conversation or sends the message including a map with a current location of electronic device and/or text requesting current location of a second electronic device. In some embodiments, in response to receiving the second user input, the electronic device initiates a process to share location of the electronic device with the second electronic device. Directly interacting with the first user interface element reduces the number of inputs needed to initiate a location sharing processing, thereby improving user-device interactions.

It should be understood that the particular order in which the operations in FIGS. 9A-9I have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and 1100) are also applicable in an analogous manner to method 900 described above with respect to FIGS. 9A-9I. For example, the operation of the electronic device to present images in accordance with the pose of the electronic device described above with reference to method 900 optionally has one or more of the characteristics of the presentation of content associated with a map, a summary of captured content, and video while in a communication session described herein with reference to other methods described herein (e.g., methods 700 and 1100). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIGS. 9A-9I are, optionally, implemented by components depicted in FIGS. 1A-1B. For example, displaying operation 902a and/or receiving operation 902b are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Updating an Input Field of a Messaging Application User Interface in Accordance with an Audio Messages Application

Users interact with electronic devices in many different manners, including composing and/or sending messages. In some embodiments, an electronic device displays a messages application user interface including an input field allowing a user to compose and/or send messages. The embodiments described below provide ways in which an electronic device updates an input field of a messages application user interface in accordance with an audio messages application user interface. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

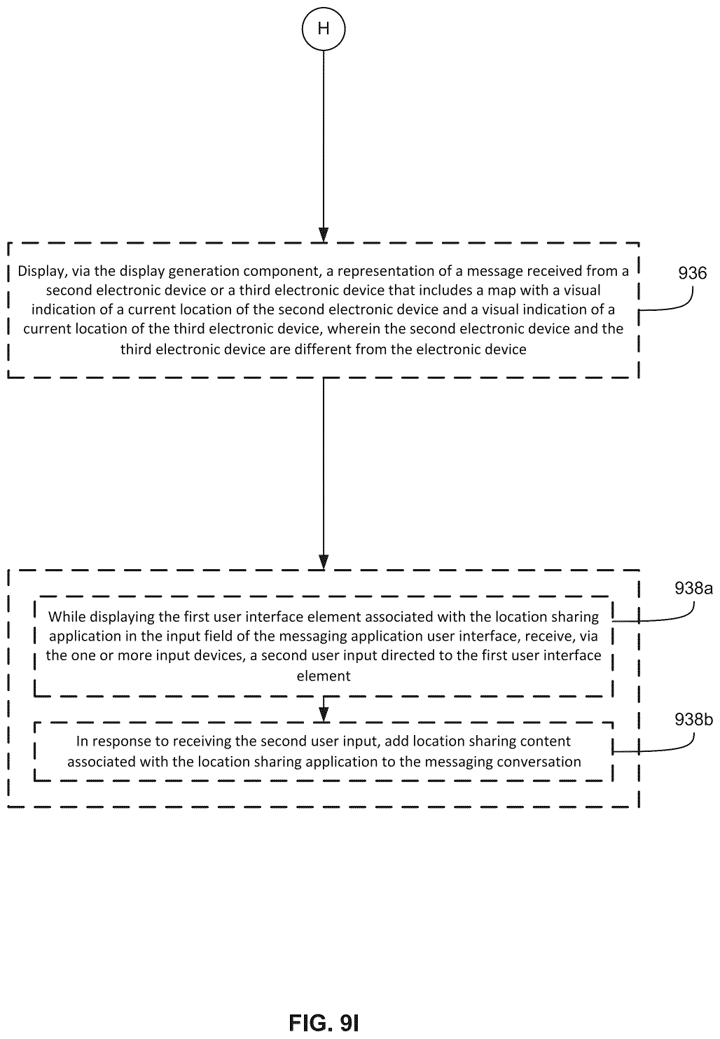

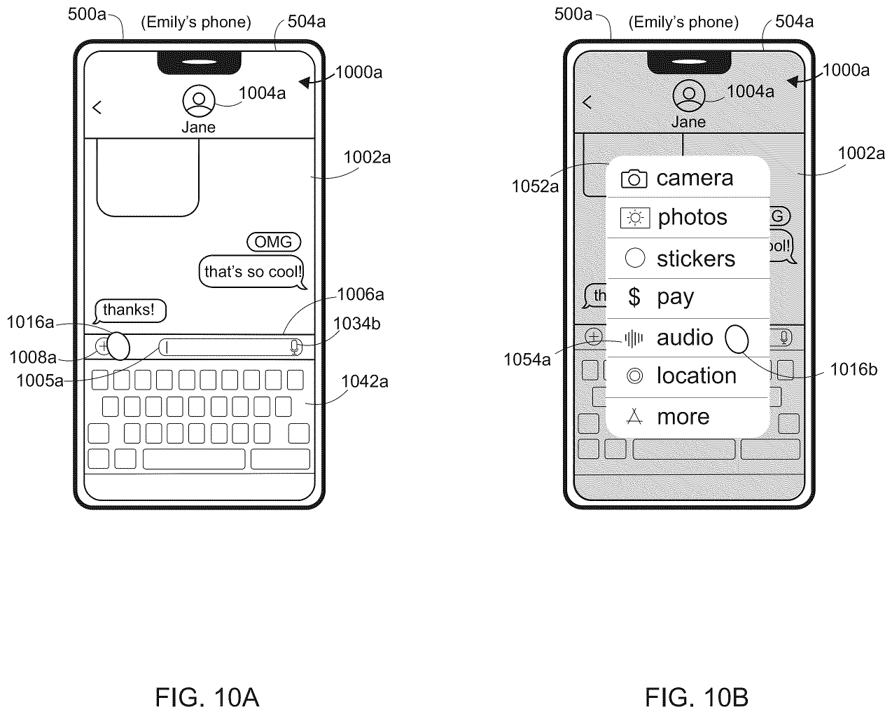

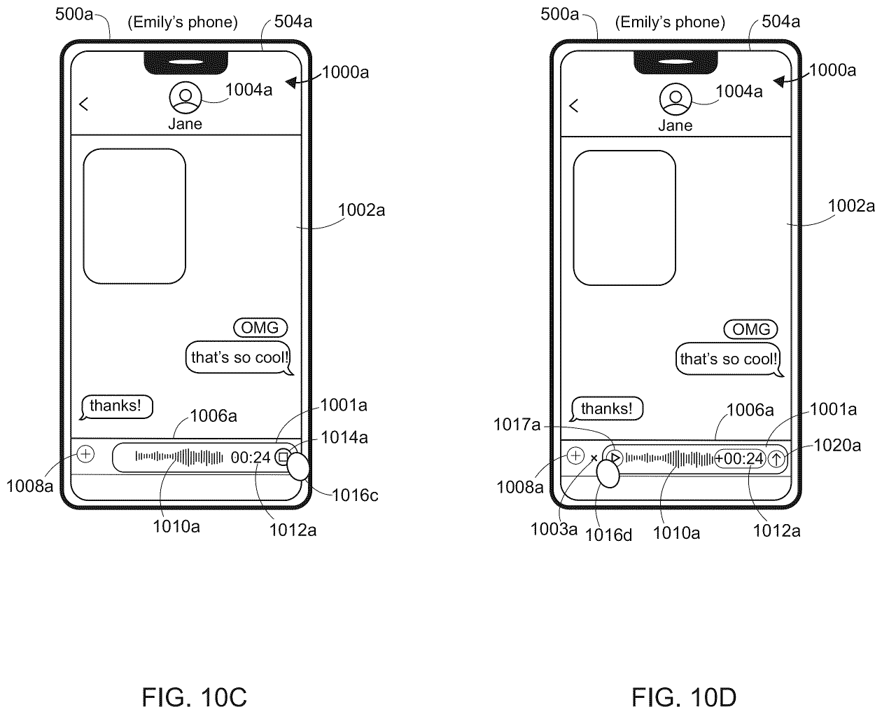

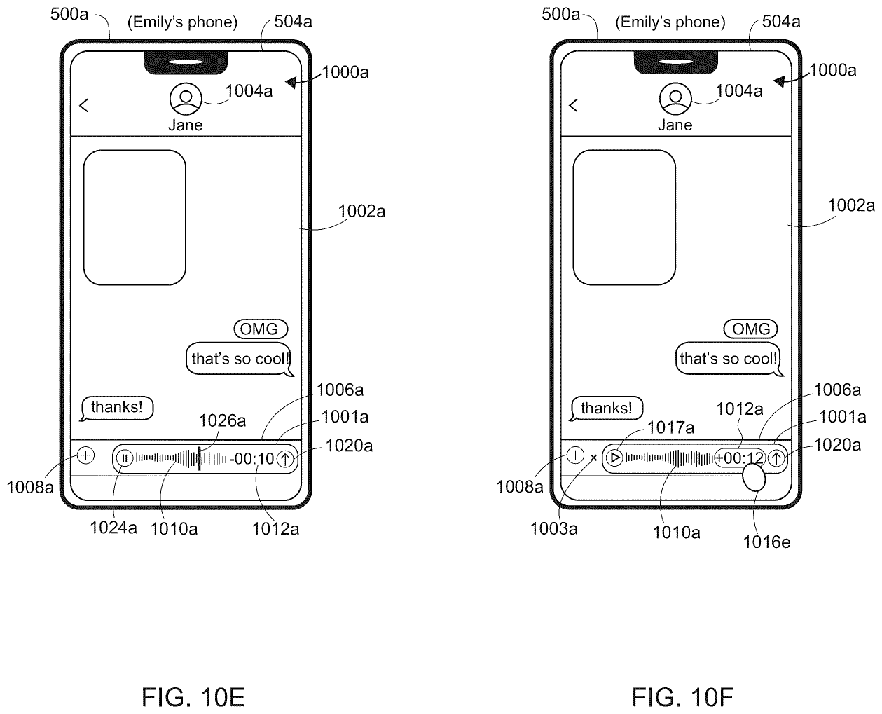

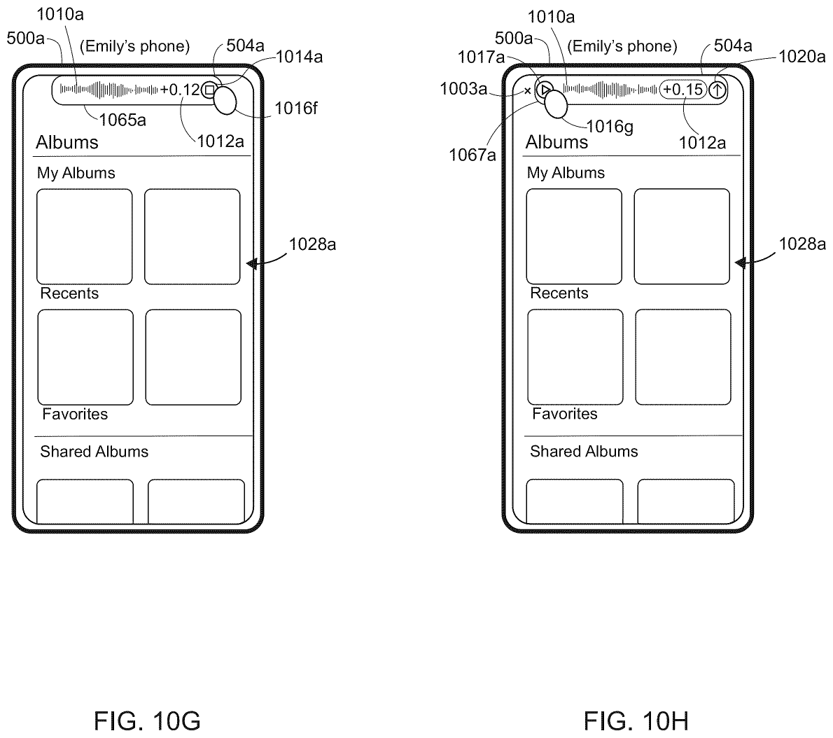

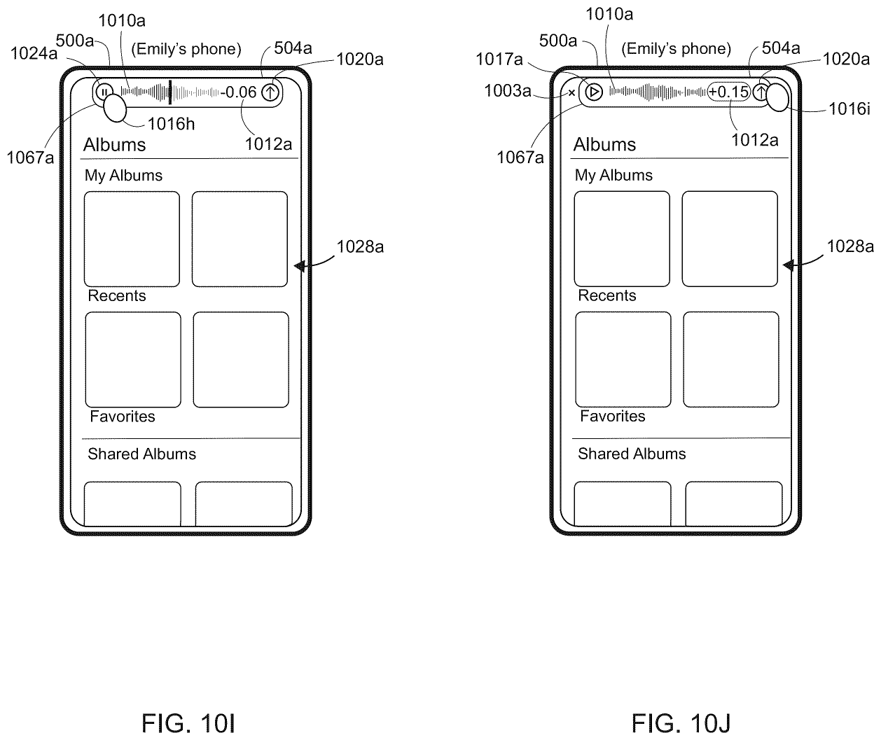

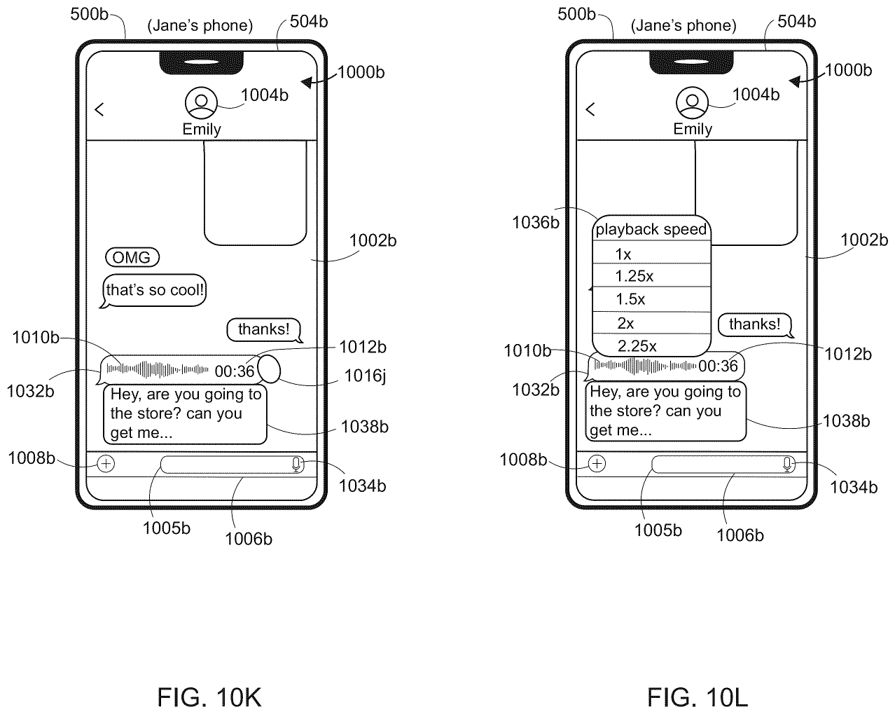

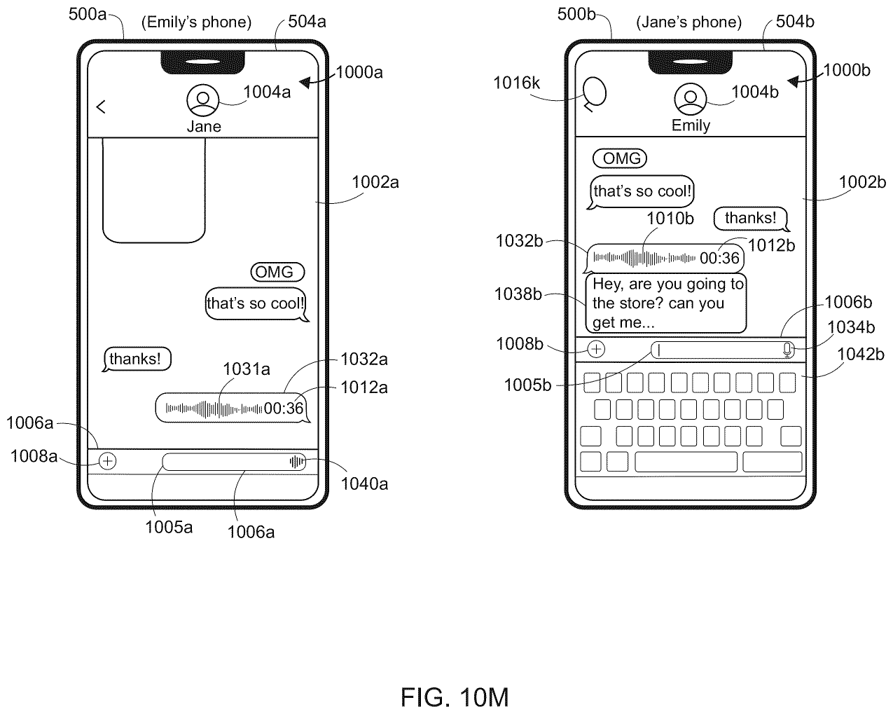

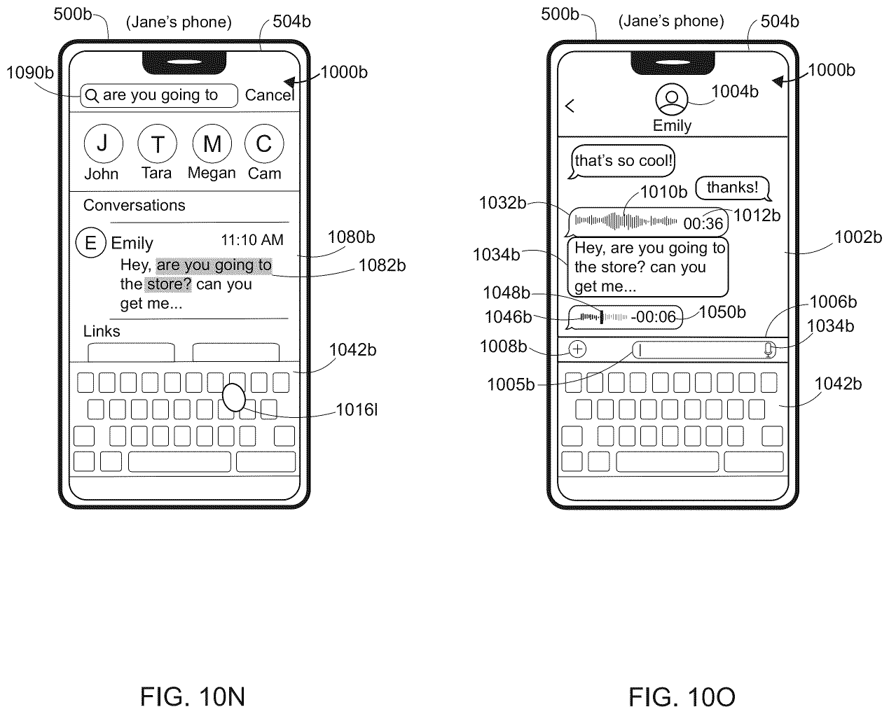

FIGS. 10A-10O illustrate exemplary ways of updating an input field of a messaging application user interface in accordance with an audio messages application user interface in accordance with some embodiments of the disclosure. The embodiments in these figures are used to illustrate the processes described below, including the processes described with reference to FIGS. 11A-11I. These figures are not meant to be limiting; other user interfaces are possible in accordance with method 1100 without departing from the scope of the disclosure.

FIGS. 10A-10O illustrate an example electronic device 500a and/or second electronic device 500b displaying user interfaces for composing and/or sending messages that include content from a respective application user interface. As shown at least in FIG. 10A, the electronic device 500a includes a touch screen 504a. In FIG. 10A, the electronic device 500a displays a messages application user interface 1000a including a messaging conversation 1002a, a visual representation 1004a of a second user account (e.g., avatar of Jane) associated with a second electronic device different from the electronic device 500a, an input field 1006a, and soft keyboard 1042a. As shown in FIG. 10A, the messaging conversation is between a user account of the electronic device 500a and the second user account of the second electronic device. Messages sent from the user account associated with the electronic device 500a are optionally displayed on a right side of the messaging conversation 1002a, and messages received from the second user account associated with the second electronic device are optionally displayed on the left side of the messaging conversation 1002a. The input field 1006a is optionally a visual demarcation that includes an entry field 1005a (e.g., text entry field) configured to accept text and/or content (e.g., images, videos, and/or audio messages) and/or one or more selectable options. The visual appearance of the input field 1006a in FIG. 10A is controlled by an operating system of the electronic device 500a. In some embodiments, and as shown in FIG. 10A, the input field 1006a includes selectable option 1008a (e.g., plus sign icon) that, when selected, causes the electronic device 500a to display an application selection user interface as described with reference to method 700. As shown in FIG. 10A, the input field 1006a also includes selectable option 1034a (e.g., microphone icon) that, when selected, causes the electronic device 500a to enter text into the input field in response to receiving a dictation input including spoken words, the text corresponding to the spoken words, as described with reference to method 1100. As illustrated in FIG. 10A, the electronic device 500a receives a user input 1016a directed to the selectable option 1008a (e.g., plus sign icon). In some embodiments, user inputs illustrated in FIGS. 10A-10P (such as user input 1016a a in FIG. 6A) include one or more characteristics of the first user input described with reference to methods 700, 900, and/or 1100.

In response to receiving the user input 1016a directed to selectable option 1008a (e.g., plus sign icon) in FIG. 10A, the electronic device 500a displays an application selection user interface 1052a in the messaging application user interface 100a, as shown in FIG. 10B. In some embodiments, while displaying the application selection user interface, the electronic device 500a modifies the appearance of the messaging application user interface 600a to be dimmer (e.g., as in FIG. 10B), less bright, more blurry, less saturated in color, and/or with a reduced visual prominence compared to the appearance of the application user interface (e.g., a first portion of the application user interface 1052a as shown in in FIG. 10B), as described above with reference to method 700. As illustrated in FIG. 10B, the first portion of the application selection user interface 622a includes selectable options corresponding to a camera application, a photos application, a stickers application, a payment application, an audio messages application 1054a, and a location sharing application as described with reference to method 700. In FIG. 10B, the electronic device 500a receives user input 1016b directed to a selectable option corresponding to the audio messages application 1054a.

In response to receiving the user input 1016b directed to a selectable option corresponding to audio messages application 1054a in FIG. 10B, the electronic device 500a ceases display of the soft keyboard 1042a from FIG. 10A and automatically (e.g., without other user inputs) begins recording an audio message 1010a in FIG. 10C. Further, as shown in FIG. 10C, the electronic device 500a updates the input field 1006a in accordance with the audio messages application 1054a such that the updated input field 1006a is a visual demarcation including a user interface element 1001a and one or more selectable options corresponding to the audio messages application 1054a. In some embodiments, the updated input field 606a includes selectable option 1008a. The updated input field 606a no longer includes the entry field 1005b of FIG. 10A into which text and/or content can be entered using the soft keyboard 1042a of FIG. 10A. Instead, the electronic device 500a displays user interface element 1001a corresponding to the audio messages application 1054a (e.g., illustrated as an entry field in FIG. 10C but is different from the entry field 1005b) into which the electronic device 500a can enter an audio message and/or text corresponding to a dictation input. Unlike the input field 1006a of the FIG. 10A, the updated input field of FIGS. 10C-10F is controlled by the audio messages application 1054a rather than the operating system of the electronic device 500a. As shown in FIG. 10C, the user interface element 1001a includes the audio message 1010a (e.g., represented by a sound waveform), a time indication 1012a, and selectable option 1014a (e.g., stop recording option) that, when selected, causes the electronic device to stop recording the audio message 1010a. In some embodiments, the time indication 1012a indicates the amount of time elapsed since starting the recording of the audio message 1010a. In FIG. 10C, the electronic device 500a receives user input 1016c directed to the selectable option 1014a (e.g., stop recording option).

In response to receiving the input 1016c selecting the selectable option 1014a (e.g., stop recording option) in FIG. 10C, the electronic device 500a stops recording of the audio message 1010a in FIG. 10D. Further, in response to receiving the input 1016c selecting the selectable option 1014a in FIG. 10C, the electronic device 500a replaces the selectable options 1014a (e.g., stop recording option) with selectable option 1020a (e.g., send option) that, when selected, causes the electronic device 500a add a message including the audio message 1010a into the messaging conversation 1002a, as shown in FIG. 10D. Additionally, in FIG. 10D, while the electronic device 500a has stopped recording of the audio message 1010a, the electronic device 500a display selectable option 1017a (e.g., play option) in the user interface element 1001a. When selected, the selectable option 1017a (e.g., play option) causes playback of the audio message 1010a. In some embodiments, the electronic device 500a displays, in the updated input field 1006a, selectable option 1003a (e.g., cancel option) that, when selected, causes the electronic device 500a to delete the audio message 1010a and/or cease display of the audio message 1010a. In FIG. 10D, the electronic device 500a receives user input 1016d directed to the selectable option 1017a (e.g., play option). Further, in FIG. 10D, after the audio message 1010a has been recorded, a visual appearance of the time indication 1012a is updated compared to the visual appearance of the time indication 1012a in FIG. 10C as described in detail below.

In response to receiving input 1016d selecting the selectable 1017a (e.g., play option) in FIG. 10D, the electronic device 500a initiates playback of the audio message 1010a, as shown in FIG. 10E. In response to playback of the audio message 1010a, the electronic device 500a replaces the selectable option 1017a (e.g., play option) with selectable option 1024a (e.g., pause option) that, when selected, causes the electronic device to pause playback of the audio message 1010a. In FIG. 10E, the time indication 1012a indicates the amount of time remaining in the playback of the audio message 1010a. In some embodiments, the electronic device 500a displays a current playback indicator 1026a indicating a current playback position relative to the playback length of the audio message 1010. In some embodiments, the portion of the audio message 1010a that has already been played (e.g., portion of the audio message 1010a before the current playback indicator 1026a) is darkened and/or has a different visual prominence compared to the portion of the audio message 1010a that has not been played yet (e.g., portion of the audio message 1010a after the current playback indicator 1026a).

From FIG. 10E to 10F, the electronic device 500a has completed playback of the audio message 1010a. Therefore, in FIG. 10F, the electronic device 500a replaces the selectable option 1024a (e.g., pause option) with the selectable option 1017a (e.g., play option) that, when selected again, cause the electronic device 500a to replay the audio message 1010a. As shown in FIG. 10F, after the audio message 1010a has been recorded and/or after playback of the audio message 1010a has been completed, a visual appearance of the time indication 1012a is updated compared to the visual appearance of the time indication 1012a in FIGS. 10C and 10E. In some embodiments and as illustrated in FIG. 10F, the updated visual appearance of the time indication 1012a includes an outline around the value of time. In FIG. 10F, the electronic device 500a receives user input 1016e directed to the updated time indication 1012a that, when selected, causes the electronic device 500a to append an additional audio recording to the audio message 1010a.

In response to receiving the input 1016e selecting updated time indication 1012a in FIG. 10F, the electronic device 500a continues recording of an audio message in FIG. 10G. From FIG. 10F to 10G, the electronic device is displaying a different application user interface, such as a photos application user interface 1028a, compared to the messaging application user interface 1000a. In some embodiments, the electronic device 500 displays the other application user interface in response to a sequence of one or more inputs navigating away from (e.g., ceasing display of) the messaging application user interface to the user interface of the other application. In some embodiments, even though the electronic device 500a switches from displaying the messaging application user interface 1000a to the photos application user interface 1028a while recording an audio message, the electronic device 500a maintains recording of the audio message in FIG. 10G. As illustrated in FIG. 10G, the electronic device 500a displays audio recording user interface 1065a in the photos application user interface 1028a. As described with reference to method 1100, the audio recording user interface element 1065a includes the audio message 1010a (e.g., represented by a sound waveform), time indication 1012a, and selectable option 1014a (e.g., stop recording of the audio message). In FIG. 10G, the electronic device 500a receives user input 1016f directed to the selectable option 1014a (e.g., stop recording of the audio message) in the audio recording user interface element 1065a.

In response to receiving the input 1016f selecting the selectable option 1014a (e.g., stop recording of the audio message) in FIG. 10G and while displaying the photos application user interface 1028a, the electronic device 500a displays an audio playback user interface element 1067a overlaid on the photos application user interface 1028a in FIG. 10H. In FIG. 10H, the audio playback user interface element 1067a includes the audio message 1010a with added audio recording (e.g., indicated by the longer time indication 1012a in FIG. 10H compared to FIG. 10G. As described with reference to method 1100, the audio playback user interface element 1067a includes the audio message 1010a (e.g., represented by a sound waveform), time indication 1012a, and selectable option 1017a (e.g., play option), and selectable option 1020a (e.g., send option). In some embodiments, the electronic device 500a displays, in the audio playback user interface element 1067a, selectable option 1003a (e.g., cancel option) that, when selected, causes the electronic device 500a to delete the audio message 1010a and/or cease display of the audio message 1010a. In some embodiments, the 500a displays the selectable option 1003a (e.g., cancel option) outside the audio playback user interface element 1067a in the photos application user interface 1028a. In FIG. 10H, the electronic device 500a receives user input 1016g directed to the selectable option 1017a (e.g., play option) in the audio playback user interface element 1067a.

In response to receiving input 1016g selecting the selectable option 1017a (e.g., play option) in the audio playback user interface element 1067a in FIG. 10H, the electronic device 500a updates the audio playback user interface element 1067a in FIG. 10I. The updated audio playback user interface element 1067a in FIG. 10I optionally includes one or more characteristics described with respect to the user interface element 1001a in FIG. 10E. In FIG. 10I, the electronic device 500a receives user input directed to the selectable option 1024a (e.g., pause option) in the audio playback user interface element 1067a.

In response to selecting the selectable option 1024a (e.g., pause option) in the audio playback user interface element 1067a in FIG. 10H, the electronic device 500a updates the audio playback user interface element 1067a in FIG. 10J. The updated audio playback user interface element 1067a in FIG. 10J optionally includes one or more characteristics described with respect to the user interface element 1001a in FIG. 10F. In FIG. 10J, the electronic device 500a receives user input directed to the selectable option 1020a (e.g., send option) in the audio playback user interface element 1067a.

In response to receiving the input 1016i selecting the selectable option 1020a (e.g., send option) in the audio playback user interface element 1067a in FIG. 10J, the electronic device 500a adds a message including the audio message to the messaging conversation 1002a in FIG. 10K. In some embodiments, additionally or alternatively, in response to receiving the input 1016i selecting the selectable option 1020a (send option) in FIG. 10J, the electronic device 500a ceases display of audio recording user interface 1065a. In some embodiments, additionally or alternatively, in response to receiving the input 1016i selecting the selectable option 1020a (send option) in FIG. 10J, the electronic device 500a maintains display of audio recording user interface 1065a. For example, maintaining display of the audio recording user interface 1065a enables the user to record another audio message without navigating back to the messaging user interface shown in FIGS. 10A-10F.

FIG. 10K illustrates a second electronic device 500b including a touch screen 504b. In FIG. 10K, the second electronic device 500b displays a message 1032b including the audio message 1010a and the time indication 1012a in the messaging conversation 1002a as well as a text transcription 1038b corresponding to the audio message 1010a. In some embodiments, longer text transcriptions are capped to a threshold number of lines of text as described with reference to method 1100. The second electronic device 500b displays the input field 1006b, a visual demarcation that includes an entry field 1005b (e.g., text entry field) configured to accept text and/or content (e.g., images, videos, and/or audio messages) and/or one or more selectable options. The visual appearance of the input field 1006b in FIG. 10K is controlled by an operating system of the second electronic device 500b. As shown in FIG. 10K, the input field 1006b includes selectable option 1034b (e.g., microphone icon) that, when selected, causes the second electronic device 500b to enter text into the input field in response to receiving a dictation input including spoken words, the text corresponding to the spoken words, as described with reference to method 1100. In FIG. 10K, the second electronic device 500b receives user input 1016j directed to the message 1032b. For example, receiving user input 1016j includes detecting a “long press” input in which the second electronic device 500b detects contact 1016j at the location at which the message 1032b is displayed using touch screen 504b for more than a threshold time (e.g., 0.1, 0.2, 0.3, 0.5, 1, 2, or 3 seconds).

In response to receiving the user input 1016j in FIG. 10K, the second electronic device 500b displays a plurality of selectable options 1036b corresponding to respective playback speeds of the respective audio message as described with reference to method 1100 in FIG. 10L. In some embodiments, the plurality of options includes one or more of the following playback speed options: 0.1, 0.5, 0.75, 1, 1.5, 2, 5, or 10×. As shown in FIG. 10L, the plurality of options 1036b include 1, 1.25, 1.5, 2, and 3× playback speed options. For example, if the second electronic device 500b receives user input directed to 2× playback speed, then the second electronic device 500b plays the audio message 1010b twice as fast as the default playback speed.

In some embodiments, if the input field was more recently populated with an audio message rather than text in response to a dictation input, then the electronic device displays an audio recording option in the input field. Accordingly, in FIG. 10M, the electronic device 500a displays, in the input field 1006a, selectable option 1040a that, when selected, causes the electronic device to record a new and/or an additional audio message. The electronic device 500a optionally replaces selectable option 1034a (e.g., dictation option), which was displayed in the input field 1006a in FIG. 10A prior to recording an audio message, with the selectable option 1040a in the input field 1006a in FIG. 10M. That is, the electronic device 500a displays the selectable option 1040a in the input field in FIG. 10M at the same location at which the electronic device 500a had displayed the selectable option 1034a (e.g., dictation option) in FIG. 10A. Meanwhile, in some embodiments, if text was entered into the input field in response to a dictation input more recently than an audio message was recorded, then the electronic device displays a dictation option for entering new and/or additional text in the input field in response to a second dictation input. Accordingly, in FIG. 10M, the second electronic device 500b displays selectable option 1034b (e.g., dictation option) in the input field 1006b. In FIG. 10M, the second electronic device receives user input 1016k directed to a selectable option (e.g., leftward pointing caret as shown in FIG. 10M) in the messaging application user interface 1000b.

In response to receiving a sequence of inputs including the input 1016k selecting the selectable option (e.g., leftward pointing caret as shown in FIG. 10M) in the messaging application user interface 1000b in FIG. 10M, the second electronic device 500b displays a search user interface 1080b corresponding to the messaging application user interface 1000b (e.g., different from the messaging conversation 1002b) in FIG. 10N. As shown in FIG. 10N, the search user interface 1080b includes a list of representations of different messaging conversations between the user account associated with the electronic device 500a and other user accounts. The search user interface 1080b optionally also includes as a search entry field 1090b. In FIG. 10N, the second electronic device 500b receives user input 10161 directed to one or more keys of the soft keyboard 1042b. Based on the user input 10161, the search entry field 1090b is populated with text, “are you going to” in FIG. 10N. In response to receiving a search input corresponding to the text entered into the search entry field 1090b, the second electronic device 500 displays search results in the search user interface 1080b, where the search results optionally include one or more messaging conversations that include an audio message and/or respective text transcription corresponding to the text entered into the search entry field 1090b. In some embodiments, the respective text transcription (e.g., such as text transcription 1082b in FIG. 10N) corresponding to the text entered into the search entry field 1090b is highlighted, bolded, or increased in visual prominence. In some embodiments, selecting a messaging conversation including the audio message and/or respective text transcription corresponding to the text entered into the search entry field 1090b causes the electronic device to display the messaging conversation 1002b instead of the search user interface 1080b, where the respective text transcription corresponding to the text entered into the search entry field 1090b is highlighted, bolded, or increased in visual prominence in the messaging conversation 1002b.

In some embodiments, after playing a first audio message, an electronic device automatically (e.g., without input directed to a play button corresponding to a second audio message) plays a second audio message because the second audio message is immediately after the first audio message (e.g., without any intermediate content between the first audio message and the second audio message aside from the text transcription 1034b related to the first audio message) as described with reference to method 1100. Because no other non-audio messages are intervening between the first audio message and the second audio message, the electronic device automatically plays the second audio message after playing the first audio message. Accordingly, in FIG. 10O, the second electronic device 500b is playing second audio message 1046b (as indicted by the current playback indicator 1048b) after having played the first audio message 1010b. In some embodiments, the second electronic device 500b plays the second audio message 1046b without receiving additional user input (e.g., during or after playing audio message 1032b) since the second audio message 1046b is immediately after the first audio message 1010b. Playback of the second audio message 1046b optionally includes one or more characteristics of playback of the audio message 1010a in FIG. 10E.

FIGS. 11A-11I are flow diagrams illustrating a method of updating an input field of a messaging application user interface in accordance with an audio messages application user interface in accordance with some embodiments of the disclosure. The method 1100 is optionally performed at an electronic device such as device 100, device 300, device 500a, 500b, and/or 500c as described above with reference to FIGS. 1A-1B, 2-3, 4A-4B and 5A-5H. Some operations in method 900 are, optionally combined and/or order of some operations is, optionally, changed.

As described below, the method 1100 provides ways in which an electronic device updates an input field of a messaging application user interface in accordance with an audio messages application user interface. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, the method 1100 is performed at an electronic device, such as electronic device 500a in FIG. 5, in communication with a display generation component and one or more input devices. In some embodiments, the electronic device has one or more of the characteristics of the electronic device of methods 700 and/or 900. In some embodiments, the display generation component has one or more of the characteristics of the display generation component of methods 700 and/or 900. In some embodiments, the one or more input devices have one or more of the characteristics of the one or more input devices of methods 700 and/or 900.

In some embodiments, the electronic device displays (1102a), via the display generation component, a messaging application user interface, such as messaging application user interface 1000a in FIG. 10A, that includes an input field, such as input field 1006a in FIG. 10A. In some embodiments, the messaging application user interface has one or more characteristics of the messaging application user interface of methods 700 and/or 900. In some embodiments, the input field has one or more characteristics of the input field of methods 700 and/or 900. In some embodiments, the input field is a visual demarcation including an entry field (e.g., text entry field), editable content, and one or more selectable options (e.g., send option or dictation option).

In some embodiments, while displaying the messaging application user interface, the electronic device receives (1102b), via the one or more inputs devices, a first user input, such as user input 1016b in FIG. 10B, corresponding to a request associated with recording an audio message. In some embodiments, the first user input has one or more characteristics of the first user input of methods 700 and/or 900. In some embodiments, the first user input is directed to a selectable option corresponding to an audio messages application in the messaging application user interface, such as selection from a menu of available applications as described with reference to method 700.

In some embodiments, in response to receiving the first user input (1102c), the electronic device records (1102d) (e.g., automatically or without additional user input), via the one or more input devices, an audio message, such as recording an audio message in FIG. 10C, for transmission to a messaging conversation corresponding to the messaging application user interface; and In some embodiments, the messaging conversation corresponding includes one or more characteristics of the messaging conversation of methods 700 and/or 900.

In some embodiments, in response to receiving the first user input (1102c), the electronic device displays (1102e), via the display generation component, a first user interface element, such as user interface element 1001a in FIG. 10C, associated with an audio messages application, including a visual indication (e.g., a sound waveform) of one or more characteristics (e.g., wavelength, amplitude, frequency, time period and/or velocity) of the audio message while recording the audio message and one or more selectable options to stop the recording of the audio message, send the audio message, and/or record another audio message in the input field of the messaging application user interface, such as selectable option 1014a (e.g., stop audio recording option) in FIG. 10C, selectable option 1020a (e.g., send option) in FIG. 10D, and selectable option 1040a (e.g., audio recording option) in FIG. 10M. In some embodiments, in response to receiving the first user input, the electronic device updates the input field in accordance with the audio messages application such that the updated input field is a visual demarcation including the first user interface element including one or more selectable options corresponding to the audio messages application. In some embodiments, the entry field, such as the text entry field, (e.g., displayed in the input field prior to receiving the first user input) is replaced with the first user interface element corresponding to the audio messages application in the input field. In some embodiments, no entry field exists outside the first user interface element corresponding to the audio messages application, into which text and/or content can be entered (e.g., using a soft keyboard or otherwise). In some embodiments, in response to receiving the first user input, the only location into which text and/or content can be entered into is the first user interface element in the input field. In some embodiments, the first user interface element is an interactable visual representation corresponding to the audio messages application. In some embodiments, the visual indication (e.g., sound waveform) is no longer displayed in the input field after sending the audio message to another user account via the messaging conversation. In some embodiments, the first user interface element includes a single selectable option configured to stop recording the audio message, send the recorded audio message, play the recorded audio message, and/or continue recording the audio message after pausing the recording of the audio message. In some embodiments, the first user interface element includes a first selectable option configured to stop recording the audio message and send the recorded audio message, a second selectable option configured to play the recorded audio message, and a third selectable option configured to continue recording the audio message after pausing the recording of the audio message. In some embodiments, when the audio message is being recorded, the first user interface element includes a first selectable option displayed right of the sound waveform corresponding to the recording. For example, the first selectable option is optionally a pause icon. In some embodiments, when the stop recording icon is selected (e.g., tapped), the electronic device stops recording the audio message, and the first selectable option changes from the stop recording icon to a send icon. In some embodiments, the send icon corresponding to the first selectable option is different from the send option in the messaging application user interface of method 700. In some embodiments, when the electronic device stops recording the audio message, the first user interface element includes the first selectable option displayed right of the sound waveform and a second selectable option displayed left of the sound waveform. In some embodiments, the second selectable option is a play icon, and when selected, the play icon causes playback of the recorded audio message. In some embodiments, when the send icon is selected (e.g., the first selectable option is tapped again), the electronic device sends the audio message to the other user account via the messaging conversation. In some embodiments, after the audio message to the other user account is sent, the first user interface element no longer includes a sound waveform, and the first selectable option changes from the send icon to a soundwave icon configured to record another audio message when selected. In some embodiments, recording an audio message includes pressing the soundwave icon (e.g., “long press”) while recording audio, and once the soundwave icon is released, the audio message is sent to the other user account via the messaging conversation. In some embodiments, prior to receiving the first input, the electronic device displays a soft keyboard for text input in the messaging user interface. In some embodiments, while displaying the first user interface element associated with the audio messages application in the input field, the soft keyboard for text input is not displayed the messaging application user interface. In some embodiments, the first user interface element is partially or fully displayed in the input field. In some embodiments, the electronic device does not record the audio message and/or display the first user interface element before receiving the first user input. In some embodiments, the soft keyboard is displayed concurrently with the first user interface element displayed in the input field. In some embodiments, the display of the soft keyboard was maintained before receiving the first user input. The display of the soft keyboard is optionally maintained while or in response to receiving the first user input. In some embodiments the soft keyboard displayed concurrently with the first user interface element is the same soft keyboard used to enter text into the first input field prior to the input field being populated with the first user interface element and/or after the first input field is no longer populated with first user interface element. Displaying a user interface element corresponding to an audio messages application in an input field of a messaging application user interface allows for direct interaction with the audio messages application when sending messages, reduces the number of inputs needed to send an audio message via a messaging conversation, and simplifies user interaction with the computer system, thereby improving user-device interactions.

In some embodiments, displaying, via the display generation component, the one or more selectable options included in the first user interface element in the input field includes displaying, via the first user interface element, a first selectable option, such as selectable option 1014a in FIG. 10C (e.g., button, icon, widget, affordance, or any other selectable object) that, when selected, causes the electronic device to stop the recording of the audio message (1104a). In some embodiments, the first selectable option is a stop recording button and has a first visual appearance (e.g., includes a square icon).

In some embodiments, the electronic device receives (1104b), via the one more input devices, a second user input, such as user input 1016c in FIG. 10C, (e.g., different from the first user input and/or includes one or more characteristics of the first user input) directed to the first selectable option displayed at a first location in the first user interface element. In some embodiments, the second user input includes tapping the first selectable option. In some embodiments, the second user input includes an air pinch gesture (e.g., in which an index finger and thumb of a hand of the user come together to make contact) while attention of the user is directed to the first selectable option. In some embodiments, the first selectable option (e.g., stop recording button) is displayed to the right of a sound waveform corresponding to the recoding of the audio message. In some embodiments, while recording the audio message, the representation of the sound waveform is displayed with an animation, including vertical movement, horizontal scrolling, and/or increasing in length. In some embodiments, a time indication is displayed in between the sound waveform and the first selectable option. In some embodiments, the time indication indicates the amount of time elapsed since starting the recording of the audio message.

In some embodiments, in response to receiving the second user input (1104c), the electronic device ceases (1104d) recording of the audio message, such as ceasing recording of audio message 1010a in FIG. 10D. In some embodiments, in response to ceasing recording of the audio message, the electronic device displays the representation of the sound waveform without the animation (e.g., no longer moves, no longer scrolls, and/or no longer increases in length).

In some embodiments, in response to receiving the second user input (1104c), the electronic device ceases (1104e) display of the first selectable option at the first location in the first user interface element, such as ceasing display of the selectable option 1014a in the user interface element 10001a in FIG. 10D.

In some embodiments, in response to receiving the second user input (1104c), the electronic device displays (1104f), via the display generation component, a second selectable option, such as selectable option 1020d in FIG. 10D, (e.g., button, icon, widget, affordance, or any other selectable object different from the first selectable option), that when selected, causes the electronic device to add the audio message to the messaging conversation, wherein the second selectable option is displayed at the first location in the first user interface element. In some embodiments, the second selectable option is a send button and has a second visual appearance (e.g., includes an upward pointing arrow icon) different from the first visual appearance of the first selectable option (e.g., stop recording button). In some embodiments, selecting the send button causes the electronic device to send a message with the recorded audio message to the messaging conversation. In some embodiments, the send icon replaces the stop recording button in response to the electronic device receiving the second user input and ceasing recording of the audio message. In some embodiments, the second selectable option is not displayed unless and until the second user input has been received and recording of the audio message has been received. In some embodiments, while displaying the second selectable option, display of the time indication between the sound waveform and the second selectable option (e.g., send button) is maintained, where the time indication indicates the duration of the recorded audio message. In some embodiments, in response to and/or after receiving the first user input, display of the selectable options (e.g., first and/or second selectable options) in the first user interface element is controlled by the audio messages application installed on the electronic device and not controlled by an operating system of the electronic device. Displaying a second selectable option (e.g., send button) instead of a first selectable option (e.g., stop recording button) in response to input for ceasing recording of the audio message provides a visual indication for sending a message with an audio recording and avoids consuming computing resources (e.g., for displaying the first selectable option) when not needed, thereby improving user-device interaction.

In some embodiments, displaying, via the display generation component, the one or more selectable options included in the first user interface element in the input field includes displaying, via the first user interface element, a first selectable option, such as selectable option 1014a in FIG. 10C (stop recording button described with reference to step(s) 1104) that, when selected, causes the electronic device to stop the recording of the audio message (1106a).

In some embodiments, the electronic device receives (1106b), via the one more input devices, a second user input, such as user input 1016c FIG. 10C, (e.g., different from the first user input and/or includes one or more characteristics of the first user input) directed to the first selectable option (as described with reference to step(s) 1104).

In some embodiments, in response to receiving the second user input (1106c), the electronic device ceases (1106d) recording of the audio message, such as ceasing recording of audio message 1010a in FIG. 10D (as described with reference to step(s) 1104).

In some embodiments, in response to receiving the second user input (1106c), the electronic device displays (1106e), via the display generation component, a second selectable option, such as selectable option 1004a in FIG. 10D, (e.g., button, icon, widget, affordance, or any other selectable object different from the first selectable option), that when selected, causes playback of the audio message. In some embodiments, in response to ceasing recording of the audio message, the second selectable option (e.g., a play button) is displayed adjacent to (e.g., to the left or to the right of) the sound waveform. The play button, when selected, causes playback of the recorded audio message without sending the audio message to the messaging conversation. In some embodiments, after the electronic device has initiated playback of the recorded audio message, the electronic device ceases display of the play button and instead displays a pause button at the same location as the play button. In some embodiments, after the electronic device has initiated playback of the recorded audio message, the electronic device ceases display of the play button and instead displays a pause button at a different location compared to the play button when displayed. The pause button, when selected, causes the electronic device to pause playback of the audio message. In some embodiments, in response to receiving the second user input, the electronic device ceases display of the first selectable option (e.g., stop recording button) and instead displays a respective selectable option for sending the recorded audio message via the messaging conversation as described with reference to claim 2. In some embodiments, in response to and/or after receiving the first user input, display of the selectable options (e.g., first and/or second selectable options) in the first user interface element is controlled by the audio messages application installed on the electronic device and not controlled by an operating system of the electronic device. Displaying a second selectable option (e.g., a play button) in response to input for ceasing recording of the audio message provides a visual indication for playback of the audio message, thereby improving user-device interaction.

In some embodiments, displaying, via the display generation component, the one or more selectable options included in the first user interface element in the input field includes displaying, via the first user interface element, a first selectable option, such as selectable option 1014a in FIG. 10C (stop recording button described with reference to step(s) 1104) that, when selected, causes the electronic device to stop the recording of the audio message (1108a).

In some embodiments, the electronic device receives (1108b), via the one more input devices, a second user input, such as user input 1016c FIG. 10C, (e.g., different from the first user input and/or includes one or more characteristics of the first user input) directed to the first selectable option (as described with reference to step(s) 1104).

In some embodiments, in response to receiving the second user input (1108c), the electronic device ceases (1108d) recording of the audio message, such as ceasing recording of audio message 1010a in FIG. 10D (as described with reference to step(s) 1104).

In some embodiments, in response to receiving the second user input (1108c), the electronic device displays (1108e), via the display generation component, a second selectable option, such as updated time indication 1012a in FIG. 10F, (e.g., button, icon, widget, affordance, or any other selectable object different from the first selectable option), that when selected, causes the electronic device to append an additional audio recording (e.g., same amount of time as the recorded audio message or a different amount of time as the recorded audio message) to the audio message. In some embodiments, the second selectable options is displayed at a different location in the first user interface element compared to the first selectable option. In some embodiments, in response to receiving the second user input, the electronic device ceases display of the first selectable option (e.g., stop recording button) and instead displays a respective selectable option (e.g., send button) for sending the recorded audio message via the messaging conversation as described with reference to step(s) 1104. In some embodiments, in response to ceasing recording of the audio message, the second selectable option includes a plus icon and the time indication described with reference to step(s) 1104. In some embodiments, from left to right, the sound waveform, the plus icon, the time indication, and the send button are displayed. In some embodiments, a different arrangement is possible. Selection of the plus icon and/or the time indication causes the electronic device to optionally continue recording after having ceased recording of the audio message and add new or additional audio to the recorded audio message. In some embodiments, selection of the second selectable option causes the electronic device to record audio unless and until the electronic device receives an input corresponding to a request to stop recording the audio, where the audio is appended to the previously recorded audio message. In some embodiments, in response to and/or after receiving the first user input, display of the selectable options (e.g., first and/or second selectable options) in the first user interface element is controlled by the audio messages application installed on the electronic device and not controlled by an operating system of the electronic device. Displaying a second selectable option (e.g., plus icon and time indication) in response to input for ceasing recording of the audio message provides a visual indication for appending an additional audio recording to the audio message, thereby improving user-device interaction.

In some embodiments, while displaying the messaging application user interface and before receiving the first user input (1110a), in accordance with a determination that a first audio message was recorded while displaying the messaging conversation in the messaging application user interface, such as recoding audio message 1010a in FIG. 10C, the electronic device displays (1110b), via the input field, a first selectable option, such as selectable option 1040a in FIG. 10M, (e.g., button, icon, widget, affordance, or any other selectable object), that when selected, causes the electronic device to record a second audio message. In some embodiments, the first selectable option is a sound waveform icon. In some embodiments, when the first electable option (e.g., sound waveform icon for recording an audio message) is displayed, a second selectable option (e.g., a microphone icon for dictation) is not displayed. In some embodiments, selecting the first selectable option causes the electronic device to display user interface elements corresponding to recording an audio message (e.g., pause option to pause recoding of the audio message, cancel option to delete recording of audio message, an/or a time indication) in the input field.

In some embodiments, while displaying the messaging application user interface and before receiving the first user input (1110a), in accordance with a determination that the first audio message was not recorded, such as not recording an audio message in FIG. 10K, (optionally instead text was displayed in the input field in response to a dictation input) while displaying the messaging conversation in the messaging application user interface, the electronic device displays (1110c), via the input field, a second selectable option, such as selectable option 1034b in FIG. 10M, (e.g., button, icon, widget, affordance, or any other selectable object different from the first selectable option), that when selected, causes the electronic device to display text in the input field in response to receiving a dictation input including spoken words, the text corresponding to the spoken words. In some embodiments, the second selectable option is a dictation icon. In some embodiments, when the second selectable option (e.g., a microphone icon for dictation) is displayed, the first selectable option (e.g., sound waveform icon for recording an audio message) is not displayed. In some embodiments, if an audio message was recorded more recently than dictation was used, then the electronic device displays the first selectable option for recording another audio message as default. In some embodiments, even after the electronic device navigates to a user interface different from the messaging application user interface as described with reference to step(s) 1120 and 1124 after recording an audio message, the first selectable option is still displayed in the input field when redisplaying the messaging application user interface. In some embodiments, if text was entered into the input field in response to a dictation input more recently than an audio message was recorded, then the electronic device displays the second selectable option for entering new and/or additional text in the input field in response to a second dictation input as default. In some embodiments, the display of the first selectable option (e.g., audio message option) or the second selectable option (e.g., dictation option) in the input field is not changed in response to composing a message that includes content other than an audio message or text corresponding to a dictation input. In some embodiments, even after the electronic device navigates to a user interface different from the messaging application user interface as described with reference to step(s) 1120 and 1124 after enter entering text into the input field based on a dictation input, the second selectable option is still displayed in the input field when redisplaying the messaging application user interface. In some embodiments, if the first selectable option (e.g., audio message option) is displayed in the input field, the electronic device switches from displaying the first selectable option to the second selectable option (e.g., dictation option) in response to receiving an input directed to a selectable option associated with dictation in a soft keyboard. In some embodiments, if the input field was most recently populated with an audio message rather than text in response to a dictation input, then the electronic device displays the first selectable option in the input field. Meanwhile, in some embodiments, if the input field was most recently populated with text in response to a dictation input rather than an audio message, then the electronic device displays the second selectable option in the input field. Displaying a first selectable option or a second selectable option based on which option was last selected reduces the number of inputs for efficiently sending a message with an audio recording and text corresponding to a dictation input based on user selection history, thereby improving user-device interactions.

In some embodiments, the electronic device displays (1112), via the display generation component, in the messaging application user interface, a representation of a message that includes a respective audio message and a first selectable option, such as time indication 1012b in FIG. 10K, that, when selected, causes the electronic device to display a plurality of selectable options corresponding to respective playback speeds of the respective audio message, such as a plurality of selectable options 1036b in FIG. 10L. In some embodiments, the message including the respective audio message and the first selectable option is composed by the electronic device (e.g., electronic device having recorded the respective audio message). In some embodiments, the representation of the message is received from a second electronic device (e.g., different from the electronic device) with access to the messaging conversation. In some embodiments, the message is sent from a second user account associated with the second electronic device different from a user account associated with the electronic device. In some embodiments, the plurality of selectable options is displayed in the messaging conversation (e.g., overlaid on the representation of the message received from the second electronic device). In some embodiments, when the plurality of selectable options is displayed, the messaging conversation behind the plurality of selectable options has a reduced visual prominence (e.g., blurred, more transparent, less bright, and/or a different color) compared to the plurality of selectable options. In some embodiments, the plurality of options includes one or more of the following playback speed options: 0.1, 0.5, 0.75, 1, 1.5, 2, 5, or 10×. In some embodiments, the first selectable option is a play button that, when selected, causes the electronic device to initiate playback of the recorded audio message. In some embodiments, the first electable option is a representation of a sound waveform corresponding to the recorded audio message. In some embodiments, the first selectable option is a time indication displayed to the right of the representation of sound waveform, where the time indication indicates the duration of the recorded audio message. In some embodiments, detecting a contact at the location of the first selectable option (e.g., play button) for a threshold amount of time (e.g., 0.1, 0.2, 0.3, 0.5, 1, 2, or 3 seconds) causes the electronic device to display the plurality of selectable options. Displaying a plurality of selectable options in response to selecting a play button corresponding to an audio message provides a visual indication for changing playback speed of the recorded audio message, thereby improving user-device interactions.

In some embodiments, displaying, via the display generation component, the representation of the message received from the second electronic device includes displaying a text transcription, such as text transcription 1038b in FIG. 10K, corresponding to the respective audio message (1114). In some embodiments, the text transcription is displayed below the representation of the sound waveform corresponding to the respective audio message. In some embodiments, a text transcription is not displayed when displaying a message including the respective audio message in a messaging conversation. In some embodiments, a text transcription only displayed in the message including the respective audio message if a setting in the electronic device for displaying text transcription is enabled. Displaying a text transcription provides visual feedback in addition to audio feedback for an audio message, thereby improving user-device interactions.

In some embodiments, the respective the respective audio message corresponds to a first number of lines of text, such as number of lines of text of the text transcription 1038b in FIG. 10K (1116a).

Displaying the text transcription corresponding to the respective audio message includes in accordance with a determination that the first number of lines of text exceeds a threshold number of lines of text (e.g., 4, 5, 6, or 10 lines of text), displaying, via the display generation component, the threshold number of lines of text (e.g., 4, 5, 6, or 10 lines of text), corresponding to the respective audio message (1116b), such as displaying a threshold number of lines of text in FIG. 10K if the number of lines of text of the text transcription 1038b exceeded the threshold number of lines of text. In some embodiments, the electronic device receives an input corresponding to a request to display a text transcription corresponding to a respective audio message. However, in some embodiments, if the first number of lines of text corresponding to the respective audio message exceed the threshold number of lines of text, then the electronic device displays a portion of the first number of lines of text (e.g., up to the threshold number of lines of text). In some embodiments, an input directed to (e.g., tapping) the text transcription, including the first portion of the first number of lines of text, causes the electronic device to display a separate user interface element including the threshold number of lines of text as well as the remaining lines of text of the first number of lines of text in the messaging application user interface

Displaying the text transcription corresponding to the respective audio message includes in accordance with a determination that the first number of lines of text does not exceed the threshold number of lines of text (e.g., 4, 5, 6, or 10 lines of text), displaying, via the display generation component, the first number of lines of text corresponding to the respective audio message, such as displaying the number of lines of text of the text transcription 1038b in FIG. 10K if the number of lines of text of the text transcription 1038b did not exceed the threshold number of lines of text (1116c). In some embodiments, if the first number of lines of text corresponding to the respective audio message does not exceed the threshold number of lines of text, then the electronic device displays all of the first number of lines of text. Capping display of longer text transcriptions prevents a cluttered screen and reduces computing resources (e.g., for displaying each line of text corresponding to an audio message) when not needed, thereby improving user-device interactions.

In some embodiments, the electronic device receives (1118a), via the one or input device, a second user input, such as user input 1090b in FIG. 10N, (e.g., different from the first user input and/or includes one or more characteristics of the first user input) (as described with respect to step(s) 1104) corresponding to a request to initiate a process for searching one or more messaging conversations of the messaging application. In some embodiments, the second user input corresponds to a request to search for text within messaging conversations of the messaging application user interface. In some embodiments, the second user input includes selection of an option in the messaging conversation of the messaging application user interface to display a search user interface corresponding to the messaging application user interface. The search user interface includes a list of representations of different messaging conversation between the user account and other user accounts as well as a search entry field including a text entry field.

In some embodiments, in response to the second user input, the electronic device displays (1118b), via the display generation component, a respective audio message and corresponding text transcription from the messaging conversation, such as text transcription 1082b in search user interface 1080b in FIG. 10N, in accordance with the second user input. In some embodiments, in response to receiving a search input corresponding to entering text into the search field, the electronic device ceases display of the search user interface and displays a search results user interface corresponding to the messaging application user interface. The search results user interface optionally includes one or more messaging conversations that include an audio message and respective text transcription corresponding to the text entered into the search field. In some embodiments, the text corresponding to the search input from the text transcription (e.g., search results) is highlighted, bolded, or increased in visual prominence. Displaying an audio message and corresponding text transcription in response to a process for searching text reduces the number of inputs needed in identifying an appropriate audio message and corresponding text transcription from a messaging conversation, thereby improving user-device interactions.

In some embodiments, while recording, via the one or more input devices, the audio message, the electronic device receives (1120a), via the one or more input devices, a second user input (e.g., different from the first user input and/or includes one or more characteristics of the first user input) (as described with respect to step(s) 1104) corresponding to a request to initiate display of a user interface (e.g., a camera application user interface, a photos application user interface, a stickers application user interface, a payment application user interface, a location sharing application user interface, or an application store application user interface) different from the messaging application user interface, such as optionally receiving a user input corresponding to a request to display a user interface different from the messaging application user interface 1000a in FIG. 10F. In some embodiments, the user interface is associated with an application user interface other than the messaging application user interface or a system user interface. In some embodiments, the second user input includes tapping on a widget corresponding to the user interface from an application library or from a home screen of the electronic device.

In some embodiments, in response to the second user input (1120b), the electronic device ceases (1120c) display of the messaging application user interface, such as ceasing display of the messaging application user interface from 1000a in FIG. 10G. In some embodiments, the electronic device displays one application user interface at a time in full screen. In some embodiments, the second user input includes an input corresponding to a request to cease display of the messaging application user interface and continue recording the audio message.

In some embodiments, in response to the second user input (1120b), the electronic device displays (1120d), via the display generation component, the user interface different from the messaging application user interface, such as a photos application user interface 1028a in FIG. 10G. In some embodiments, the electronic device displays the user interface in full screen. In some embodiments, the electronic device does not display the user interface in full screen.

In some embodiments, in response to the second user input (1120c), the electronic device maintains (1120c) recording of the audio message, such as maintaining recording of the audio message 1010a in FIG. 10G, while displaying the user interface different from the messaging application user interface. In some embodiments, an audio message recording user interface element described with reference to step(s) 1122 is displayed at a top portion of the user interface. In some embodiments, even though the electronic device switches from displaying the messaging application user interface to the user interface of a different application while recording an audio message, the electronic device maintains recording of the audio message. In some embodiments, the electronic device maintains recording of the audio message while receiving input for interacting with the user interface different from the messaging application user interface. In some embodiments, the electronic device maintains recording of the audio message while displaying a second user interface different from the user interface instead of displaying the user interface. Continuing to record an audio message even when navigating away from the messages application user interface allows for different operations simultaneously, thereby improving user-device interactions.

In some embodiments, displaying, via the display generation component, the user interface different from the messaging application user interface includes displaying an audio message recording user interface element, such as audio message recording user interface element 1065a in FIG. 10G, overlaid on the user interface different from the messaging application user interface (1122). In some embodiments, the audio message recording user interface element includes a representation of a sound waveform corresponding to the audio message, a time indication indicating the amount of time elapsed since starting recording of the audio message, and/or a stop recording button described with reference to step(s) 1104. In some embodiments, the electronic device maintains display of audio message recording user interface element while receiving input for interacting with the user interface different from the messaging application user interface. In some embodiments, the electronic device maintains display of audio message recording user interface element while displaying a second user interface different from the user interface instead of displaying the user interface. In some embodiments, the audio message recording user interface element includes an option to record an audio message, an option to send the recorded audio message, and/or other options to control recording and/or playback of an audio message as described with respect to step(s) 1102-1108. In some embodiments, the audio message recording user interface element overlaid on the user interface different from the messaging application user interface is at a fixed position on a display. Accordingly, in some embodiments, even if a different user interface (e.g., second user interface) is displayed instead, the audio message recording user interface element remains at the fixed position on the display. Displaying an audio message recording user interface element on a user interface different from the messages application user interface allows for performing different operations (e.g., including recording an audio message) simultaneously, thereby improving user-device interactions.

In some embodiments, while displaying the messaging application user interface, the electronic device outputs (1124a) playback audio of a respective audio message included in the messaging conversation, such as outputting playback audio of audio message 1010a if it was displayed in the messaging conversation 1002a in FIG. 10E. In some embodiments, the electronic device initiates playback of a respective audio message as described with reference to step(s) 1106.

In some embodiments, while outputting playback audio of the respective audio message, the electronic device receives (1124b), via the one or more input device, a second user input (e.g., different from the first user input and/or includes one or more characteristics of the first user input) (as described with respect to step(s) 1104) corresponding to a request to initiate display of a user interface (e.g., a camera application user interface, a photos application user interface, a stickers application user interface, a payment application user interface, a location sharing application user interface, or an application store application user interface) different from the messaging application user interface, such as optionally receiving a user input corresponding to a request to display a user interface different from the messaging application user interface 1000a in FIG. 10F. In some embodiments, the user interface is associated with an application user interface other than the messaging application user interface or a system user interface. In some embodiments, the second user input includes tapping on a widget corresponding to the user interface from an application library or from a home screen of the electronic device.

In some embodiments, in response to the second user input (1124c), the electronic device ceases (1124d) display of the messaging application user interface, such as ceasing display of the messaging application user interface from 1000a in FIG. 10H. In some embodiments, the electronic device displays one application user interface at a time in full screen. In some embodiments, the second user input includes an input corresponding to a request to cease display of the messaging application user interface and continue outputting playback audio of the respective audio message.

In some embodiments, in response to the second user input (1124c), the electronic device displays (1124c), via the display generation component, the user interface different from the messaging application user interface, such as a photos application user interface 1028a in FIG. 10H. In some embodiments, the electronic device displays the user interface in full screen. In some embodiments, the electronic device does not display the user interface in full screen.

In some embodiments, in response to the second user input (1124c), the electronic device maintains (1124f) outputting of the playback audio of the respective audio message in the user interface different from the messaging application user interface, such as maintaining outputting of the playback audio of the audio message 1010a in FIG. 10H, while displaying the user interface different from the messaging application user interface. In some embodiments, audio message playback user interface element described with reference to step 1126 is displayed at a top portion of the user interface. In some embodiments, even though the electronic device switches from displaying the messaging application user interface to the user interface of a different application during playback of an audio message, the electronic device maintains playback of the audio message. In some embodiments, the electronic device maintains outputting playback audio of the respective audio message while receiving input for interacting with the user interface different from the messaging application user interface. In some embodiments, the electronic device maintains outputting playback audio of the respective audio message while displaying a second user interface different from the user interface instead of displaying the user interface. Continuing playback of an audio message even when navigating away from the messages application user interface allows for performing different operations simultaneously, thereby improving user-device interactions.

In some embodiments, displaying, via the display generation component, the user interface different from the messaging application user interface includes displaying an audio message playback user interface element, such as audio message playback user interface element 1067a in FIG. 10H, overlaid on the user interface different from the messaging application user interface (1126). In some embodiments, the audio message playback user interface element includes a representation of a sound waveform corresponding to an audio message, a time indication indicating the duration of the audio message, a pause button for pausing playback of the audio button, a skip ahead button for skipping forward to a different portion of the playback of the audio message by a threshold time interval (e.g., 10, 15, 30, or 100 s), a skip back button for skipping back to a different portion of the playback of the audio message by a threshold time interval (e.g., 10, 15, 30, or 100 s) and/or an avatar or a visual representation of a user account from which the electronic device has receives a message including a respective audio message for playback. In some embodiments, the electronic device maintains display of audio message playback user interface element while receiving input for interacting with the user interface different from the messaging application user interface. In some embodiments, the electronic device maintains display of audio message playback user interface element while displaying a second user interface different from the user interface instead of displaying the user interface. After the end of a first playback of the audio message, a playback of the audio message can optionally be repeated in response to an input directed to the audio message playback user interface element. In some embodiments, the audio message recording user interface element includes an option to record an audio message, an option to send the recorded audio message, and/or other options to control recording and/or playback of an audio message as described with respect to step(s) 1102-1108. In some embodiments, the audio message playback user interface element overlaid on the user interface different from the messaging application user interface is at a fixed position on a display. Accordingly, in some embodiments, even if a different user interface (e.g., second user interface) is displayed instead, the audio message playback user interface element remains at the fixed position on the display. Displaying an audio message playback user interface element on a user interface different from the messages application user interface allows for performing different operations (e.g., including playback of an audio message) simultaneously, thereby improving user-device interactions.

In some embodiments, the electronic device displays (1128a), via the display generation component, a plurality of audio output options, such as optionally displaying audio output options in the messaging application user interface 1000a in FIG. 10D. In some embodiments, the plurality of audio output options includes a skip ahead option that, when selected, causes the electronic device, to skip to a portion ahead of the current portion of the playback of the audio message by a threshold time interval (e.g., 10, 15, 30, or 100 s). In some embodiments, the plurality of audio output options includes a skip back option that, when selected, causes the electronic device, to skip back to a portion behind the current portion of the playback of the audio message by a threshold time interval (e.g., 10, 15, 30, or 100 s). In some embodiments, the plurality of audio output options includes a rewind option that, when selected, causes the electronic device, to restart playback of the audio message. In some embodiments, the plurality of audio output options is displayed in a control user interface element, which also includes options for controlling other functions of the electronic device (e.g., controlling a level of brightness of a display screen of the electronic device, controlling a level of volume outputted by the electronic device, and/or controlling language settings of the electronic device).

In some embodiments, while displaying the plurality of audio output options, the electronic device receives (1128b), via the one or more input devices, an input corresponding to selection of a first option (e.g., button, icon, widget, affordance, or any other selectable object) of the plurality of audio options, such as optionally receiving input directed to the audio output options if displayed in the messaging application user interface 1000a in FIG. 10D.

In some embodiments, in response to the input corresponding to selection of the first option (1128c), in accordance with a determination that the electronic device is currently playing a respective audio message included in the messaging conversation, the electronic device modifies (1128d) (e.g., skipping ahead, skipping back, pausing, and/or rewinding) playback of the respective audio message in accordance with the first option (e.g., skip ahead option, skip back option, pausing, and/or rewind option), such as modifying playback of the audio message 1010a in FIG. 10E if the input directed to the audio output options was received in FIG. 10D.

In some embodiments, in response to the input corresponding to selection of the first option (1128c), in accordance with a determination that the electronic device is currently playing audio content (e.g., music, audiobooks, or podcasts) that is not an audio message, the electronic device modifies (1128e) (e.g., skipping ahead, skipping back, pausing and/or rewinding) playback of the audio content in accordance with the first option (e.g., skip ahead option, skip back option, pausing and/or rewind option), such as modifying playback of audio content if the audio content was displayed in FIG. 10E. In some embodiments, respective audio output options, when selected, cause the electronic device to skip ahead, skip back, pause, and/or rewind during playback of a respective audio message. In some embodiments, the plurality of audio output options, when selected, can control playback of content from different applications (e.g., media playback application including movies or TV shows) while the electronic device is playing content from the different applications. Displaying various audio output options allows for skipping ahead, skipping back, rewinding, and other functionalities during playback of an audio message and/or other audio content, thereby improving user-device interactions.

In some embodiments, while displaying the messaging application user interface, the electronic device displays (1130a), via the display generation component, a representation of a first audio message, such as first audio message 1010b in FIG. 10O, and a representation of a second audio message, such as second audio message 1046b in FIG. 10O, in the messaging conversation (e.g., the representations of the first audio message and the second audio message include one or more characteristics of the representation of the audio message described with respect to step(s) 1102 and 1104), wherein the representation of the first audio message and the representation of the second audio message are not separated by (any) intermediate content (e.g., audio message, text, image, stickers, and/or video) in the messaging conversation.

In some embodiments, the electronic device receives (1130b), via the one more input devices, a second user input (e.g., different from the first user input and/or includes one or more characteristics of the first user input) directed to a selectable option (e.g., button, icon, widget, affordance, or any other selectable object) corresponding to the first audio message, that, when selected, causes playback of the first audio message, such as user input directed to a play option corresponding to the first audio message 1010b if the play option was displayed in FIG. 10O. In some embodiments, in response to receiving input directed to a play button corresponding to the first audio message, the electronic device plays the first audio message.

In some embodiments, in response to the second user input (1130c), the electronic device outputs (1130d) playback of the first audio message, such playing the first audio message 1010b in FIG. 10O.

In some embodiments, in response to the second user input (1130c), after outputting playback of the first audio message, the electronic device (automatically and/or without additional user inputs) outputs (1130e) playback of the second audio message, such as playing the second audio message 1046b in FIG. 10O. In some embodiments, after playing the first audio message, the electronic device automatically (e.g., without input directed to a play button corresponding to the second audio message) plays the second audio message because the second audio message is displayed immediately after the first audio message. In some embodiments, the electronic device does not automatically play the second audio message displayed after the first audio message in the messaging conversation if intermediate content exists between the second audio message and the first audio message. In some embodiments, the electronic device automatically plays a third audio message displayed after the second audio message in the messaging conversation if the third audio message and the second audio message are not separated by any intermediate content. In some embodiments, the electronic device does not automatically play a fourth audio message displayed after the third audio message in the messaging conversation if intermediate content exists between the fourth audio message and the third audio message. Automatically playing subsequent audio messages that are not separated by intermediate content reduces the number of inputs needed for playback of multiple audio messages, thereby improving user-device interactions.

It should be understood that the particular order in which the operations in FIGS. 11A-11I have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and 900) are also applicable in an analogous manner to method 1100 described above with respect to FIGS. 11A-11I. For example, the operation of the electronic device to present images in accordance with the pose of the electronic device described above with reference to method 1100 optionally has one or more of the characteristics of the presentation of content associated with a map, a summary of captured content, and video while in a communication session described herein with reference to other methods described herein (e.g., methods 700 and 900). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIGS. 11A-11I are, optionally, implemented by components depicted in FIGS. 1A-1B. For example, displaying operation 1102a and/or receiving operation 1102b are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is the gathering and use of data available from specific and legitimate sources to present content of relevance to the user. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, determining current device usage can enable an electronic device to effectively update an input field of a messaging application user interface in accordance with a respective application user interface. Accordingly, use of such personal information data enables users to view information that is relevant to them. Further, other uses for personal information data that benefit the user are also contemplated by the present disclosure. For instance, a current location can be used to update an input field of the messaging application user interface in accordance with a location sharing application user interface.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable location services that determine the location of the electronic device and/or locations of other electronic devices and/or not to share information about current device usage.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the user can select options for an application user interface such that an input field of a messaging application user interface is updated in accordance with the selected application user interface without providing current device usage.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display generation component and one or more input devices:
displaying, via the display generation component, a messaging application user interface that includes an input field;
while displaying the messaging application user interface, receiving, via the one or more input devices, a first user input directed to an option for selecting a respective application user interface element in the messaging application user interface; and
in response to receiving the first user input:
in accordance with a determination that the respective application user interface element is a first application user interface element, updating the input field of the messaging application user interface with a first visual appearance in accordance with the first application user interface element; and
in accordance with a determination that the respective application user interface element is a second application user interface element different from the first application user interface element, updating the input field of the messaging application user interface with a second visual appearance different from the first visual appearance in accordance with the second application user interface element.

2. The method of claim 1, further comprising:
while displaying the input field of the messaging application user interface without the respective application user interface element, receiving, via the one or more inputs devices, a second user input directed to the messaging application user interface; and
in response to receiving the second user input, displaying, via the display generation component, an application selection user interface that includes a plurality of application user interfaces including the respective application user interface element, wherein at least one application user interface is configurable to be added to, removed from, or rearranged in the application selection user interface.

3. The method of claim 2, wherein the application selection user interface includes a first portion including a fixed set of application user interface elements.

4. The method of claim 3, wherein the first portion of the application selection user interface includes a user interface element, the method further comprising:
receiving, via the one or more input devices, a second user input directed towards the user interface element; and
in response to receiving the second user input:
ceasing display of the first portion of the application selection user interface; and
displaying, via the display generation component a second portion different from the first portion of the application selection user interface, wherein the second portion of the application user interface includes a variable set of application user interface elements.

5. The method of claim 4, further comprising:
while displaying the application selection user interface, receiving, via the one or more input devices, an input corresponding to a request to scroll the application selection user interface; and in response to receiving the input corresponding to the request to scroll the application selection user interface:
in accordance with a determination that the input corresponding to the request to scroll the application selection user interface was received while displaying the first portion of the application selection user interface, scrolling from the first portion of the application selection user interface to the second portion of the application selection user interface irrespective of a magnitude of the input corresponding to the request to scroll the application selection user interface; and
in accordance with a determination that the input corresponding to the request to scroll the application selection user interface was received while displaying the second portion of the application selection user interface, scrolling the application selection user interface by an amount corresponding to the magnitude of the input corresponding to the request to scroll the application selection user interface.

6. The method of claim 1, further comprising:
in response to receiving the first user input, updating the input field of the messaging application user interface with a respective visual appearance in accordance with the respective application user interface element and the first user input;
while displaying the messaging application user interface with the input field having the respective visual appearance, receiving, via the one or more input devices, a second user input corresponding to a request to update the respective application user interface element;
in response to receiving the second user input, updating the input field of the messaging user interface with a respective visual appearance in accordance with the second user input;
receiving, via the one or more input devices, a third user input directed towards a send user interface element in the input field of the messaging application user interface; and
in response to receiving the third user input, performing an operation corresponding to the respective application user interface element.

7. The method of claim 1, further comprising:
while displaying the input field of the messaging application user interface without the respective application user interface element, receiving, via the one or more inputs devices, a second user input directed to the messaging application user interface; and in response to receiving the second user input:
reducing a visual prominence of the messaging application user interface; and
displaying, via the display generation component, an application selection user interface over the messaging application user interface with the reduced visual prominence.

8. The method of claim 7, further comprising:
in response to receiving the first user input, updating the input field of the messaging application user interface with a respective visual appearance in accordance with the respective application user interface element and the first user input;
while displaying the messaging application user interface with the input field having the respective visual appearance, receiving, via the one or more input devices, a second user input directed to a selectable element included in the respective application user interface element; and in response to receiving the second user input, performing an action associated with the respective application user interface element.

9. The method of claim 8, wherein the action associated with the respective application user interface element includes revising content to be added to a messaging conversation displayed in the messaging application user interface, and the method further comprises:
in response to receiving the second user input, displaying, in the input field, a selectable option that, when selected, causes the electronic device to add the content to the messaging conversation, wherein the selectable option is not displayed prior to receiving the second user input.

10. The method of claim 1, further comprising in response to receiving the first user input:
in accordance with a determination that the respective application user interface element is the first application user interface element:
updating the input field of the messaging application user interface with the first visual appearance in accordance with the first application user interface element such that the first application user interface element includes an entry field, and
displaying a soft keyboard in the messaging application user interface; and
in accordance with a determination that the respective application user interface element is the second application user interface element:
updating the input field of the messaging application user interface with the second visual appearance different from the first visual appearance in accordance with the second application user interface element such that the first application user interface element does not include the entry field, and
forgoing displaying the soft keyboard in the messaging application user interface.

11. The method of claim 10, wherein the second application user interface element includes an audio messaging application user interface element or a location sharing application user interface element.

12. The method of claim 1, further comprising in response to receiving the first user input:
in accordance with a determination that the respective application user interface element is the first application user interface element, updating the input field of the messaging application user interface with the first visual appearance such that the first application user interface element includes a first set of user interface elements in accordance with the first application user interface element; and
in accordance with a determination that the respective application user interface element is the second application user interface element different from the first application user interface element, updating the input field of the messaging application user interface with the second visual appearance different from the first visual appearance such that the second application user interface element includes a second set of user interface elements different from the first set of user interface elements in accordance with the second application user interface element.

13. The method of claim 1, wherein receiving, via the one or more input devices, the first user input directed to the option for selecting the respective application user interface element includes receiving the first user input directed to the option for selecting a camera application user interface element, a photos application user interface element, a stickers application user interface element, a payment application user interface element, an audio messaging application user interface element, a location sharing application user interface element, or an application store application user interface element.

14. The method of claim 1, wherein receiving, via the one or more input devices, the first user input directed to the option for selecting the respective application user interface element includes receiving the first user input directed to a user interface element representing an image stored on the electronic device; and the method further includes:
in response to detecting selection of the user interface element representing the image stored on the electronic device, updating the input field of the messaging application user interface to include a photos application user interface element.

15. The method of claim 1, further comprising:
while displaying the messaging user interface with the input field including a text entry field and not including the respective application user interface element, and while displaying a soft keyboard in the messaging user interface:
receiving, via the one or more input devices, one or more inputs directed to the soft keyboard; and
in response to receiving the one or more inputs directed to the soft keyboard, updating the text entry field to include text corresponding to the one or more inputs directed to the soft keyboard.

16. The method of claim 1, further comprising:
while displaying the messaging application user interface without displaying the respective application user interface element in the input field, displaying, via the display generation component, a selectable option in the input field; and
in response to receiving the first user input, ceasing to display the selectable option in the input field.

17. The method of claim 1, further comprising:
in response to receiving the first user input, displaying, via the display generation component, a selectable option in the input field, wherein the selectable option was not displayed while displaying the messaging application user interface without displaying the respective application user interface element in the input field.

18. The method of claim 1, wherein the input field is displayed, via the display generation component, with a first characteristic while displaying the messaging application user interface without displaying the respective application user interface element in the input field; and the method further comprising:
in response to receiving the first user input, updating the input field of the messaging application user interface from being displayed with the first characteristic to being displayed with a second characteristic different from the first characteristic.

19. The method of claim 1, further comprising:
while displaying the messaging application user interface without displaying the respective application user interface element in the input field, displaying, using the display generation component, a soft keyboard; and
in response to receiving the first user input, ceasing display of the soft keyboard.

20. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
displaying, via the display generation component, a messaging application user interface that includes an input field;
while displaying the messaging application user interface, receiving, via the one or more input devices, a first user input directed to an option for selecting a respective application user interface element in the messaging application user interface; and
in response to receiving the first user input:
in accordance with a determination that the respective application user interface element is a first application user interface element, updating the input field of the messaging application user interface with a first visual appearance in accordance with the first application user interface element; and
in accordance with a determination that the respective application user interface element is a second application user interface element different from the first application user interface element, updating the input field of the messaging application user interface with a second visual appearance different from the first visual appearance in accordance with the second application user interface element.

21. A non-transitory computer readable storage medium storing one or more programs, the one or more programs comprising instructions, which when executed by one or more processors of a computer system that is in communication with a display generation component and one or more input devices, cause the computer system to perform a method comprising:
displaying, via the display generation component, a messaging application user interface that includes an input field;
while displaying the messaging application user interface, receiving, via the one or more input devices, a first user input directed to an option for selecting a respective application user interface element in the messaging application user interface; and
in response to receiving the first user input:
in accordance with a determination that the respective application user interface element is a first application user interface element, updating the input field of the messaging application user interface with a first visual appearance in accordance with the first application user interface element; and
in accordance with a determination that the respective application user interface element is a second application user interface element different from the first application user interface element, updating the input field of the messaging application user interface with a second visual appearance different from the first visual appearance in accordance with the second application user interface element.
